(19) United States
(12) Patent Application Publication
(10) Pub. No.: US 2025/0111227 A1
(43) Pub. Date: Apr. 3, 2025

(54) ENHANCING NEURAL NETWORK TRAINING VIA BALANCED CONCATENATION

(71) Applicant: NVIDIA Corporation, Santa Clara, CA (US)

(72) Inventors: Tero Tapani Karras, Helsinki (FI); Miika Samuli Aittala, Helsinki (FI); Janne Johannes Hellsten, Helsinki (FI); Jaakko T. Lehtinen, Helsinki (FI); Timo Oskari Aila, Tuusula (FI); Samuli Matias Laine, Vantaa (FI)

(21) Appl. No.: 18/897,244

(22) Filed: Sep. 26, 2024

Related U.S. Application Data
(60) Provisional application No. 63/606,448, filed on Dec. 5, 2023.
(60) Provisional application No. 63/603,049, filed on Nov. 27, 2023.
(60) Provisional application No. 63/586,948, filed on Sep. 29, 2023.

(51) Int. Cl. G06N 3/08

(52) U.S. Cl. CPC G06N 3/08

(57) ABSTRACT

Apparatuses, systems, and techniques to train neural networks and to use neural networks to perform inference. In at least one embodiment, a balanced concatenation layer performs a balanced concatenation operation during a forward pass of a training iteration during the training of a neural network. In at least one embodiment, a balanced concatenation layer performs a balanced concatenation operation during the use of a neural network to perform inference.

### CLAIM OF PRIORITY

This application claims the benefit of U.S. Provisional Application No. 63/606,448, titled “Improvements to the Training and Architecture of Neural Networks” and filed Dec. 5, 2023, of U.S. Provisional Application No. 63/603,049, titled “Improvements to the Training and Architecture of Neural Networks” and filed Nov. 27, 2023, and of U.S. Provisional Application No. 63/586,948, titled “Improvements to the training and architecture of neural networks” and filed Sep. 29, 2023, each of which is incorporated by reference herein.

### BACKGROUND

Deep learning is a subset of machine learning that involves training models consisting of multiple layers of computational units (often referred to as artificial neurons). Such models can be referred to as deep neural networks (DNNs). The goal of deep learning is to train DNNs to identify complex patterns and representations from large datasets and thereby enable them to perform various tasks, e.g., image classification and natural language processing.

DNNs can be conceptualized as a number of interconnected layers, some of which are linear and some of which are non-linear, some of which are learned and some of which perform predefined, fixed functions. Linear layers (e.g., fully-connected layers or convolutional layers) perform a linear operation on an input, using a weight matrix, to transform the input and thereby provide an output. Linear layers typically include weights and biases that are learned during a training process, though some linear layers may have predefined, fixed weights that are invariant to training (or not updated during certain learning scenarios). Non-linear layers include, for example, activation layers (which consist of a number of artificial neurons using some activation function, e.g. ReLU, SiLU, etc.), normalization layers (e.g. BatchNorm, LayerNorm, GroupNorm), modulation layers (e.g. AdaIN), gating layers (e.g. GeGLU), and attention layers (e.g. self-attention layers, cross-attention layers). Some non-linear layers are fixed and therefore invariant to training (e.g. activation layers typically perform predefined, fixed mathematical operations), while others include trainable parameters that are learned during the training process (e.g. attention layers).

Training a DNN involves providing an input to the DNN, processing the input in a forward direction to provide a model output, computing a model error (i.e., a difference between the model output and a ground truth), backpropagating a feedback signal (based on gradients of the model error) in a reverse direction, and updating the individual weights of each respective learned layer. The feedback signal provides an indication of a direction in which each weight should be adjusted in order to reduce the value of the loss function, and the weights are thereby updated in a manner that reduces the model error. The process is repeated—often for hundreds of thousands of iterations—enabling the model to learn from large datasets.

While the process may appear straightforward when described at a high level, the training dynamics are highly complex in the presence of multiple layers and large numbers of computational units, and a number of significant problems are presented in practice.

### BRIEF DESCRIPTION OF THE DRAWINGS

FIG. 1 illustrates a flow diagram of a process for training a neural network, according to at least one embodiment;

FIG. 2 illustrates a flow diagram of a process for using a neural network to perform inference, according to at least one embodiment;

FIG. 3A illustrates a diffusion model (DM) architecture, according to at least one embodiment;

FIG. 3B illustrates an input block of the diffusion model of FIG. 3A, according to at least one embodiment;

FIG. 3C illustrates an output block of the diffusion model of FIG. 3A, according to at least one embodiment;

FIG. 3D illustrates an embedding block of the diffusion model of FIG. 3A, according to at least one embodiment;

FIG. 3E illustrates an encoder block of the diffusion model of FIG. 3A, according to at least one embodiment;

FIG. 3F illustrates a decoder block of the diffusion model of FIG. 3A, according to at least one embodiment;

FIG. 3G illustrates an attention block of the diffusion model of FIG. 3A, according to at least one embodiment;

FIG. 3H illustrates the diffusion model architecture of FIG. 3A, highlighting locations of certain decoder blocks that include balanced concatenation layers;

FIG. 4A illustrates logic, according to at least one embodiment;

FIG. 4B illustrates logic, according to at least one embodiment;

FIG. 5 illustrates training and deployment of a neural network, according to at least one embodiment;

FIG. 6 illustrates an example data center system, according to at least one embodiment;

FIG. 7 is a block diagram illustrating a computer system, according to at least one embodiment;

FIG. 8 illustrates a computer system, according to at least one embodiment;

FIG. 9A illustrates a computer system, according to at least one embodiment;

FIG. 9B illustrates a computer system, according to at least one embodiment;

FIG. 9C illustrates a computer system, according to at least one embodiment;

FIG. 9D illustrates a computer system, according to at least one embodiment;

FIGS. 9E and 9F illustrate a shared programming model, according to at least one embodiment;

FIG. 10 illustrates exemplary integrated circuits and associated graphics processors, according to at least one embodiment;

FIGS. 11A-11B illustrate additional exemplary graphics processor logic according to at least one embodiment;

FIG. 12A illustrates a parallel processor, according to at least one embodiment;

FIG. 12B illustrates a partition unit, according to at least one embodiment;

FIG. 12C illustrates a processing cluster, according to at least one embodiment;

FIG. 12D illustrates a graphics multiprocessor, according to at least one embodiment;

FIG. 13 is a block diagram illustrating a processor micro-architecture for a processor, according to at least one embodiment;

FIG. 14 illustrates a deep learning application processor, according to at least one embodiment;

FIG. 15 illustrates at least portions of a graphics processor, according to one or more embodiments;

FIG. 16 illustrates at least portions of a graphics processor, according to one or more embodiments;

FIG. 17 illustrates a parallel processing unit (“PPU”), according to at least one embodiment;

FIG. 18 illustrates a general processing cluster (“GPC”), according to at least one embodiment;

FIG. 19 illustrates a memory partition unit of a parallel processing unit (“PPU”), according to at least one embodiment; and

FIG. 20 illustrates a streaming multi-processor, according to at least one embodiment.

### DETAILED DESCRIPTION

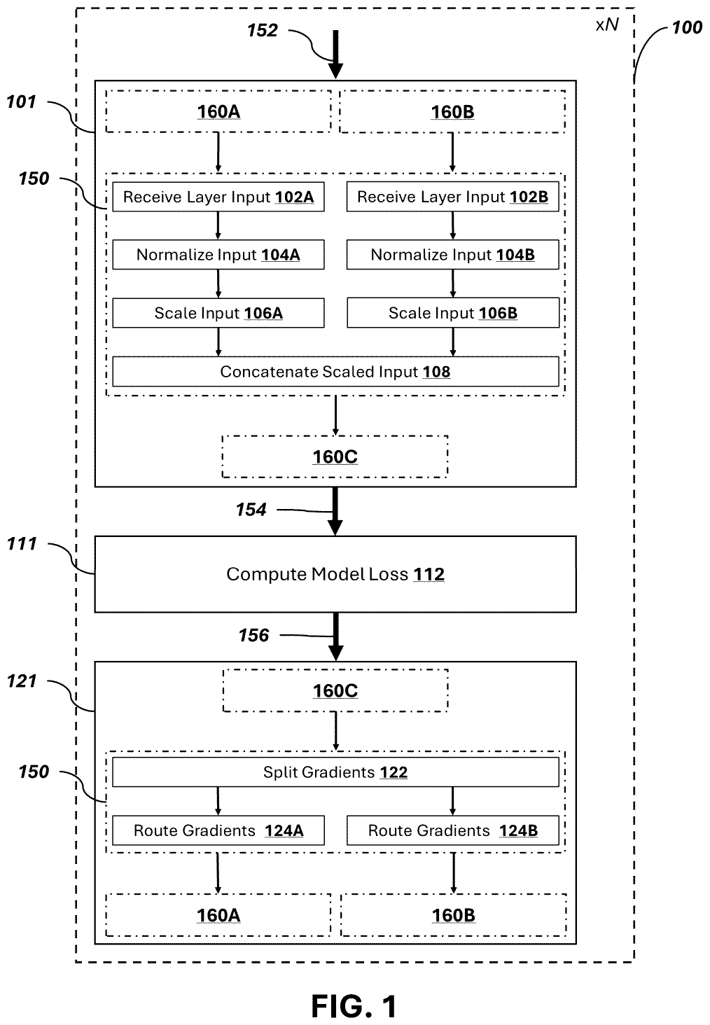

FIG. 1A illustrates a flowchart of a process 100 for training a neural network, according to at least one embodiment. The process 100 includes performing a number of training iterations (e.g. N iterations), each training iteration including a forward pass 101, a loss calculation 111, and a backward pass 121. During the forward pass, the neural network receives training instance input 152 and processes it to generate model output 154. During the loss calculation, the model output 154 is processed to provide a model loss 156. During the backward pass 121, gradients with respect to the model loss 156 are computed. In addition, each training iteration additionally includes a parameter update, in which parameters of learned layers of the network are updated, e.g. based on feedback provided during the backward pass. In at least one embodiment, the parameter update is performed as part of the backward pass. In at least one embodiment, the parameter update is performed after the backward pass of one training iteration and before the forward pass of the training iteration that immediately follows.

The process 100 for training a neural network is used to train a neural network that includes balanced concatenation layer 150, as well as a number of additional layers 160A, 160B, and 160C, which can include both learned and fixed function layers. In at least one embodiment, the neural network is a diffusion model (DM). In at least one embodiment, the neural network is a generative pretrained transformer (GPT). In various embodiments, the neural network is a convolutional neural network (CNN), a recurrent neural network (RNN), an autoencoder, a feedforward neural network (FFNN), a graph neural network (GNN), or a generative adversarial network (GAN).

While FIG. 1 only illustrates additional layers 160A and 160B upstream of balanced concatenation layer 150 and additional layer 160C downstream of balanced concatenation layer 150, it will be appreciated by those skilled in the art that the illustrated location of balanced concatenation layer 150 and additional layers 160 is merely one example location provided for purposes of illustration, and that balanced concatenation layer 150 can be the first layer in the neural network or the final layer in the neural network. It will be appreciated by those skilled in the art that one or more additional layers 160 may also be located in a branch parallel to balanced concatenation layer 150. It will also be appreciated by those skilled in the art that both first additional upstream layers 160A and second additional upstream layers 160B may branch from a common path located further upstream. Furthermore, it will be appreciated by those skilled in the art that additional layers 160A, 160B, and 160C may include further balanced concatenation layers and that process 100 can include performing, in any number of such balanced concatenation layers, the same actions performed in balanced concatenation layer 150 during forward pass 101 and backward pass 121.

In at least one embodiment, the process 100 includes combining, via a concatenation operation performed by the balanced concatenation layer 150, a plurality of inputs received via different paths such that (i) each respective input component has a respective contribution to the magnitude of the output of the balanced concatenation layer that is equal to a predefined constant and (ii) the expected magnitude of the output of the balanced concatenation layer is equal to the magnitude of each input to the concatenation operation performed by the balanced concatenation layer.

The process 100 includes receiving, at 102A, first concatenation layer input via a first input path and receiving, at 102B, second concatenation layer input via a second input path. The first input path includes one or more first additional upstream layers 160A, and the second input path includes one or more second additional upstream layers 160B. In at least one embodiment, the process 100 includes normalizing, at 104A, the first concatenation layer input and normalizing, at 104B, the second concatenation layer input. The process 100 further includes scaling, at 106A, the first concatenation layer input (e.g. as normalized at 104A) and scaling, at 106B, the second concatenation layer input (e.g. as normalized at 104B). The process 100 additionally includes, at 108, combining the scaled input produced at 106A and the scaled input produced at 106B via a concatenation operation to provide concatenation layer output. In at least one embodiment, the concatenation layer output is provided as input to one or more downstream additional layers 160C as the forward pass continues. In at least one embodiment, the concatenation layer output is provided as a model output.

Most modern neural networks have complex architectures in which certain layers provide output that branches off into multiple different paths and in which other layers receive inputs from multiple different paths. When signals from multiple different paths are combined together, for example as input to a particular layer, the signals are often simply concatenated into a single signal with a number of channels equal to the sum of the numbers of channels in the various different paths that are combined.

One problem that results from simple concatenation operations is that the impact of different branches on downstream computations will be strongly influenced by the number of channels in each of those different branches. For example, if a first input branch contributes 10 channels to a concatenation operation and a second input branch contributes 1000 channels, the second input branch will have a far greater impact on the computations performed at any subsequent downstream layer (provided that each input component has roughly equal variance). This can become problematic when attempting to tune computational capacity across different paths in the network: an increase in computational capacity in one path (i.e., the addition of channels to that path) can have unintended consequences because such an increase will necessarily impact the relative contributions of different paths to computations performed at subsequent downstream layers. For example, an increase in computational capacity that improves the accuracy of a first path may appear detrimental to the network overall due to a shift in the balance of the contributions of that first path and some second path to one or more downstream layers.

In at least one embodiment, the process 100, by combining a plurality of inputs, received via a plurality of different input paths, via a concatenation operation performed by balanced concatenation layer 150, decouples the respective contributions of different input paths to a concatenation operation from the channel counts of those different input paths. As a result, the respective contributions of different input paths to a particular concatenation operation can be treated as an independent hyperparameter, and such hyperparameters can be adjusted, independently and on a case-by-case basis, to provide enhanced flexibility in network design. The enhanced flexibility provides greater control over the learning process, thereby enabling the development of more accurate models while simultaneously reducing the outlays—e.g. in terms of both compute costs and financial costs-required for training.

A further problem that results during the training of complex neural networks is that uncontrollable increases in the magnitudes of the weights over many training iterations causes uncontrollable increases in the magnitude of activations received by non-linear layers from one training iteration to the next. This results because each layer acts multiplicatively, i.e., the weights of a weight matrix of a particular layer are multiplied by the output of an upstream layer, and the output of that particular layer is then multiplied by the weights of a downstream layer. Since (i) the learnable weights of the network are trained based on magnitudes of an activation signals seen during forward passes of prior training iterations and (ii) the increase in the magnitudes of the weights of learned linear layers occurs after forward passes of prior training iterations but before a forward pass of a current training iteration, the activation signals received by the activation layers during the current training iteration will have, statistically speaking, larger magnitudes than in the prior training iteration. Therefore, the output of the activation layers will always deviate from the optimum due to the increases in the magnitudes of the activation signals. While the effect may be small for any given activation layer and/or training iteration, significant distortions can result, for example, when a small increase in the output of one activation layer cascades through the network as it is multiplied—many times over by different layers—before serving as the input to some distant downstream activation layer.

In at least one embodiment, the process 100, by normalizing the first concatenation layer input at 104A and normalizing the second concatenation layer input at 104B, prevents the balanced concatenation layer 150 from contributing to further increases in the magnitude of activations received by downstream layers during the forward pass. As a result, the training dynamics are improved, and the process 100 yields trained neural networks that exhibit enhanced accuracy at inference while simultaneously reducing the outlays required for training. In at least one embodiment, the normalizations 104A and 104B are omitted, for example, due to the presence of some other mechanism to ensure that the magnitudes of the layer inputs 102A and 102B are sufficiently similar to each other.

In at least one embodiment, the balanced concatenation layer 150 scales, at 106A, the first concatenation layer input (e.g. as normalized at 104A) based on the channel count thereof and scales, at 106B, the second concatenation layer input (e.g. as normalized at 104B) based on the channel count thereof. In at least one embodiment, the balanced concatenation layer 150 receives, at 102A, the first concatenation layer input via the first input path in the form of a first vector a and receives, at 102B, the second concatenation layer input via the second input path in the form of a second vector b. The balanced concatenation layer 150 scales, at 106A, the first vector a by a scaling factor [symbol] ₐ and scales, at 106B, the second vector b by a second scaling factor [symbol] _{b}. Each of the first scaling factor [symbol] ₐ and the second scaling factor [symbol] _{b} is determined based on a mixing factor t, the channel count Nₐ of the first vector a and the channel count N_{b} of the second vector b. In at least one embodiment:

$$c = {a}_{} a ⊕ {b}_{} b ,$$

$${a}_{} = \sqrt{\frac{{N}_{a} + {N}_{b}}{{( 1 - t )}^{2} + {t}^{2}}} \cdot \frac{1 - t}{\sqrt{{N}_{a}}} ,$$

$${b}_{} = \sqrt{\frac{{N}_{a} + {N}_{b}}{{( 1 - t )}^{2} + {t}^{2}}} \cdot \frac{t}{\sqrt{{N}_{b}}} , and$$

$$MPCat ( a , b , t ) = c = \sqrt{\frac{{N}_{a} + {N}_{b}}{{( 1 - t )}^{2} + {t}^{2}}} \cdot [ \frac{1 - t}{\sqrt{{N}_{a}}} a ⊕ \frac{t}{\sqrt{{N}_{b}}} b ] ,$$

where c is an output vector produced by the balanced concatenation operation.

While FIG. 1 illustrates balanced concatenation layer 150 receiving input from only two upstream paths, it will be appreciated by those skilled in the art that the balanced concatenation layer 150 can receive input from three or more upstream paths. In at least one embodiment, the process 100 includes, receiving n concatenation layer inputs via n different input paths, normalizing each of the n received concatenation layer inputs, scaling each of the n received concatenation layer inputs via n different scaling factors, and concatenating the n scaled inputs. In at least one embodiment, each of the n concatenation layer inputs is in the form of a vector aᵢ for i=1, . . . , n, the n scaling factors [symbol] ᵢ are determined by n mixing factors tᵢ and the channel counts Nᵢ of the n vectors. In at least one embodiment:

$$c = {1}_{} {a}_{1} ⊕ {2}_{} {a}_{2} ⊕ … ⊕ {n}_{} {a}_{n} ,$$

$${i}_{} = \sqrt{\frac{{\sum }_{j = 1}^{n} {N}_{j}}{{\sum }_{j = 1}^{n} {t}_{j}^{2}}} \cdot \frac{{t}_{i}}{\sqrt{{N}_{i}}} , and$$

$$MPCat ( a , b , t ) = c = \sqrt{\frac{{\sum }_{j = 1}^{n} {N}_{j}}{{\sum }_{j = 1}^{n} {t}_{j}^{2}}} \cdot [ \frac{{t}_{i}}{\sqrt{{N}_{i}}} {a}_{1} ⊕ \frac{{t}_{2}}{\sqrt{{N}_{2}}} {a}_{2} ⊕ … ⊕ \frac{{t}_{n}}{\sqrt{{N}_{n}}} {a}_{n} ] ,$$

where c is an output vector produced by the balanced concatenation operation and Σ₁ⁿ tᵢ=1.

During loss calculation 111, the process 100 computes, at 112, using a loss function £ and based on a model output 154 for the current training iteration provided by the neural network at the completion of the forward pass 101, a model loss (also referred to as a model error) 156. In at least one embodiment, the model loss 156 is computed by using a supervised learning loss function £ that compares the model output 154 with a target (also referred to as “ground truth”). In various embodiments, the supervised learning loss function can be a regression loss function, such as mean squared error (MSE), score matching loss, mean absolute error (MAE), or Huber Loss, or a classification loss function, such as binary cross-entropy or categorical cross-entropy. In at least one embodiment, the model loss 156 is computed using an unsupervised learning loss function £ that assesses the degree to which the forward pass captured underlying structure of or patterns in the training instance input 152. In various embodiments, the unsupervised learning loss function can be a reconstruction loss function, such as mean squared error (MSE) or binary cross-entropy, a contrastive loss function, such as triplet loss, an adversarial loss function, such as minimax loss or Wasserstein loss, or a clustering loss, such as K-means loss or Gaussian mixture loss.

During the backward pass 121, the process 100 computes gradients of the model loss 156—including, e.g., gradients of the model loss 156 with respect to the concatenation layer output provided at 108. During the backward pass 121, the balanced concatenation layer 150 receives the gradients of the model loss 156 with respect to the concatenation layer output provided at 108, and splits, at 122, the received gradients into a first path, which includes gradients for the portion of the concatenation layer output corresponding to the first concatenation layer input received at 102A, and a second path, which includes gradients for the portion of the concatenation layer output corresponding to the second concatenation layer input received at 102B. The balanced concatenation layer 150 routes, at 124A, the received gradients to the additional first upstream layers 160A and routes, at 124B, the received gradients to the additional second upstream layers 160B.

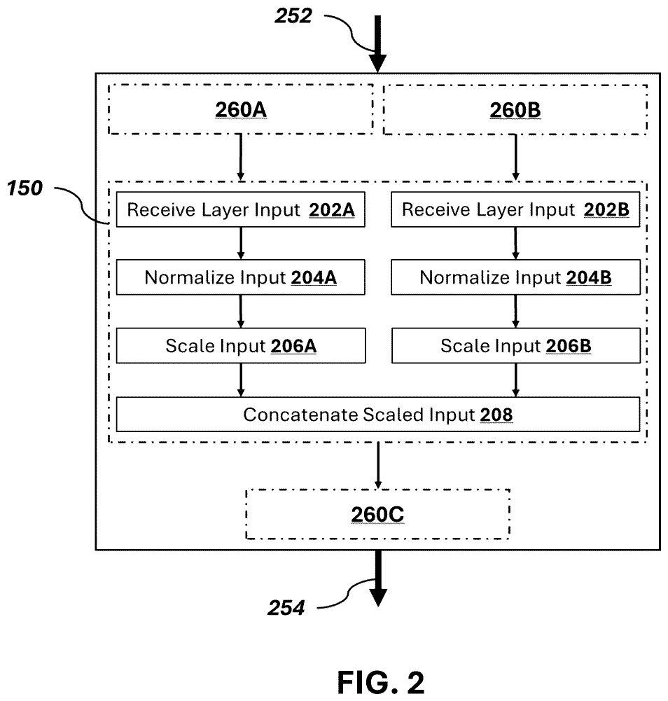

FIG. 2 illustrates a flow diagram of a process 200 for using a neural network to perform inference, according to at least one embodiment. The process 200 includes receiving, by a neural network 201, input 252 and processing, by a plurality of layers of the neural network 201, the input 252 to generate model output 254. The plurality of layers of the neural network include balanced concatenation layer 150, as well as a number of additional layers 160A, 160B, and 160C, which can include both learned and fixed function layers. In at least one embodiment, the neural network is a diffusion model (DM). In at least one embodiment, the neural network is a generative pretrained transformer (GPT). In various embodiments, the neural network is a convolutional neural network (CNN), a recurrent neural network (RNN), an autoencoder, a feedforward neural network (FFNN), a graph neural network (GNN), or a generative adversarial network (GAN).

While FIG. 2 only illustrates additional layers 260A and 260B upstream of balanced concatenation layer 250 and additional layer 260C downstream of balanced concatenation layer 250, it will be appreciated by those skilled in the art that the illustrated location of balanced concatenation layer 250 and additional layers 260 is merely one example location provided for purposes of illustration, and that balanced concatenation layer 250 can be the first layer in the neural network or the final layer in the neural network. It will be appreciated by those skilled in the art that one or more additional layers may also be located in a branch parallel to balanced concatenation layer 250. It will also be appreciated by those skilled in the art that both first additional upstream layers 260A and second additional upstream layers 260B may branch from a common path locater further upstream. Furthermore, it will be appreciated by those skilled in the art that additional layers 260A, 260B, and 260C may include further balanced concatenation layers and that process 200 can include performing, in any number of such balanced concatenation layers, the same actions performed in balanced concatenation layer 250 during inference.

In at least one embodiment, the process 200 includes combining, via a concatenation operation performed by the balanced concatenation layer 250, a plurality of inputs received via different paths such that (i) each respective input component has a respective contribution to the magnitude of the output of the balanced concatenation layer that is equal to a predefined constant and (ii) the expected magnitude of the output of the balanced concatenation layer is equal to the magnitude of each input to the concatenation operation performed by the balanced concatenation layer.

The process 200 includes receiving, at 202A, first concatenation layer input via a first input path and receiving, at 202B, second concatenation layer input via a second input path. The first input path includes one or more first additional upstream layers 260A, and the second input path includes one or more second additional upstream layers 260B. In at least one embodiment, the process 100 includes normalizing, at 204A, the first concatenation layer input and normalizing, at 204B, the second concatenation layer input. The process 200 further includes scaling, at 206A, the first concatenation layer input (e.g. as normalized at 204A) and scaling, at 206B, the second concatenation layer input (e.g. as normalized at 204B). The process 200 additionally includes, at 208, combining the scaled input produced at 206A and the scaled input produced at 206B via a concatenation operation to provide concatenation layer output. In at least one embodiment, the concatenation layer output is provided as input to one or more downstream additional layers 260C as the forward pass continues. In at least one embodiment, the concatenation layer output is provided as the model output 254.

In at least one embodiment, the balanced concatenation layer 250 scales, at 206A, the first concatenation layer input (e.g. as normalized at 204A) based on the channel count thereof and scales, at 206B, the second concatenation layer input (e.g. as normalized at 204B) based on the channel count thereof. In at least one embodiment, the balanced concatenation layer 250 receives, at 202A, the first concatenation layer input via the first input path in the form of a first vector a and receives, at 202B, the second concatenation layer input via the second input path in the form of a second vector b. The balanced concatenation layer 250 scales, at 206A, the first vector a by a scaling factor [symbol] ₐ and scales, at 206B, the second vector b by a second scaling factor [symbol] _{b}. Each of the first scaling factor [symbol] ₐ and the second scaling factor [symbol] _{b} is determined based on a mixing factor t, the channel count Nₐ of the first vector a and the channel count N_{b} of the second vector b. In at least one embodiment:

$$c = {a}_{} a ⊕ {b}_{} b ,$$

$${a}_{} = \sqrt{\frac{{N}_{a} + {N}_{b}}{{( 1 - t )}^{2} + {t}^{2}}} \cdot \frac{1 - t}{\sqrt{{N}_{a}}} ,$$

$${b}_{} = \sqrt{\frac{{N}_{a} + {N}_{b}}{{( 1 - t )}^{2} + {t}^{2}}} \cdot \frac{t}{\sqrt{{N}_{b}}} , and$$

$$MPCat ( a , b , t ) = c = \sqrt{\frac{{N}_{a} + {N}_{b}}{{( 1 - t )}^{2} + {t}^{2}}} \cdot [ \frac{1 - t}{\sqrt{{N}_{a}}} a ⊕ \frac{t}{\sqrt{{N}_{b}}} b ] ,$$

where c is an output vector produced by the balanced concatenation operation.

While FIG. 2 illustrates balanced concatenation layer 250 receiving input from only two upstream paths, it will be appreciated by those skilled in the art that the balanced concatenation layer 250 can receive input from three or more upstream paths. In at least one embodiment, the process 200 includes, receiving n concatenation layer inputs via n different input paths, normalizing each of the n received concatenation layer inputs, scaling each of the n received concatenation layer inputs via n different scaling factors, and concatenating the n scaled inputs. In at least one embodiment, each of the n concatenation layer inputs is in the form of a vector aᵢ for i=1, . . . , n, the n scaling factors [symbol] ᵢ are determined by n mixing factors tᵢ and the channel counts Nᵢ of the n vectors. In at least one embodiment:

$$c = {1}_{} {a}_{1} ⊕ {2}_{} {a}_{2} ⊕ … ⊕ {n}_{} {a}_{n} ,$$

$${i}_{} = \sqrt{\frac{{\sum }_{j = 1}^{n} {N}_{j}}{{\sum }_{j = 1}^{n} {t}_{j}^{2}}} \cdot \frac{{t}_{i}}{\sqrt{{N}_{i}}} , and$$

$$MPCat ( a , b , t ) = c = \sqrt{\frac{{\sum }_{j = 1}^{n} {N}_{j}}{{\sum }_{j = 1}^{n} {t}_{j}^{2}}} \cdot [ \frac{{t}_{i}}{\sqrt{{N}_{i}}} {a}_{1} ⊕ \frac{{t}_{2}}{\sqrt{{N}_{2}}} {a}_{2} ⊕ … ⊕ \frac{{t}_{n}}{\sqrt{{N}_{n}}} {a}_{n} ] ,$$

where c is an output vector produced by the balanced concatenation operation and Σ₁ⁿ tᵢ=1.

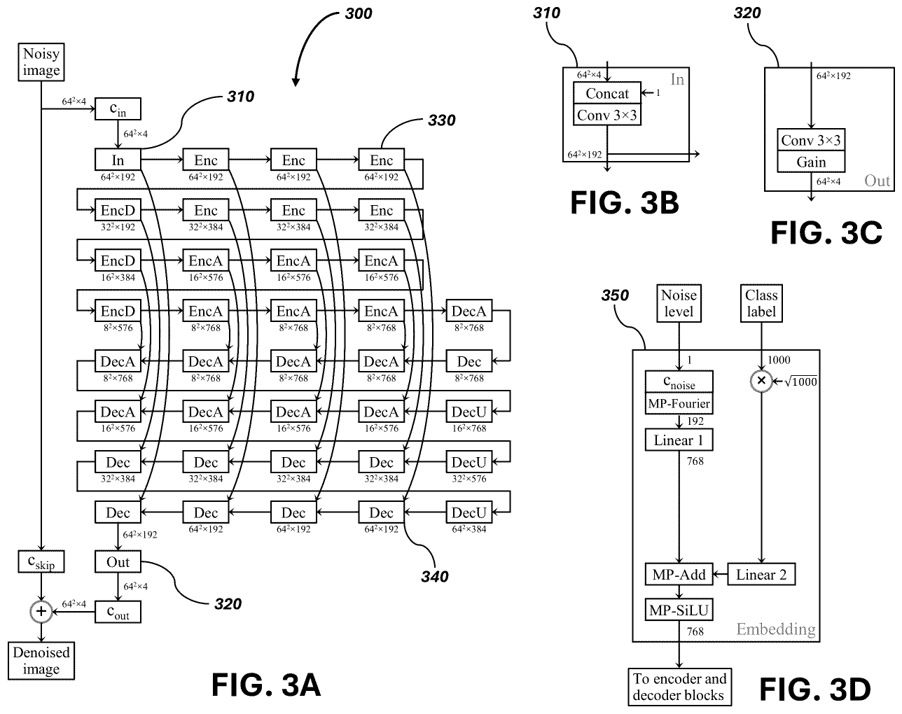

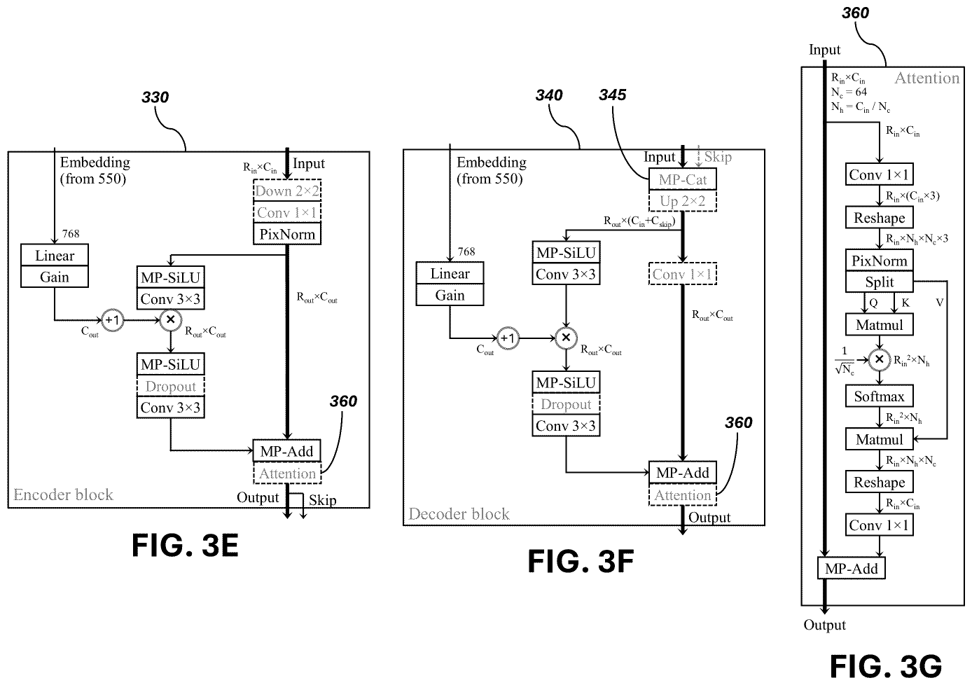

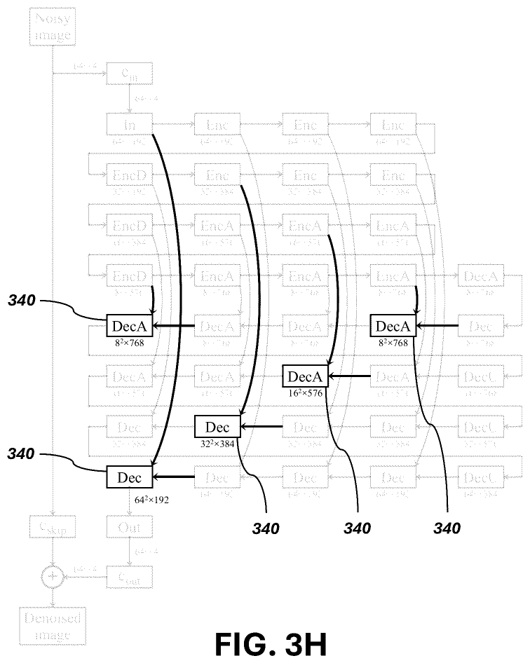

FIG. 3A illustrates a diffusion model (DM) architecture, according to at least one embodiment. The DM 300 receives, as input, a noisy image and generates, as output, a denoised image. The DM 300 includes an input block 310, an output block 320, a plurality of encoder blocks (Enc), e.g. encoder block 330, and a plurality of decoder blocks (Dec), e.g. decoder block 340. The DM 300 additionally includes an embedding network 350 that conditions the encoder blocks and the decoder blocks with a noise level and class label. In at least one embodiment, a balanced concatenation layer 150 is included in the DM 300. FIG. 3H illustrates, according to at least one embodiment, a plurality of decoder blocks 340 that include balanced concatenation layers. In at least one embodiment, the DM 300 is trained via the process 100 of FIG. 1. In at least one embodiment, the DM 300 is used in the method 200 of FIG. 2 for performing inference.

The plurality of encoder blocks include encoder downsampling blocks (EncD) which perform downsampling operations on the input they receive. The encoder downsampling blocks reduce spatial dimensions of their input and/or increase the number of channels/features incorporated in their output. The plurality of decoder blocks include decoder upsampling blocks (DecU) which perform upsampling operations on the input they receive. The decoder upsampling blocks increase spatial dimensions of the input they receive and/or decrease the number of channels/features incorporated in their output. The plurality of encoder blocks and the plurality of decoder blocks additionally include encoder attention blocks (EncA) and decoder attention blocks (DecA) which incorporate attention mechanisms into encoding processes and decoding processes, respectively. The encoder attention blocks enable the DM 300 to capture long-range dependencies in the data, allow the encoder to focus on relevant parts of the input, and enhance the ability of the DM 300 to learn complex relationships. The decoder attention blocks enable the DM 300 to refine generated output by attending to relevant encoded features, improve the coherence and quality of the reconstructed data, and allow the decoder to access information from the entire input sequence. In at least one embodiment, one or more encoder attention blocks and one or more decoder attention blocks utilize self-attention. In at least one embodiment, one or more encoder attention blocks and one or more decoder attention blocks utilize cross-attention. In at least one embodiment, one or more encoder attention blocks and one or more decoder attention blocks utilize both self-attention and cross-attention.

FIG. 3B illustrates an input block 310 of the diffusion model of FIG. 3A, according to at least one embodiment. The input block 310 includes a concatenation layer and a convolutional layer. FIG. 3C illustrates an output block 320 of the diffusion model of FIG. 3A, according to at least one embodiment. The output block 320 includes a convolutional layer and a gain parameter.

FIG. 3D illustrates an embedding network of the diffusion model of FIG. 3A, according to at least one embodiment. The embedding network 350 receives, as input, a noise level and a class label and processes the input to provide, as input for the encoder and decoder blocks, a combined noise level and class label embedding. The embedding network 350 thereby both (i) encodes the noise level of a diffusion process into a vector representation that can be used by the encoder and decoder blocks of the DM 300 and (ii) encodes class labels into a vector representation that can be used by the encoder and decoder blocks of the DM 300. The embedding network 350 includes a magnitude preserving summation layer (MP-Add) that combines the noise level and class label embeddings.

FIG. 3E illustrates an encoder block of the diffusion model of FIG. 3A, according to at least one embodiment. The encoder block 330 receives, as input, an embedding from embedding network 350 and a main path input (e.g. from input block 310 or from a preceding encoder block). The encoder block 330 processes the input embedding and the main path input to generate output, which is provided to both (i) a subsequent encoder block or a decoder block in the main path and (ii) a corresponding decoder block via a skip connection. If the encoder block 330 is an encoder downsampling block (EncD), the encoder block 330 includes a downsampling layer (Down 2×2) and a convolutional layer (Conv 1×1). If the encoder block 330 is an encoder attention block (EncA), the encoder block 330 includes an attention block 360.

FIG. 3F illustrates a decoder block of the diffusion model of FIG. 3A, according to at least one embodiment. The decoder block 340 receives, as input, an embedding from embedding network 350, a main path input (e.g. from a preceding encoder or decoder block), and a skip connection input from a corresponding encoder block. The decoder block 340 processes the input to generate output, which is provided, via the main path, to a subsequent decoder block or to the output block 320. The decoder block 340 includes a magnitude-preserving, balanced concatenation layer 345. In at least one embodiment, the process 100 of FIG. 1 is used to train the DM 300, and the balanced concatenation layer 345 is the balanced concatenation layer 150 of FIG. 1. In at least one embodiment, the DM 300 is the neural network used for performing inference in the process 200 of FIG. 2, and the balanced concatenation layer 345 is the balanced concatenation layer 250 of FIG. 2. If the decoder block 340 is decoder upsampling block (DecU), the decoder block 340 includes an upsampling layer (Up 2×2) and a convolutional layer (Conv 1×1). If the decoder block is a decoder attention block (DecA), the decoder block 340 includes an attention block 360.

FIG. 3G illustrates an attention block of the diffusion model of FIG. 3A, according to at least one embodiment. The attention block 360 receives input, processes the input to capture, e.g., contextual information and long-range dependencies in the data, and provides output that incorporates, e.g., the contextual information and/or information pertaining to the long-range dependencies.

### Logic

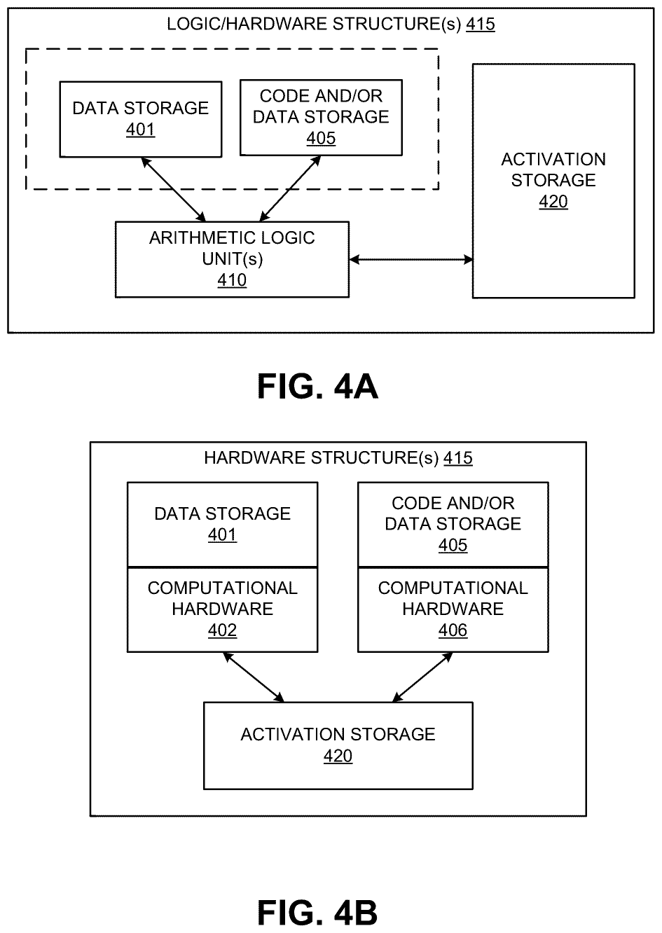

FIG. 4A illustrates logic 415 which, as described elsewhere herein, can be used in one or more devices to perform operations such as those discussed herein in accordance with at least one embodiment. In at least one embodiment, logic 415 is used to perform inferencing and/or training operations associated with one or more embodiments. In at least one embodiment, logic 415 is inference and/or training logic. Details regarding logic 415 are provided below in conjunction with FIGS. 4A and/or 4B. In at least one embodiment, logic refers to any combination of software logic, hardware logic, and/or firmware logic to provide functionality or operations described herein, wherein logic may be, collectively or individually, embodied as circuitry that forms part of a larger system, for example, an integrated circuit (IC), system-on-chip (SoC), or one or processors (e.g., CPU, GPU).

In at least one embodiment, logic 415 may include, without limitation, code and/or data storage 401 to store forward and/or output weight and/or input/output data, and/or other parameters to configure neurons or layers of a neural network trained and/or used for inferencing in aspects of one or more embodiments. In at least one embodiment, logic 415 may include, or be coupled to code and/or data storage 401 to store graph code or other software to control timing and/or order, in which weight and/or other parameter information is to be loaded to configure, logic, including integer and/or floating point units (collectively, arithmetic logic units (ALUs)). In at least one embodiment, code, such as graph code, loads weight or other parameter information into processor ALUs based on an architecture of a neural network to which such code corresponds. In at least one embodiment, code and/or data storage 401 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 401 may be included with other on-chip or off-chip data storage, including a processor's L1, L2, or L3 cache or system memory.

In at least one embodiment, any portion of code and/or data storage 401 may be internal or external to one or more processors or other hardware logic devices or circuits. In at least one embodiment, code and/or code and/or data storage 401 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 401 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, logic 415 may include, without limitation, a code and/or data storage 405 to store backward and/or output weight and/or input/output data corresponding to neurons or layers of a neural network trained and/or used for inferencing in aspects of one or more embodiments. In at least one embodiment, code and/or data storage 405 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, logic 415 may include, or be coupled to code and/or data storage 405 to store graph code or other software to control timing and/or order, in which weight and/or other parameter information is to be loaded to configure, logic, including integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 405 may be included with other on-chip or off-chip data storage, including a processor's L1, L2, or L3 cache or system memory. In at least one embodiment, any portion of code and/or data storage 405 may be internal or external to one or more processors or other hardware logic devices or circuits. In at least one embodiment, code and/or data storage 405 may be cache memory, DRAM, SRAM, non-volatile memory (e.g., flash memory), or other storage. In at least one embodiment, a choice of whether code and/or data storage 405 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 401 and code and/or data storage 405 may be separate storage structures. In at least one embodiment, code and/or data storage 401 and code and/or data storage 405 may be a combined storage structure. In at least one embodiment, code and/or data storage 401 and code and/or data storage 405 may be partially combined and partially separate. In at least one embodiment, any portion of code and/or data storage 401 and code and/or data storage 405 may be included with other on-chip or off-chip data storage, including a processor's L1, L2, or L3 cache or system memory.

In at least one embodiment, logic 415 may include, without limitation, one or more arithmetic logic unit(s) (“ALU(s)”) 410, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 420 that are functions of input/output and/or weight parameter data stored in code and/or data storage 401 and/or code and/or data storage 405. In at least one embodiment, activations stored in activation storage 420 are generated according to linear algebraic and or matrix-based mathematics performed by ALU(s) 410 in response to performing instructions or other code, wherein weight values stored in code and/or data storage 405 and/or data storage 401 are used as operands along with other values, such as bias values, gradient information, momentum values, or other parameters or hyperparameters, any or all of which may be stored in code and/or data storage 405 or code and/or data storage 401 or another storage on or off-chip.

In at least one embodiment, ALU(s) 410 are included within one or more processors or other hardware logic devices or circuits, whereas in another embodiment, ALU(s) 410 may be external to a processor or other hardware logic device or circuit that uses them (e.g., a co-processor). In at least one embodiment, ALUs 410 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 401, code and/or data storage 405, and activation storage 420 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 420 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 420 may be cache memory, DRAM, SRAM, non-volatile memory (e.g., flash memory), or other storage. In at least one embodiment, activation storage 420 may be completely or partially within or external to one or more processors or other logical circuits. In at least one embodiment, a choice of whether activation storage 420 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, logic 415 illustrated in FIG. 4A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, logic 415 illustrated in FIG. 4A may be used in conjunction with central processing unit (“CPU”) hardware, graphics processing unit (“GPU”) hardware or other hardware, such as field programmable gate arrays (“FPGAs”).

FIG. 4B illustrates logic 415, according to at least one embodiment. In at least one embodiment, logic 415 is inference and/or training logic. In at least one embodiment, logic 415 may include, without limitation, hardware logic in which computational resources are dedicated or otherwise exclusively used in conjunction with weight values or other information corresponding to one or more layers of neurons within a neural network. In at least one embodiment, logic 415 illustrated in FIG. 4B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, logic 415 illustrated in FIG. 4B may be used in conjunction with central processing unit (CPU) hardware, graphics processing unit (GPU) hardware or other hardware, such as field programmable gate arrays (FPGAs). In at least one embodiment, logic 415 includes, without limitation, code and/or data storage 401 and code and/or data storage 405, which may be used to store code (e.g., graph code), weight values and/or other information, including bias values, gradient information, momentum values, and/or other parameter or hyperparameter information. In at least one embodiment illustrated in FIG. 4B, each of code and/or data storage 401 and code and/or data storage 405 is associated with a dedicated computational resource, such as computational hardware 402 and computational hardware 406, respectively. In at least one embodiment, each of computational hardware 402 and computational hardware 406 comprises one or more ALUs that perform mathematical functions, such as linear algebraic functions, only on information stored in code and/or data storage 401 and code and/or data storage 405, respectively, result of which is stored in activation storage 420.

In at least one embodiment, each of code and/or data storage 401 and 405 and corresponding computational hardware 402 and 406, respectively, correspond to different layers of a neural network, such that resulting activation from one storage/computational pair 401/402 of code and/or data storage 401 and computational hardware 402 is provided as an input to a next storage/computational pair 405/406 of code and/or data storage 405 and computational hardware 406, in order to mirror a conceptual organization of a neural network. In at least one embodiment, each of storage/computational pairs 401/402 and 405/406 may correspond to more than one neural network layer. In at least one embodiment, additional storage/computation pairs (not shown) subsequent to or in parallel with storage/computation pairs 401/402 and 405/406 may be included in logic 415.

### Neural Network Training and Deployment

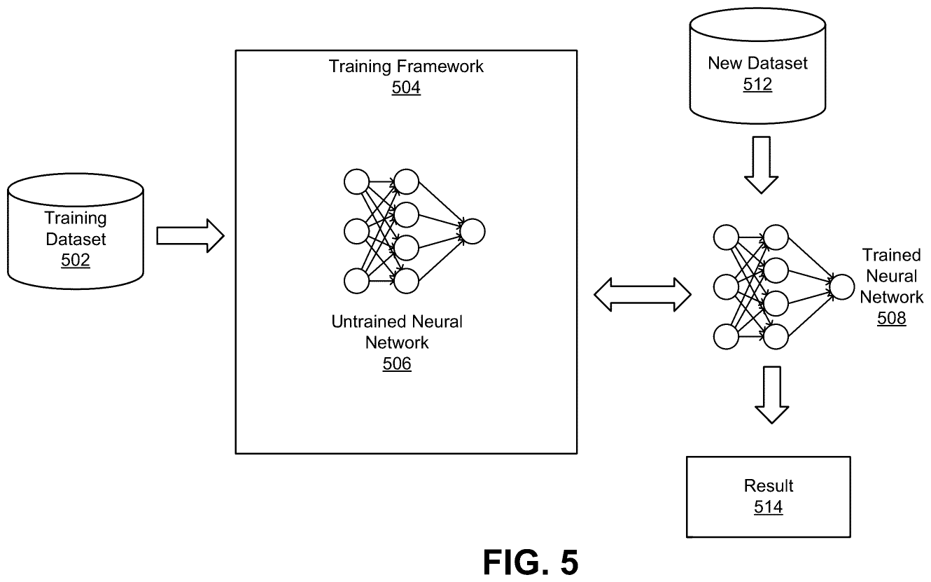

FIG. 5 illustrates training and deployment of a deep neural network, according to at least one embodiment. In at least one embodiment, untrained neural network 506 is trained using a training dataset 502. In at least one embodiment, training framework 504 is a PyTorch framework, whereas in other embodiments, training framework 504 is a TensorFlow, Boost, Caffe, Microsoft Cognitive Toolkit/CNTK, MXNet, Chainer, Keras, Deeplearning4j, or other training framework. In at least one embodiment, training framework 504 trains an untrained neural network 506 and enables it to be trained using processing resources described herein to generate a trained neural network 508. In at least one embodiment, weights may be chosen randomly or by pre-training using a deep belief network. In at least one embodiment, training may be performed in either a supervised, partially supervised, or unsupervised manner.

In at least one embodiment, untrained neural network 506 is trained using supervised learning, wherein training dataset 502 includes an input paired with a desired output for an input, or where training dataset 502 includes input having a known output and an output of neural network 506 is manually graded. In at least one embodiment, untrained neural network 506 is trained in a supervised manner and processes inputs from training dataset 502 and compares resulting outputs against a set of expected or desired outputs. In at least one embodiment, errors are then propagated back through untrained neural network 506. In at least one embodiment, training framework 504 adjusts weights that control untrained neural network 506. In at least one embodiment, training framework 504 includes tools to monitor how well untrained neural network 506 is converging towards a model, such as trained neural network 508, suitable to generating correct answers, such as in result 514, based on input data such as a new dataset 512. In at least one embodiment, training framework 504 trains untrained neural network 506 repeatedly while adjust weights to refine an output of untrained neural network 506 using a loss function and adjustment algorithm, such as stochastic gradient descent. In at least one embodiment, training framework 504 trains untrained neural network 506 until untrained neural network 506 achieves a desired accuracy. In at least one embodiment, trained neural network 508 can then be deployed to implement any number of machine learning operations.

In at least one embodiment, untrained neural network 506 is trained using unsupervised learning, wherein untrained neural network 506 attempts to train itself using unlabeled data. In at least one embodiment, unsupervised learning training dataset 502 will include input data without any associated output data or “ground truth” data. In at least one embodiment, untrained neural network 506 can learn groupings within training dataset 502 and can determine how individual inputs are related to untrained dataset 502. In at least one embodiment, unsupervised training can be used to generate a self-organizing map in trained neural network 508 capable of performing operations useful in reducing dimensionality of new dataset 512. In at least one embodiment, unsupervised training can also be used to perform anomaly detection, which allows identification of data points in new dataset 512 that deviate from normal patterns of new dataset 512.

In at least one embodiment, semi-supervised learning may be used, which is a technique in which in training dataset 502 includes a mix of labeled and unlabeled data. In at least one embodiment, training framework 504 may be used to perform incremental learning, such as through transferred learning techniques. In at least one embodiment, incremental learning enables trained neural network 508 to adapt to new dataset 512 without forgetting knowledge instilled within trained neural network 508 during initial training.

In at least one embodiment, training framework 504 is a framework processed in connection with a software development toolkit such as an OpenVINO (Open Visual Inference and Neural network Optimization) toolkit. In at least one embodiment, an OpenVINO toolkit is a toolkit such as those developed by Intel Corporation of Santa Clara, CA. In at least one embodiment, OpenVINO comprises logic 415 or uses logic 415 to perform operations described herein. In at least one embodiment, an SoC, integrated circuit, or processor uses OpenVINO to perform operations described herein.

In at least one embodiment, OpenVINO is a toolkit for facilitating development of applications, specifically neural network applications, for various tasks and operations, such as human vision emulation, speech recognition, natural language processing, recommendation systems, and/or variations thereof. In at least one embodiment, Open VINO supports neural networks such as convolutional neural networks (CNNs), recurrent and/or attention-based neural networks, and/or various other neural network models. In at least one embodiment, OpenVINO supports various software libraries such as OpenCV, OpenCL, and/or variations thereof.

In at least one embodiment, OpenVINO supports neural network models for various tasks and operations, such as classification, segmentation, object detection, face recognition, speech recognition, pose estimation (e.g., humans and/or objects), monocular depth estimation, image inpainting, style transfer, action recognition, colorization, and/or variations thereof.

In at least one embodiment, OpenVINO comprises one or more software tools and/or modules for model optimization, also referred to as a model optimizer. In at least one embodiment, a model optimizer is a command line tool that facilitates transitions between training and deployment of neural network models. In at least one embodiment, a model optimizer optimizes neural network models for execution on various devices and/or processing units, such as a GPU, CPU, PPU, GPGPU, and/or variations thereof. In at least one embodiment, a model optimizer generates an internal representation of a model, and optimizes said model to generate an intermediate representation. In at least one embodiment, a model optimizer reduces a number of layers of a model. In at least one embodiment, a model optimizer removes layers of a model that are utilized for training. In at least one embodiment, a model optimizer performs various neural network operations, such as modifying inputs to a model (e.g., resizing inputs to a model), modifying a size of inputs of a model (e.g., modifying a batch size of a model), modifying a model structure (e.g., modifying layers of a model), normalization, standardization, quantization (e.g., converting weights of a model from a first representation, such as floating point, to a second representation, such as integer), and/or variations thereof.

In at least one embodiment, OpenVINO comprises one or more software libraries for inferencing, also referred to as an inference engine. In at least one embodiment, an inference engine is a C++ library, or any suitable programming language library. In at least one embodiment, an inference engine is utilized to infer input data. In at least one embodiment, an inference engine implements various classes to infer input data and generate one or more results. In at least one embodiment, an inference engine implements one or more API functions to process an intermediate representation, set input and/or output formats, and/or execute a model on one or more devices.

In at least one embodiment, OpenVINO provides various abilities for heterogeneous execution of one or more neural network models. In at least one embodiment, heterogeneous execution, or heterogeneous computing, refers to one or more computing processes and/or systems that utilize one or more types of processors and/or cores. In at least one embodiment, Open VINO provides various software functions to execute a program on one or more devices. In at least one embodiment, OpenVINO provides various software functions to execute a program and/or portions of a program on different devices. In at least one embodiment, Open VINO provides various software functions to, for example, run a first portion of code on a CPU and a second portion of code on a GPU and/or FPGA. In at least one embodiment, Open VINO provides various software functions to execute one or more layers of a neural network on one or more devices (e.g., a first set of layers on a first device, such as a GPU, and a second set of layers on a second device, such as a CPU).

In at least one embodiment, OpenVINO includes various functionality similar to functionalities associated with a CUDA programming model, such as various neural network model operations associated with frameworks such as TensorFlow, PyTorch, and/or variations thereof. In at least one embodiment, one or more CUDA programming model operations are performed using OpenVINO. In at least one embodiment, various systems, methods, and/or techniques described herein are implemented using OpenVINO.

### Data Center

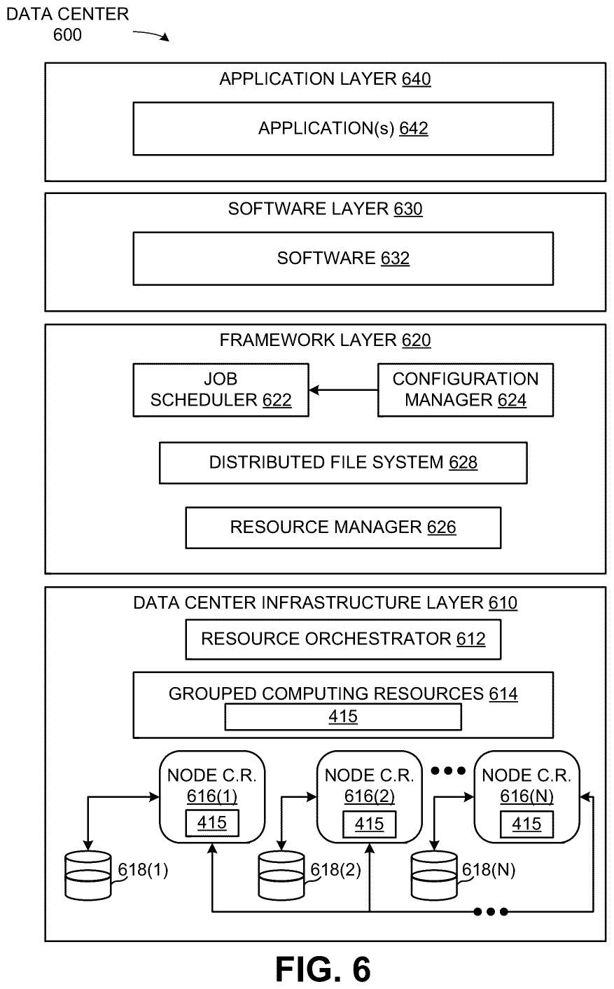

FIG. 6 illustrates an example data center 600, in which at least one embodiment may be used. In at least one embodiment, data center 600 includes a data center infrastructure layer 610, a framework layer 620, a software layer 630 and an application layer 640.

In at least one embodiment, as shown in FIG. 6, data center infrastructure layer 610 may include a resource orchestrator 612, grouped computing resources 614, and node computing resources (“node C.R.s”) 616(1)-616(N), where “N” represents a positive integer (which may be a different integer “N” than used in other figures). In at least one embodiment, node C.R.s 616(1)-616(N) may include, but are not limited to, any number of central processing units (“CPUs”) or other processors (including accelerators, field programmable gate arrays (FPGAs), graphics processors, etc.), memory storage devices 618(1)-618(N) (e.g., dynamic read-only memory, solid state storage or disk drives), network input/output (“NW I/O”) devices, network switches, virtual machines (“VMs”), power modules, and cooling modules, etc. In at least one embodiment, one or more node C.R.s from among node C.R.s 616(1)-616(N) may be a server having one or more of above-mentioned computing resources.

In at least one embodiment, grouped computing resources 614 may include separate groupings of node C.R.s housed within one or more racks (not shown), or many racks housed in data centers at various geographical locations (also not shown). In at least one embodiment, separate groupings of node C.R.s within grouped computing resources 614 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 612 may configure or otherwise control one or more node C.R.s 616(1)-616(N) and/or grouped computing resources 614. In at least one embodiment, resource orchestrator 612 may include a software design infrastructure (“SDI”) management entity for data center 600. In at least one embodiment, resource orchestrator 412 may include hardware, software or some combination thereof.

In at least one embodiment, as shown in FIG. 6, framework layer 620 includes a job scheduler 622, a configuration manager 624, a resource manager 626 and a distributed file system 628. In at least one embodiment, framework layer 620 may include a framework to support software 632 of software layer 630 and/or one or more application(s) 642 of application layer 640. In at least one embodiment, software 632 or application(s) 642 may respectively include web-based service software or applications, such as those provided by Amazon Web Services, Google Cloud and Microsoft Azure. In at least one embodiment, framework layer 620 may be, but is not limited to, a type of free and open-source software web application framework such as Apache Spark™ (hereinafter “Spark”) that may utilize distributed file system 628 for large-scale data processing (e.g., “big data”). In at least one embodiment, job scheduler 622 may include a Spark driver to facilitate scheduling of workloads supported by various layers of data center 600. In at least one embodiment, configuration manager 624 may be capable of configuring different layers such as software layer 630 and framework layer 620 including Spark and distributed file system 628 for supporting large-scale data processing. In at least one embodiment, resource manager 626 may be capable of managing clustered or grouped computing resources mapped to or allocated for support of distributed file system 628 and job scheduler 622. In at least one embodiment, clustered or grouped computing resources may include grouped computing resources 614 at data center infrastructure layer 610. In at least one embodiment, resource manager 626 may coordinate with resource orchestrator 612 to manage these mapped or allocated computing resources.

In at least one embodiment, software 632 included in software layer 630 may include software used by at least portions of node C.R.s 616(1)-616(N), grouped computing resources 614, and/or distributed file system 628 of framework layer 620. In at least one embodiment, one or more types of software may include, but are not limited to, Internet web page search software, e-mail virus scan software, database software, and streaming video content software.

In at least one embodiment, application(s) 642 included in application layer 640 may include one or more types of applications used by at least portions of node C.R.s 616(1)-616(N), grouped computing resources 614, and/or distributed file system 628 of framework layer 620. In at least one embodiment, one or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 624, resource manager 626, and resource orchestrator 612 may implement any number and type of self-modifying actions based on any amount and type of data acquired in any technically feasible fashion. In at least one embodiment, self-modifying actions may relieve a data center operator of data center 600 from making possibly bad configuration decisions and possibly avoiding underutilized and/or poor performing portions of a data center.

In at least one embodiment, data center 600 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 600. In at least one embodiment, trained machine learning models corresponding to one or more neural networks may be used to infer or predict information using resources described above with respect to data center 600 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Logic 415 are used to perform inferencing and/or training operations associated with one or more embodiments. Details regarding logic 415 are provided herein in conjunction with FIGS. 4A and/or 4B. In at least one embodiment, logic 415 may be used in data center 600 for inferencing or predicting operations based, at least in part, on weight parameters calculated using neural network training operations, neural network functions and/or architectures, or neural network use cases described herein.

### Computer Systems

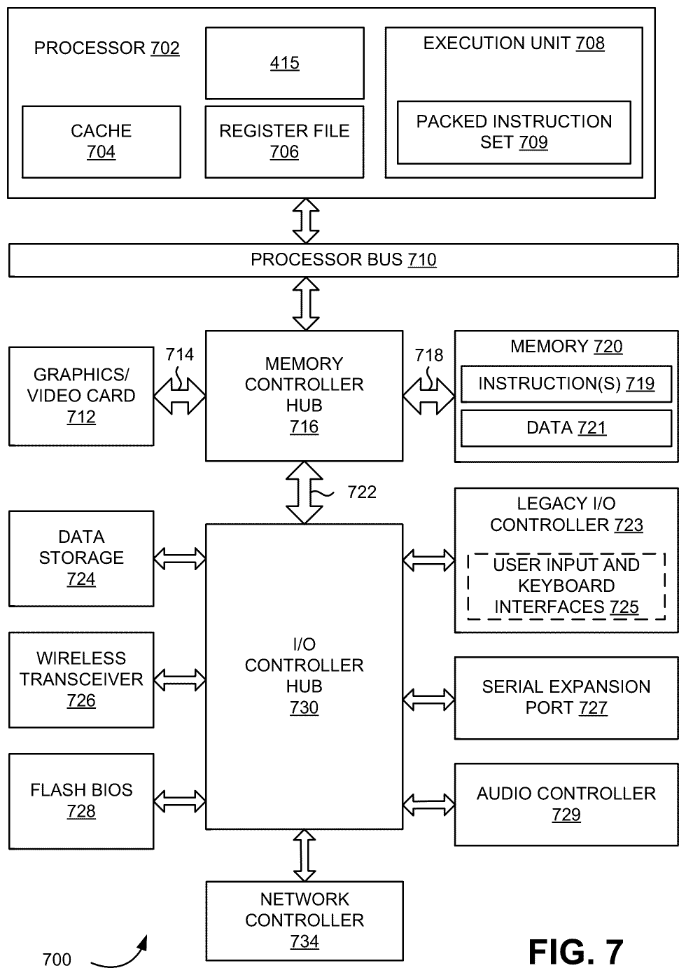

FIG. 7 is a block diagram illustrating an exemplary computer system, which may be a system with interconnected devices and components, a system-on-a-chip (SOC) or some combination thereof formed with a processor that may include execution units to execute an instruction, according to at least one embodiment. In at least one embodiment, a computer system 700 may include, without limitation, a component, such as a processor 702 to employ execution units including logic to perform algorithms for process data, in accordance with present disclosure, such as in embodiment described herein. In at least one embodiment, computer system 700 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 700 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 700 may include, without limitation, processor 702 that may include, without limitation, one or more execution units 708 to perform machine learning model training and/or inferencing according to techniques described herein. In at least one embodiment, computer system 700 is a single processor desktop or server system, but in another embodiment, computer system 700 may be a multiprocessor system. In at least one embodiment, processor 702 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 702 may be coupled to a processor bus 710 that may transmit data signals between processor 702 and other components in computer system 700.

In at least one embodiment, processor 702 may include, without limitation, a Level 1 (“L1”) internal cache memory (“cache”) 704. In at least one embodiment, processor 702 may have a single internal cache or multiple levels of internal cache. In at least one embodiment, cache memory may reside external to processor 702. Other embodiments may also include a combination of both internal and external caches depending on particular implementation and needs. In at least one embodiment, a register file 706 may store different types of data in various registers including, without limitation, integer registers, floating point registers, status registers, and an instruction pointer register.

In at least one embodiment, execution unit 708, including, without limitation, logic to perform integer and floating point operations, also resides in processor 702. In at least one embodiment, processor 702 may also include a microcode (“ucode”) read only memory (“ROM”) that stores microcode for certain macro instructions. In at least one embodiment, execution unit 708 may include logic to handle a packed instruction set 709. In at least one embodiment, by including packed instruction set 709 in an instruction set of a general-purpose processor, along with associated circuitry to execute instructions, operations used by many multimedia applications may be performed using packed data in processor 702. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, execution unit 708 may also be used in microcontrollers, embedded processors, graphics devices, DSPs, and other types of logic circuits. In at least one embodiment, computer system 700 may include, without limitation, a memory 720. In at least one embodiment, memory 720 may be a Dynamic Random Access Memory (“DRAM”) device, a Static Random Access Memory (“SRAM”) device, a flash memory device, or another memory device. In at least one embodiment, memory 720 may store instruction(s) 719 and/or data 721 represented by data signals that may be executed by processor 702.

In at least one embodiment, a system logic chip may be coupled to processor bus 710 and memory 720. In at least one embodiment, a system logic chip may include, without limitation, a memory controller hub (“MCH”) 716, and processor 702 may communicate with MCH 716 via processor bus 710. In at least one embodiment, MCH 716 may provide a high bandwidth memory path 718 to memory 720 for instruction and data storage and for storage of graphics commands, data and textures. In at least one embodiment, MCH 716 may direct data signals between processor 702, memory 720, and other components in computer system 700 and to bridge data signals between processor bus 710, memory 720, and a system I/O interface 722. In at least one embodiment, a system logic chip may provide a graphics port for coupling to a graphics controller. In at least one embodiment, MCH 716 may be coupled to memory 720 through high bandwidth memory path 718 and a graphics/video card 712 may be coupled to MCH 716 through an Accelerated Graphics Port (“AGP”) interconnect 714.

In at least one embodiment, computer system 700 may use system I/O interface 722 as a proprietary hub interface bus to couple MCH 716 to an I/O controller hub (“ICH”) 730. In at least one embodiment, ICH 730 may provide direct connections to some I/O devices via a local I/O bus. In at least one embodiment, a local I/O bus may include, without limitation, a high-speed I/O bus for connecting peripherals to memory 720, a chipset, and processor 702. Examples may include, without limitation, an audio controller 729, a firmware hub (“flash BIOS”) 728, a wireless transceiver 726, a data storage 724, a legacy I/O controller 723 containing user input and keyboard interfaces 725, a serial expansion port 727, such as a Universal Serial Bus (“USB”) port, and a network controller 734. In at least one embodiment, data storage 724 may comprise a hard disk drive, a floppy disk drive, a CD-ROM device, a flash memory device, or other mass storage device.

In at least one embodiment, FIG. 7 illustrates a system, which includes interconnected hardware devices or “chips”, whereas in other embodiments, FIG. 7 may illustrate an exemplary SoC. In at least one embodiment, devices illustrated in FIG. 7 may be interconnected with proprietary interconnects, standardized interconnects (e.g., PCIe) or some combination thereof. In at least one embodiment, one or more components of computer system 700 are interconnected using compute express link (CXL) interconnects.

Logic 415 are used to perform inferencing and/or training operations associated with one or more embodiments. Details regarding logic 415 are provided herein in conjunction with FIGS. 4A and/or 4B. In at least one embodiment, logic 415 may be used in computer system 700 for inferencing or predicting operations based, at least in part, on weight parameters calculated using neural network training operations, neural network functions and/or architectures, or neural network use cases described herein.

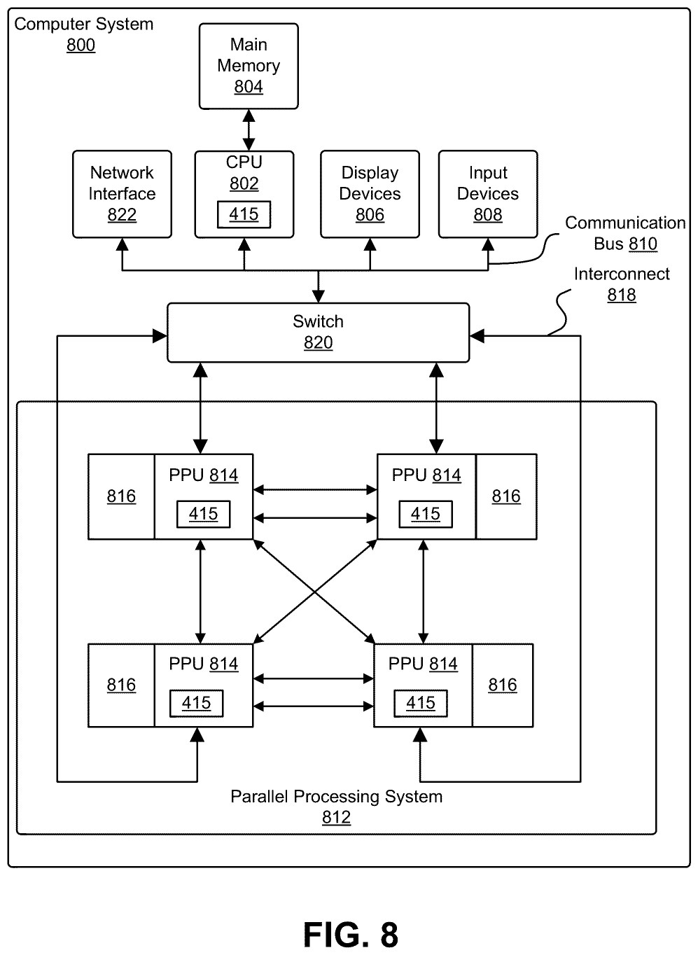

FIG. 8 illustrates a computer system 800, according to at least one embodiment. In at least one embodiment, computer system 800 is configured to implement various processes and methods described throughout this disclosure.

In at least one embodiment, computer system 800 comprises, without limitation, at least one central processing unit (“CPU”) 802 that is connected to a communication bus 810 implemented using any suitable protocol, such as PCI (“Peripheral Component Interconnect”), peripheral component interconnect express (“PCI-Express”), AGP (“Accelerated Graphics Port”), HyperTransport, or any other bus or point-to-point communication protocol(s). In at least one embodiment, computer system 800 includes, without limitation, a main memory 804 and control logic (e.g., implemented as hardware, software, or a combination thereof) and data are stored in main memory 804, which may take form of random access memory (“RAM”). In at least one embodiment, a network interface subsystem (“network interface”) 822 provides an interface to other computing devices and networks for receiving data from and transmitting data to other systems with computer system 800.

In at least one embodiment, computer system 800, in at least one embodiment, includes, without limitation, input devices 808, a parallel processing system 812, and display devices 806 that can be implemented using a conventional cathode ray tube (“CRT”), a liquid crystal display (“LCD”), a light emitting diode (“LED”) display, a plasma display, or other suitable display technologies. In at least one embodiment, user input is received from input devices 808 such as keyboard, mouse, touchpad, microphone, etc. In at least one embodiment, each module described herein can be situated on a single semiconductor platform to form a processing system.

Logic 415 are used to perform inferencing and/or training operations associated with one or more embodiments. Details regarding inference and/or training logic 415 are provided herein in conjunction with FIGS. 4A and/or 4B. In at least one embodiment, logic 415 may be used in computer system 800 for inferencing or predicting operations based, at least in part, on weight parameters calculated using neural network training operations, neural network functions and/or architectures, or neural network use cases described herein.

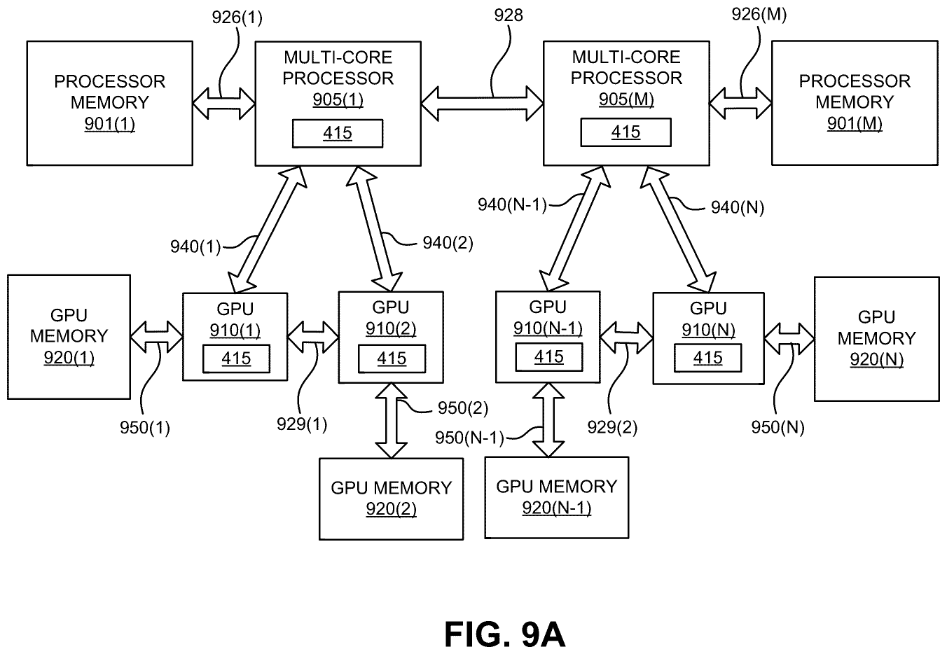

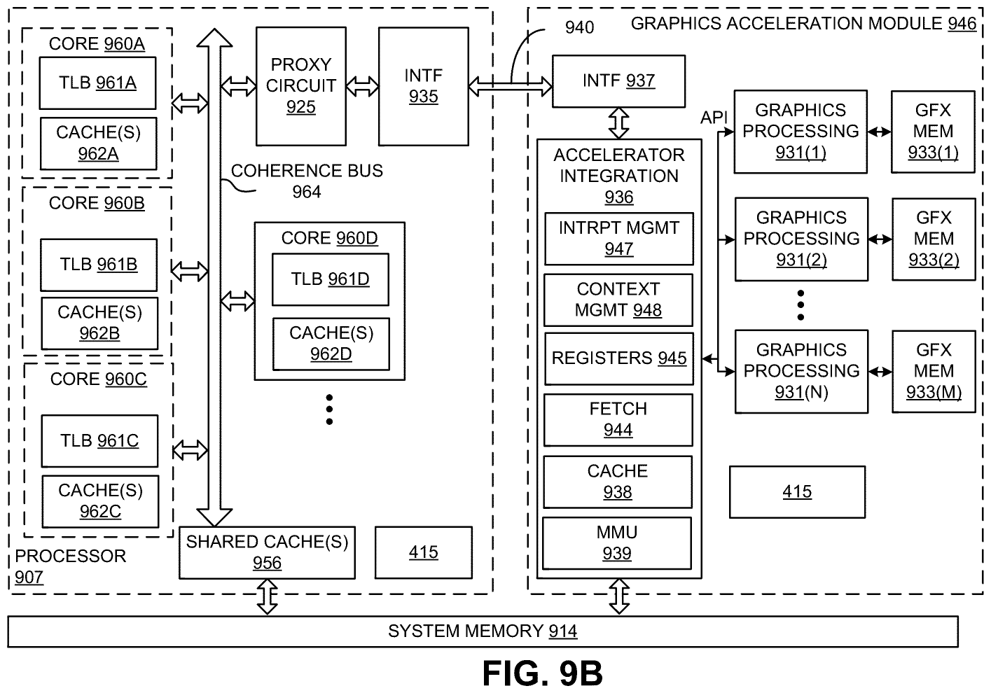

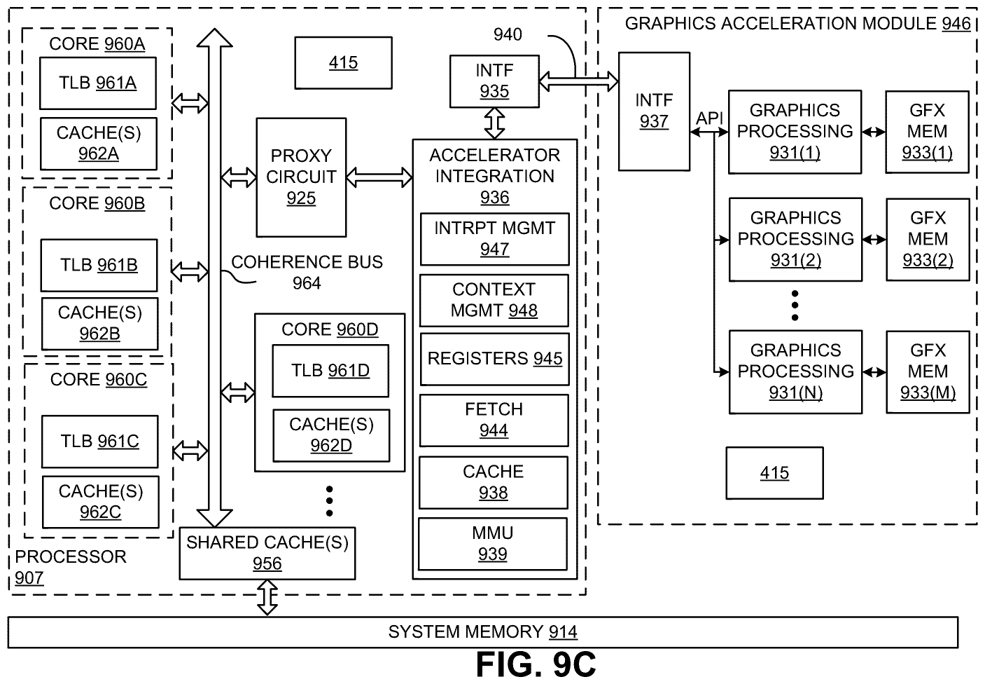

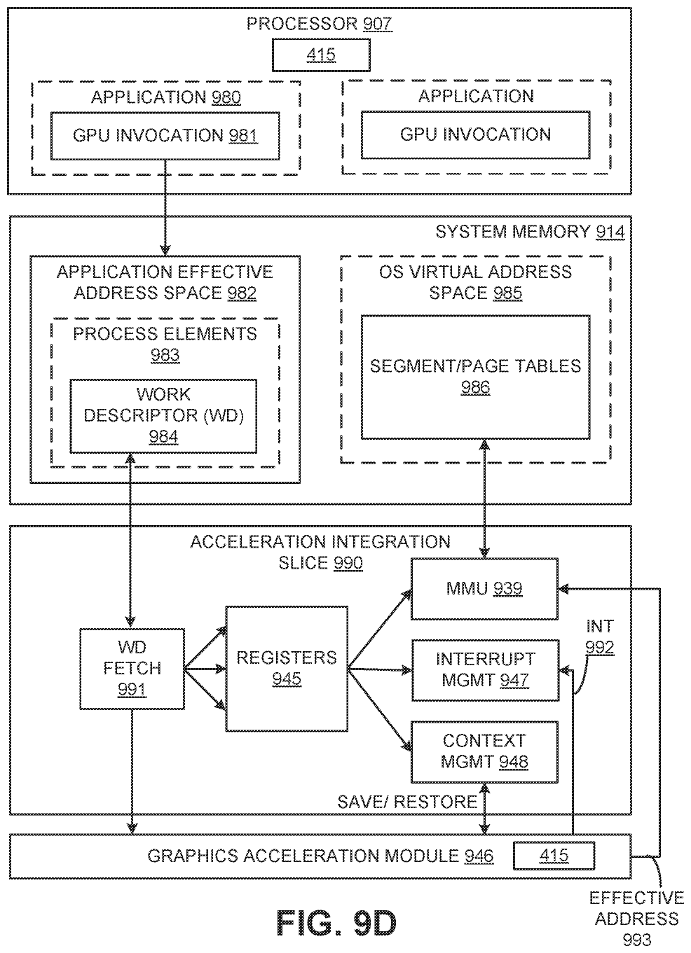

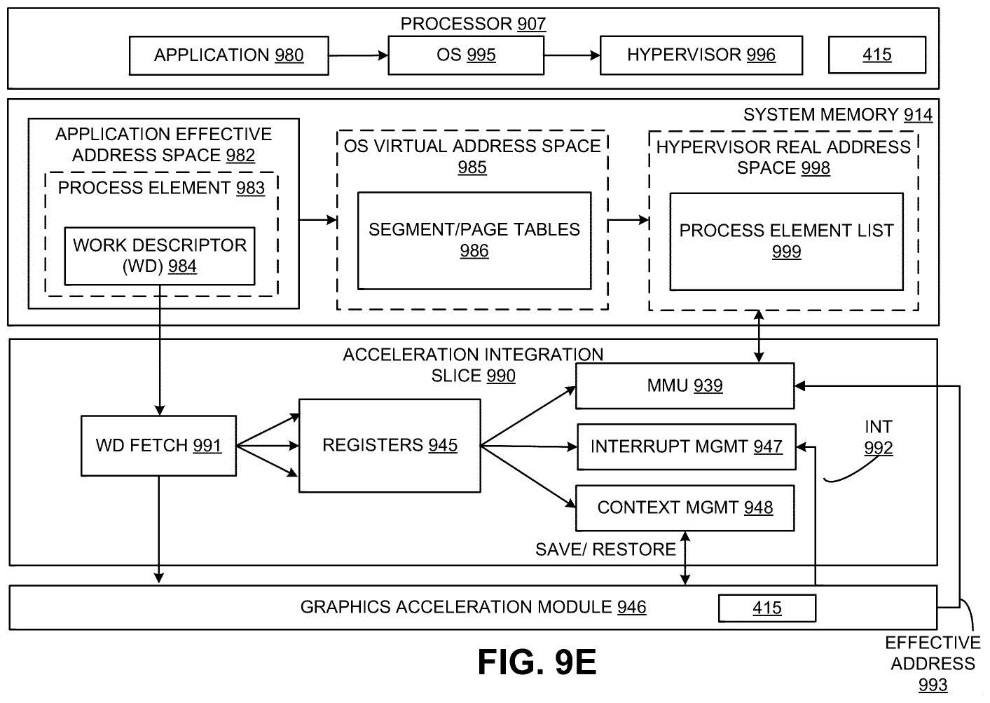

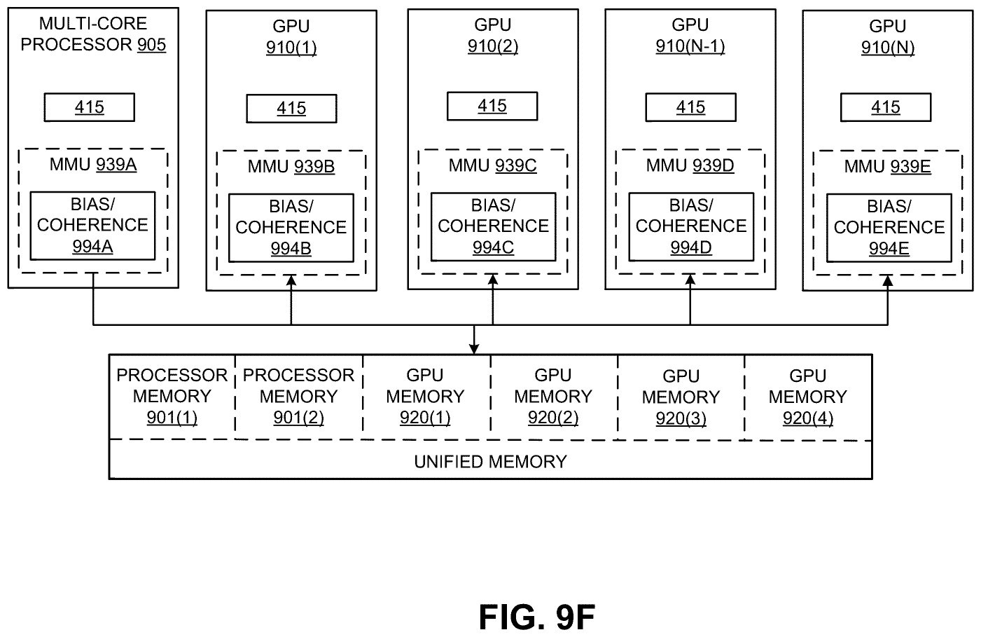

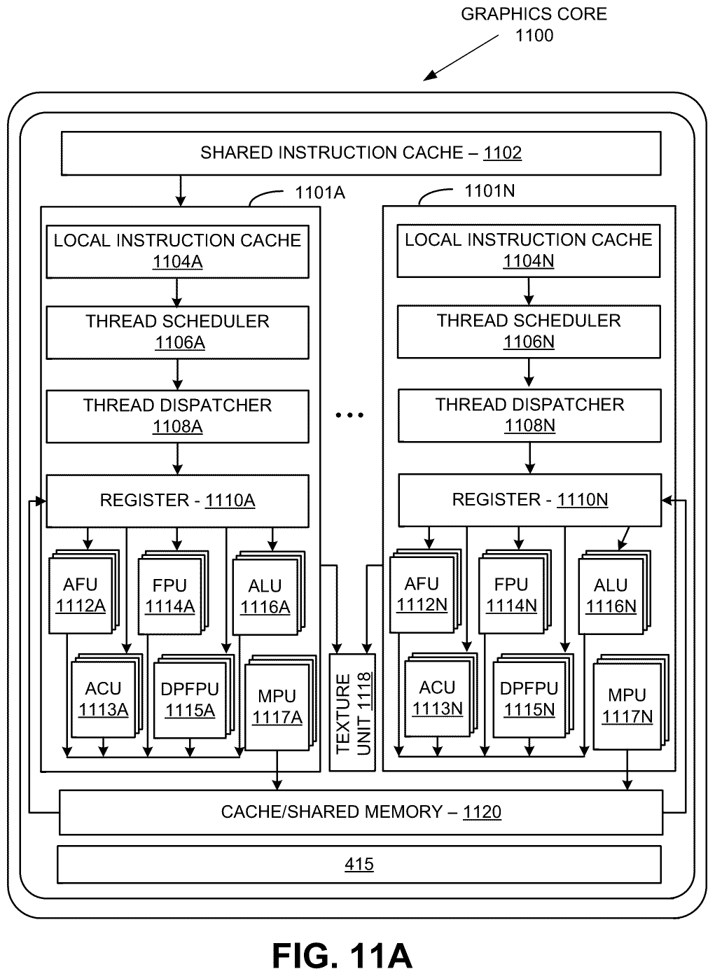

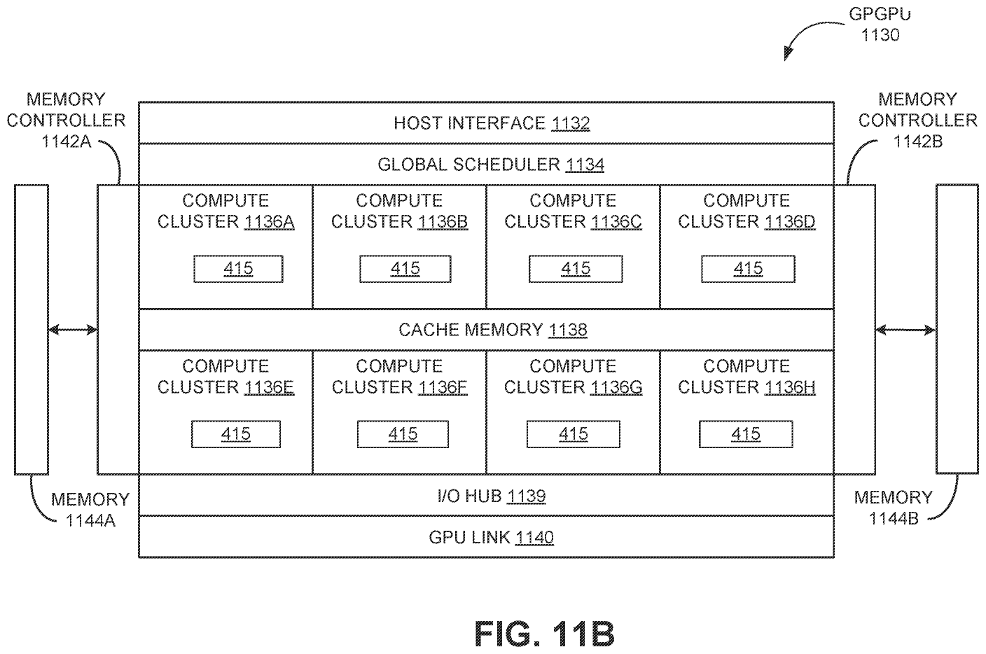

FIG. 9A illustrates an exemplary architecture in which a plurality of GPUs 910(1)-910(N) is communicatively coupled to a plurality of multi-core processors 905(1)-905(M) over high-speed links 940(1)-940(N) (e.g., buses, point-to-point interconnects, etc.). In at least one embodiment, high-speed links 940(1)-940(N) support a communication throughput of 4 GB/s, 30 GB/s, 80 GB/s or higher. In at least one embodiment, various interconnect protocols may be used including, but not limited to, PCIe 4.0 or 5.0 and NVLink 2.0. In various figures, “N” and “M” represent positive integers, values of which may be different from figure to figure. In at least one embodiment, one or more GPUs in a plurality of GPUs 910(1)-910(N) includes one or more graphics cores (also referred to simply as “cores”) 1100 as disclosed in FIGS. 11A and 11B. In at least one embodiment, one or more graphics cores 1100 may be referred to as streaming multiprocessors (“SMs”), stream processors (“SPs”), stream processing units (“SPUs”), compute units (“CUs”), execution units (“EUs”), and/or slices, where a slice in this context can refer to a portion of processing resources in a processing unit (e.g., 16 cores, a ray tracing unit, a thread director or scheduler).

In addition, and in at least one embodiment, two or more of GPUs 910 are interconnected over high-speed links 929(1)-929(2), which may be implemented using similar or different protocols/links than those used for high-speed links 940(1)-940(N). Similarly, two or more of multi-core processors 905 may be connected over a high-speed link 928 which may be symmetric multi-processor (SMP) buses operating at 20 GB/s, 30 GB/s, 120 GB/s or higher. Alternatively, all communication between various system components shown in FIG. 9A may be accomplished using similar protocols/links (e.g., over a common interconnection fabric).

In at least one embodiment, each multi-core processor 905 is communicatively coupled to a processor memory 901(1)-901(M), via memory interconnects 926(1)-926(M), respectively, and each GPU 910(1)-910(N) is communicatively coupled to GPU memory 920(1)-920(N) over GPU memory interconnects 950(1)-950(N), respectively. In at least one embodiment, memory interconnects 926 and 950 may utilize similar or different memory access technologies. By way of example, and not limitation, processor memories 901(1)-901(M) and GPU memories 920 may be volatile memories such as dynamic random access memories (DRAMs) (including stacked DRAMs), Graphics DDR SDRAM (GDDR) (e.g., GDDR5, GDDR6), or High Bandwidth Memory (HBM) and/or may be non-volatile memories such as 3D XPoint or Nano-Ram. In at least one embodiment, some portion of processor memories 901 may be volatile memory and another portion may be non-volatile memory (e.g., using a two-level memory (2LM) hierarchy).

As described herein, although various multi-core processors 905 and GPUs 910 may be physically coupled to a particular memory 901, 920, respectively, and/or a unified memory architecture may be implemented in which a virtual system address space (also referred to as “effective address” space) is distributed among various physical memories. For example, processor memories 901(1)-901(M) may each comprise 64 GB of system memory address space and GPU memories 920(1)-920(N) may each comprise 32 GB of system memory address space resulting in a total of 256 GB addressable memory when M=2 and N=4. Other values for N and M are possible.

FIG. 9B illustrates additional details for an interconnection between a multi-core processor 907 and a graphics acceleration module 946 in accordance with one exemplary embodiment. In at least one embodiment, graphics acceleration module 946 may include one or more GPU chips integrated on a line card which is coupled to processor 907 via high-speed link 940 (e.g., a PCIe bus, NVLink, etc.). In at least one embodiment, graphics acceleration module 946 may alternatively be integrated on a package or chip with processor 907.

In at least one embodiment, processor 907 includes a plurality of cores 960A-960D (which may be referred to as “execution units”), each with a translation lookaside buffer (“TLB”) 961A-961D and one or more caches 962A-962D. In at least one embodiment, cores 960A-960D may include various other components for executing instructions and processing data that are not illustrated. In at least one embodiment, caches 962A-962D may comprise Level 1 (L1) and Level 2 (L2) caches. In addition, one or more shared caches 956 may be included in caches 962A-962D and shared by sets of cores 960A-960D. For example, one embodiment of processor 907 includes 24 cores, each with its own L1 cache, twelve shared L2 caches, and twelve shared L3 caches. In this embodiment, one or more L2 and L3 caches are shared by two adjacent cores. In at least one embodiment, processor 907 and graphics acceleration module 946 connect with system memory 914, which may include processor memories 901(1)-901(M) of FIG. 9A.

In at least one embodiment, coherency is maintained for data and instructions stored in various caches 962A-962D, 956 and system memory 914 via inter-core communication over a coherence bus 964. In at least one embodiment, for example, each cache may have cache coherency logic/circuitry associated therewith to communicate to over coherence bus 964 in response to detected reads or writes to particular cache lines. In at least one embodiment, a cache snooping protocol is implemented over coherence bus 964 to snoop cache accesses.

In at least one embodiment, a proxy circuit 925 communicatively couples graphics acceleration module 946 to coherence bus 964, allowing graphics acceleration module 946 to participate in a cache coherence protocol as a peer of cores 960A-960D. In particular, in at least one embodiment, an interface 935 provides connectivity to proxy circuit 925 over high-speed link 940 and an interface 937 connects graphics acceleration module 946 to high-speed link 940.

In at least one embodiment, an accelerator integration circuit 936 provides cache management, memory access, context management, and interrupt management services on behalf of a plurality of graphics processing engines 931(1)-931(N) of graphics acceleration module 946. In at least one embodiment, graphics processing engines 931(1)-931(N) may each comprise a separate graphics processing unit (GPU). In at least one embodiment, plurality of graphics processing engines 931(1)-931(N) of graphics acceleration module 946 include one or more graphics cores 1100 as discussed in connection with FIGS. 11A and 11B. In at least one embodiment, graphics processing engines 931(1)-931(N) alternatively may comprise different types of graphics processing engines within a GPU, such as graphics execution units, media processing engines (e.g., video encoders/decoders), samplers, and blit engines. In at least one embodiment, graphics acceleration module 946 may be a GPU with a plurality of graphics processing engines 931(1)-931(N) or graphics processing engines 931(1)-931(N) may be individual GPUs integrated on a common package, line card, or chip.

In at least one embodiment, accelerator integration circuit 936 includes a memory management unit (MMU) 939 for performing various memory management functions such as virtual-to-physical memory translations (also referred to as effective-to-real memory translations) and memory access protocols for accessing system memory 914. In at least one embodiment, MMU 939 may also include a translation lookaside buffer (TLB) (not shown) for caching virtual/effective to physical/real address translations. In at least one embodiment, a cache 938 can store commands and data for efficient access by graphics processing engines 931(1)-931(N). In at least one embodiment, data stored in cache 938 and graphics memories 933(1)-933(M) is kept coherent with core caches 962A-962D, 956 and system memory 914, possibly using a fetch unit 944. As mentioned, this may be accomplished via proxy circuit 925 on behalf of cache 938 and memories 933(1)-933(M) (e.g., sending updates to cache 938 related to modifications/accesses of cache lines on processor caches 962A-962D, 956 and receiving updates from cache 938).

In at least one embodiment, a set of registers 945 store context data for threads executed by graphics processing engines 931(1)-931(N) and a context management circuit 948 manages thread contexts. For example, context management circuit 948 may perform save and restore operations to save and restore contexts of various threads during contexts switches (e.g., where a first thread is saved and a second thread is stored so that a second thread can be execute by a graphics processing engine). For example, on a context switch, context management circuit 948 may store current register values to a designated region in memory (e.g., identified by a context pointer). It may then restore register values when returning to a context. In at least one embodiment, an interrupt management circuit 947 receives and processes interrupts received from system devices.

In at least one embodiment, virtual/effective addresses from a graphics processing engine 931 are translated to real/physical addresses in system memory 914 by MMU 939. In at least one embodiment, accelerator integration circuit 936 supports multiple (e.g., 4, 8, 16) graphics accelerator modules 946 and/or other accelerator devices. In at least one embodiment, graphics accelerator module 946 may be dedicated to a single application executed on processor 907 or may be shared between multiple applications. In at least one embodiment, a virtualized graphics execution environment is presented in which resources of graphics processing engines 931(1)-931(N) are shared with multiple applications or virtual machines (VMs). In at least one embodiment, resources may be subdivided into “slices” which are allocated to different VMs and/or applications based on processing requirements and priorities associated with VMs and/or applications.

In at least one embodiment, accelerator integration circuit 936 performs as a bridge to a system for graphics acceleration module 946 and provides address translation and system memory cache services. In addition, in at least one embodiment, accelerator integration circuit 936 may provide virtualization facilities for a host processor to manage virtualization of graphics processing engines 931(1)-931(N), interrupts, and memory management.

In at least one embodiment, because hardware resources of graphics processing engines 931(1)-931(N) are mapped explicitly to a real address space seen by host processor 907, any host processor can address these resources directly using an effective address value. In at least one embodiment, one function of accelerator integration circuit 936 is physical separation of graphics processing engines 931(1)-931(N) so that they appear to a system as independent units.

In at least one embodiment, one or more graphics memories 933(1)-933(M) are coupled to each of graphics processing engines 931(1)-931(N), respectively and N=M. In at least one embodiment, graphics memories 933(1)-933(M) store instructions and data being processed by each of graphics processing engines 931(1)-931(N). In at least one embodiment, graphics memories 933(1)-933(M) may be volatile memories such as DRAMs (including stacked DRAMs), GDDR memory (e.g., GDDR5, GDDR6), or HBM, and/or may be non-volatile memories such as 3D XPoint or Nano-Ram.

In at least one embodiment, to reduce data traffic over high-speed link 940, biasing techniques can be used to ensure that data stored in graphics memories 933(1)-933(M) is data that will be used most frequently by graphics processing engines 931(1)-931(N) and preferably not used by cores 960A-960D (at least not frequently). Similarly, in at least one embodiment, a biasing mechanism attempts to keep data needed by cores (and preferably not graphics processing engines 931(1)-931(N)) within caches 962A-962D, 956 and system memory 914.

FIG. 9C illustrates another exemplary embodiment in which accelerator integration circuit 936 is integrated within processor 907. In this embodiment, graphics processing engines 931(1)-931(N) communicate directly over high-speed link 940 to accelerator integration circuit 936 via interface 937 and interface 935 (which, again, may be any form of bus or interface protocol). In at least one embodiment, accelerator integration circuit 936 may perform similar operations as those described with respect to FIG. 9B, but potentially at a higher throughput given its close proximity to coherence bus 964 and caches 962A-962D, 956. In at least one embodiment, an accelerator integration circuit supports different programming models including a dedicated-process programming model (no graphics acceleration module virtualization) and shared programming models (with virtualization), which may include programming models which are controlled by accelerator integration circuit 936 and programming models which are controlled by graphics acceleration module 946.

In at least one embodiment, graphics processing engines 931(1)-931(N) are dedicated to a single application or process under a single operating system. In at least one embodiment, a single application can funnel other application requests to graphics processing engines 931(1)-931(N), providing virtualization within a VM/partition.

In at least one embodiment, graphics processing engines 931(1)-931(N), may be shared by multiple VM/application partitions. In at least one embodiment, shared models may use a system hypervisor to virtualize graphics processing engines 931(1)-931(N) to allow access by each operating system. In at least one embodiment, for single-partition systems without a hypervisor, graphics processing engines 931(1)-931(N) are owned by an operating system. In at least one embodiment, an operating system can virtualize graphics processing engines 931(1)-931(N) to provide access to each process or application.

In at least one embodiment, graphics acceleration module 946 or an individual graphics processing engine 931(1)-931(N) selects a process element using a process handle. In at least one embodiment, process elements are stored in system memory 914 and are addressable using an effective address to real address translation technique described herein. In at least one embodiment, a process handle may be an implementation-specific value provided to a host process when registering its context with graphics processing engine 931(1)-931(N) (that is, calling system software to add a process element to a process element linked list). In at least one embodiment, a lower 16-bits of a process handle may be an offset of a process element within a process element linked list.

FIG. 9D illustrates an exemplary accelerator integration slice 990. In at least one embodiment, a “slice” comprises a specified portion of processing resources of accelerator integration circuit 936. In at least one embodiment, an application is effective address space 982 within system memory 914 stores process elements 983. In at least one embodiment, process elements 983 are stored in response to GPU invocations 981 from applications 980 executed on processor 907. In at least one embodiment, a process element 983 contains process state for corresponding application 980. In at least one embodiment, a work descriptor (WD) 984 contained in process element 983 can be a single job requested by an application or may contain a pointer to a queue of jobs. In at least one embodiment, WD 984 is a pointer to a job request queue in an application's effective address space 982.

In at least one embodiment, graphics acceleration module 946 and/or individual graphics processing engines 931(1)-931(N) can be shared by all or a subset of processes in a system. In at least one embodiment, an infrastructure for setting up process states and sending a WD 984 to a graphics acceleration module 946 to start a job in a virtualized environment may be included.

In at least one embodiment, a dedicated-process programming model is implementation-specific. In at least one embodiment, in this model, a single process owns graphics acceleration module 946 or an individual graphics processing engine 931. In at least one embodiment, when graphics acceleration module 946 is owned by a single process, a hypervisor initializes accelerator integration circuit 936 for an owning partition and an operating system initializes accelerator integration circuit 936 for an owning process when graphics acceleration module 946 is assigned.

In at least one embodiment, in operation, a WD fetch unit 991 in accelerator integration slice 990 fetches next WD 984, which includes an indication of work to be done by one or more graphics processing engines of graphics acceleration module 946. In at least one embodiment, data from WD 984 may be stored in registers 945 and used by MMU 939, interrupt management circuit 947 and/or context management circuit 948 as illustrated. For example, one embodiment of MMU 939 includes segment/page walk circuitry for accessing segment/page tables 986 within an OS virtual address space 985. In at least one embodiment, interrupt management circuit 947 may process interrupt events 992 received from graphics acceleration module 946. In at least one embodiment, when performing graphics operations, an effective address 993 generated by a graphics processing engine 931(1)-931(N) is translated to a real address by MMU 939.

In at least one embodiment, registers 945 are duplicated for each graphics processing engine 931(1)-931(N) and/or graphics acceleration module 946 and may be initialized by a hypervisor or an operating system. In at least one embodiment, each of these duplicated registers may be included in an accelerator integration slice 990. Exemplary registers that may be initialized by a hypervisor are shown in Table 1.

TABLE 1
Hypervisor Initialized Registers

| Register # | Description |
|---|---|
| 1 | Slice Control Register |
| 2 | Real Address (RA) Scheduled Processes Area Pointer |
| 3 | Authority Mask Override Register |
| 4 | Interrupt Vector Table Entry Offset |
| 5 | Interrupt Vector Table Entry Limit |
| 6 | State Register |
| 7 | Logical Partition ID |
| 8 | Real address (RA) Hypervisor Accelerator Utilization Record |
| | Pointer |
| 9 | Storage Description Register |

Exemplary registers that may be initialized by an operating system are shown in Table 2.

TABLE 2
Operating System Initialized Registers

| Register # | Description |
|---|---|
| 1 | Process and Thread Identification |
| 2 | Effective Address (EA) Context Save/Restore Pointer |
| 3 | Virtual Address (VA) Accelerator Utilization Record Pointer |
| 4 | Virtual Address (VA) Storage Segment Table Pointer |
| 5 | Authority Mask |
| 6 | Work descriptor |

In at least one embodiment, each WD 984 is specific to a particular graphics acceleration module 946 and/or graphics processing engines 931(1)-931(N). In at least one embodiment, it contains all information required by a graphics processing engine 931(1)-931(N) to do work, or it can be a pointer to a memory location where an application has set up a command queue of work to be completed.

FIG. 9E illustrates additional details for one exemplary embodiment of a shared model. This embodiment includes a hypervisor real address space 998 in which a process element list 999 is stored. In at least one embodiment, hypervisor real address space 998 is accessible via a hypervisor 996 which virtualizes graphics acceleration module engines for operating system 995.

In at least one embodiment, shared programming models allow for all or a subset of processes from all or a subset of partitions in a system to use a graphics acceleration module 946. In at least one embodiment, there are two programming models where graphics acceleration module 946 is shared by multiple processes and partitions, namely time-sliced shared and graphics directed shared.

In at least one embodiment, in this model, system hypervisor 996 owns graphics acceleration module 946 and makes its function available to all operating systems 995. In at least one embodiment, for a graphics acceleration module 946 to support virtualization by system hypervisor 996, graphics acceleration module 946 may adhere to certain requirements, such as (1) an application's job request must be autonomous (that is, state does not need to be maintained between jobs), or graphics acceleration module 946 must provide a context save and restore mechanism, (2) an application's job request is guaranteed by graphics acceleration module 946 to complete in a specified amount of time, including any translation faults, or graphics acceleration module 946 provides an ability to preempt processing of a job, and (3) graphics acceleration module 946 must be guaranteed fairness between processes when operating in a directed shared programming model.

In at least one embodiment, application 980 is required to make an operating system 995 system call with a graphics acceleration module type, a work descriptor (WD), an authority mask register (AMR) value, and a context save/restore area pointer (CSRP). In at least one embodiment, graphics acceleration module type describes a targeted acceleration function for a system call. In at least one embodiment, graphics acceleration module type may be a system-specific value. In at least one embodiment, WD is formatted specifically for graphics acceleration module 946 and can be in a form of a graphics acceleration module 946 command, an effective address pointer to a user-defined structure, an effective address pointer to a queue of commands, or any other data structure to describe work to be done by graphics acceleration module 946.

In at least one embodiment, an AMR value is an AMR state to use for a current process. In at least one embodiment, a value passed to an operating system is similar to an application setting an AMR. In at least one embodiment, if accelerator integration circuit 936 (not shown) and graphics acceleration module 946 implementations do not support a User Authority Mask Override Register (UAMOR), an operating system may apply a current UAMOR value to an AMR value before passing an AMR in a hypervisor call. In at least one embodiment, hypervisor 996 may optionally apply a current Authority Mask Override Register (AMOR) value before placing an AMR into process element 983. In at least one embodiment, CSRP is one of registers 945 containing an effective address of an area in an application's effective address space 982 for graphics acceleration module 946 to save and restore context state. In at least one embodiment, this pointer is optional if no state is required to be saved between jobs or when a job is preempted. In at least one embodiment, context save/restore area may be pinned system memory.

Upon receiving a system call, operating system 995 may verify that application 980 has registered and been given authority to use graphics acceleration module 946. In at least one embodiment, operating system 995 then calls hypervisor 996 with information shown in Table 3.

TABLE 3
OS to Hypervisor Call Parameters

| Parameter # | Description |
|---|---|
| 1 | A work descriptor (WD) |
| 2 | An Authority Mask Register (AMR) value (potentially |
| | masked) |
| 3 | An effective address (EA) Context Save/Restore Area |
| | Pointer (CSRP) |
| 4 | A process ID (PID) and optional thread ID (TID) |
| 5 | A virtual address (VA) accelerator utilization record pointer |
| | (AURP) |
| 6 | Virtual address of storage segment table pointer (SSTP) |
| 7 | A logical interrupt service number (LISN) |

In at least one embodiment, upon receiving a hypervisor call, hypervisor 996 verifies that operating system 995 has registered and been given authority to use graphics acceleration module 946. In at least one embodiment, hypervisor 996 then puts process element 983 into a process element linked list for a corresponding graphics acceleration module 946 type. In at least one embodiment, a process element may include information shown in Table 4.

TABLE 4
Process Element Information

| Element # | Description |
|---|---|
| 1 | A work descriptor (WD) |
| 2 | An Authority Mask Register (AMR) value (potentially |
| | masked). |
| 3 | An effective address (EA) Context Save/Restore Area Pointer |
| | (CSRP) |
| 4 | A process ID (PID) and optional thread ID (TID) |
| 5 | A virtual address (VA) accelerator utilization record pointer |
| | (AURP) |
| 6 | Virtual address of storage segment table pointer (SSTP) |
| 7 | A logical interrupt service number (LISN) |
| 8 | Interrupt vector table, derived from hypervisor call parameters |
| 9 | A state register (SR) value |
| 10 | A logical partition ID (LPID) |
| 11 | A real address (RA) hypervisor accelerator utilization record |
| | pointer |
| 12 | Storage Descriptor Register (SDR) |

In at least one embodiment, hypervisor initializes a plurality of accelerator integration slice 990 registers 945.

As illustrated in FIG. 9F, in at least one embodiment, a unified memory is used, addressable via a common virtual memory address space used to access physical processor memories 901(1)-901(N) and GPU memories 920(1)-920(N). In this implementation, operations executed on GPUs 910(1)-910(N) utilize a same virtual/effective memory address space to access processor memories 901(1)-901(M) and vice versa, thereby simplifying programmability. In at least one embodiment, a first portion of a virtual/effective address space is allocated to processor memory 901(1), a second portion to second processor memory 901(N), a third portion to GPU memory 920(1), and so on. In at least one embodiment, an entire virtual/effective memory space (sometimes referred to as an effective address space) is thereby distributed across each of processor memories 901 and GPU memories 920, allowing any processor or GPU to access any physical memory with a virtual address mapped to that memory.

In at least one embodiment, bias/coherence management circuitry 994A-994E within one or more of MMUs 939A-939E ensures cache coherence between caches of one or more host processors (e.g., 905) and GPUs 910 and implements biasing techniques indicating physical memories in which certain types of data should be stored. In at least one embodiment, while multiple instances of bias/coherence management circuitry 994A-994E are illustrated in FIG. 9F, bias/coherence circuitry may be implemented within an MMU of one or more host processors 905 and/or within accelerator integration circuit 936.

One embodiment allows GPU memories 920 to be mapped as part of system memory, and accessed using shared virtual memory (SVM) technology, but without suffering performance drawbacks associated with full system cache coherence. In at least one embodiment, an ability for GPU memories 920 to be accessed as system memory without onerous cache coherence overhead provides a beneficial operating environment for GPU offload. In at least one embodiment, this arrangement allows software of host processor 905 to setup operands and access computation results, without overhead of tradition I/O DMA data copies. In at least one embodiment, such traditional copies involve driver calls, interrupts and memory mapped I/O (MMIO) accesses that are all inefficient relative to simple memory accesses. In at least one embodiment, an ability to access GPU memories 920 without cache coherence overheads can be critical to execution time of an offloaded computation. In at least one embodiment, in cases with substantial streaming write memory traffic, for example, cache coherence overhead can significantly reduce an effective write bandwidth seen by a GPU 910. In at least one embodiment, efficiency of operand setup, efficiency of results access, and efficiency of GPU computation may play a role in determining effectiveness of a GPU offload.

In at least one embodiment, selection of GPU bias and host processor bias is driven by a bias tracker data structure. In at least one embodiment, a bias table may be used, for example, which may be a page-granular structure (e.g., controlled at a granularity of a memory page) that includes 1 or 2 bits per GPU-attached memory page. In at least one embodiment, a bias table may be implemented in a stolen memory range of one or more GPU memories 920, with or without a bias cache in a GPU 910 (e.g., to cache frequently/recently used entries of a bias table). Alternatively, in at least one embodiment, an entire bias table may be maintained within a GPU.

In at least one embodiment, a bias table entry associated with each access to a GPU attached memory 920 is accessed prior to actual access to a GPU memory, causing following operations. In at least one embodiment, local requests from a GPU 910 that find their page in GPU bias are forwarded directly to a corresponding GPU memory 920. In at least one embodiment, local requests from a GPU that find their page in host bias are forwarded to processor 905 (e.g., over a high-speed link as described herein). In at least one embodiment, requests from processor 905 that find a requested page in host processor bias complete a request like a normal memory read. Alternatively, requests directed to a GPU-biased page may be forwarded to a GPU 910. In at least one embodiment, a GPU may then transition a page to a host processor bias if it is not currently using a page. In at least one embodiment, a bias state of a page can be changed either by a software-based mechanism, a hardware-assisted software-based mechanism, or, for a limited set of cases, a purely hardware-based mechanism.

In at least one embodiment, one mechanism for changing bias state employs an API call (e.g., OpenCL), which, in turn, calls a GPU's device driver which, in turn, sends a message (or enqueues a command descriptor) to a GPU directing it to change a bias state and, for some transitions, perform a cache flushing operation in a host. In at least one embodiment, a cache flushing operation is used for a transition from host processor 905 bias to GPU bias, but is not for an opposite transition.

In at least one embodiment, cache coherency is maintained by temporarily rendering GPU-biased pages uncacheable by host processor 905. In at least one embodiment, to access these pages, processor 905 may request access from GPU 910, which may or may not grant access right away. In at least one embodiment, thus, to reduce communication between processor 905 and GPU 910 it is beneficial to ensure that GPU-biased pages are those which are required by a GPU but not host processor 905 and vice versa.

Hardware structure(s) 415 are used to perform one or more embodiments. Details regarding a hardware structure(s) 415 may be provided herein in conjunction with FIGS. 4A and/or 4B.

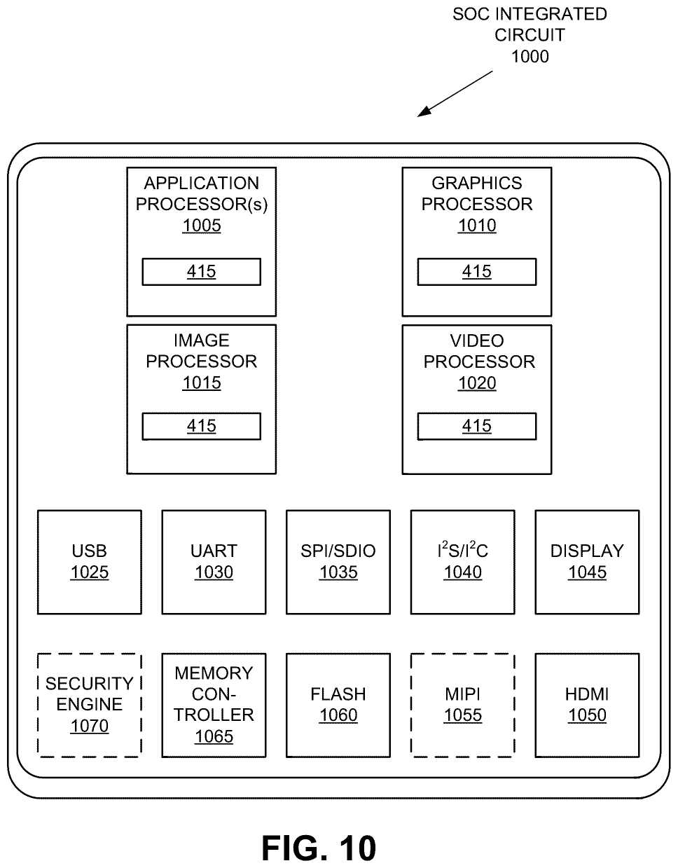

FIG. 10 illustrates exemplary integrated circuits and associated graphics processors that may be fabricated using one or more IP cores, according to various embodiments described herein. In addition to what is illustrated, other logic and circuits may be included in at least one embodiment, including additional graphics processors/cores, peripheral interface controllers, or general-purpose processor cores.

FIG. 10 is a block diagram illustrating an exemplary system on a chip integrated circuit 1000 that may be fabricated using one or more IP cores, according to at least one embodiment. In at least one embodiment, integrated circuit 1000 includes one or more application processor(s) 1005 (e.g., CPUs), at least one graphics processor 1010, and may additionally include an image processor 1015 and/or a video processor 1020, any of which may be a modular IP core. In at least one embodiment, integrated circuit 1000 includes peripheral or bus logic including a USB controller 1025, a UART controller 1030, an SPI/SDIO controller 1035, and an I²2S/I²2C controller 1040. In at least one embodiment, integrated circuit 1000 can include a display device 1045 coupled to one or more of a high-definition multimedia interface (HDMI) controller 1050 and a mobile industry processor interface (MIPI) display interface 1055. In at least one embodiment, storage may be provided by a flash memory subsystem 1060 including flash memory and a flash memory controller. In at least one embodiment, a memory interface may be provided via a memory controller 1065 for access to SDRAM or SRAM memory devices. In at least one embodiment, some integrated circuits additionally include an embedded security engine 1070.

Logic 415 are used to perform inferencing and/or training operations associated with one or more embodiments. Details regarding logic 415 are provided herein in conjunction with FIGS. 4A and/or 4B. In at least one embodiment, logic 415 may be used in integrated circuit 1000 for inferencing or predicting operations based, at least in part, on weight parameters calculated using neural network training operations, neural network functions and/or architectures, or neural network use cases described herein.

FIGS. 11A-11B illustrate additional exemplary graphics processor logic according to embodiments described herein. In at least one embodiment, components illustrated in and described in connection with FIGS. 11A-11B are integrated into a single system, such as a graphics processing unit (GPU), SoC, or another type of processor. FIG. 11A illustrates a graphics core 1100 that may be included within graphics processor 1010 of FIG. 10, in at least one embodiment. FIG. 11B illustrates a highly-parallel general-purpose graphics processing unit (“GPGPU”, which can also be referred to as a “graphics processing unit”) 1130 suitable for deployment on a multi-chip module in at least one embodiment. In at least one embodiment, graphics processing unit 1130 is a GPGPU that comprises a graphics processor. In at least one embodiment, integrated circuit 1000 comprises graphics core 1100, e.g., to form an integrated circuit and/or to form an SoC, where such an integrated circuit and/or such an SoC perform operations described herein.

In at least one embodiment, graphics core 1100 includes a shared instruction cache 1102, a texture unit 1118, and a cache/shared memory 1120 (e.g., including L1, L2, L3, last level cache, or other caches) that are common to execution resources within graphics core 1100. In at least one embodiment, graphics core 1100 can include multiple slices 1101A-1101N or a partition for each core, and a graphics processor can include multiple instances of graphics core 1100. In at least one embodiment, each slice 1101A-1101N refers to graphics core 1100. In at least one embodiment, slices 1101A-1101N have sub-slices, which are part of a slice 1101A-1101N. In at least one embodiment, slices 1101A-1101N are independent of other slices or dependent on other slices. In at least one embodiment, slices 1101A-1101N can include support logic including a local instruction cache 1104A-1104N, a thread scheduler (sequencer) 1106A-1106N, a thread dispatcher 1108A-1108N, and a set of registers 1110A-1110N. In at least one embodiment, slices 1101A-1101N can include a set of additional function units (AFUs 1112A-1112N), floating-point units (FPUs 1114A-1114N), integer arithmetic logic units (ALUs 1116A-1116N), address computational units (ACUs 1113A-1113N), double-precision floating-point units (DPFPUs 1115A-1115N), and matrix processing units (MPUs 1117A-1117N). In at least one embodiment, MPUs 1117A-1117N are referred to as matrix engines.

In at least one embodiment, each slice 1101A-1101N includes one or more engines for floating point and integer vector operations and one or more engines to accelerate convolution and matrix operations in AI, machine learning, or large dataset workloads. In at least one embodiment, one or more slices 1101A-1101N include one or more vector engines to compute a vector (e.g., compute mathematical operations for vectors). In at least one embodiment, a vector engine can compute a vector operation in 16-bit floating point (also referred to as “FP16”), 32-bit floating point (also referred to as “FP32”), or 64-bit floating point (also referred to as “FP64”). In at least one embodiment, one or more slices 1101A-1101N includes 16 vector engines that are paired with 16 matrix math units to compute matrix/tensor operations, where vector engines and math units are exposed via matrix extensions. In at least one embodiment, a slice a specified portion of processing resources of a processing unit, e.g., 16 cores and a ray tracing unit or 8 cores, a thread scheduler, a thread dispatcher, and additional functional units for a processor. In at least one embodiment, graphics core 1100 includes one or more matrix engines to compute matrix operations, e.g., when computing tensor operations.

In at least one embodiment, one or more slices 1101A-1101N includes one or more ray tracing units to compute ray tracing operations (e.g., 16 ray tracing units per slice slices 1101A-1101N). In at least one embodiment, a ray tracing unit computes ray traversal, triangle intersection, bounding box intersect, or other ray tracing operations.

In at least one embodiment, one or more slices 1101A-1101N includes a media slice that encodes, decodes, and/or transcodes data; scales and/or format converts data; and/or performs video quality operations on video data.

In at least one embodiment, one or more slices 1101A-1101N are linked to L2 cache and memory fabric, link connectors, high-bandwidth memory (HBM) (e.g., HBM2e, HDM3) stacks, and a media engine. In at least one embodiment, one or more slices 1101A-1101N include multiple cores (e.g., 16 cores) and multiple ray tracing units (e.g., 16) paired to each core. In at least one embodiment, one or more slices 1101A-1101N has one or more L1 caches. In at least one embodiment, one or more slices 1101A-1101N include one or more vector engines; one or more instruction caches to store instructions; one or more L1 caches to cache data; one or more shared local memories (SLMs) to store data, e.g., corresponding to instructions; one or more samplers to sample data; one or more ray tracing units to perform ray tracing operations; one or more geometries to perform operations in geometry pipelines and/or apply geometric transformations to vertices or polygons; one or more rasterizers to describe an image in vector graphics format (e.g., shape) and convert it into a raster image (e.g., a series of pixels, dots, or lines, which when displayed together, create an image that is represented by shapes); one or more a Hierarchical Depth Buffer (Hiz) to buffer data; and/or one or more pixel backends. In at least one embodiment, a slice 1101A-1101N includes a memory fabric, e.g., an L2 cache.

In at least one embodiment, FPUs 1114A-1114N can perform single-precision (32-bit) and half-precision (16-bit) floating point operations, while DPFPUs 1115A-1115N perform double precision (64-bit) floating point operations. In at least one embodiment, ALUs 1116A-1116N can perform variable precision integer operations at 8-bit, 16-bit, and 32-bit precision, and can be configured for mixed precision operations. In at least one embodiment, MPUs 1117A-1117N can also be configured for mixed precision matrix operations, including half-precision floating point and 8-bit integer operations. In at least one embodiment, MPUs 1117-1117N can perform a variety of matrix operations to accelerate machine learning application frameworks, including enabling support for accelerated general matrix to matrix multiplication (GEMM). In at least one embodiment, AFUs 1112A-1112N can perform additional logic operations not supported by floating-point or integer units, including trigonometric operations (e.g., sine, cosine, etc.).

Logic 415 are used to perform inferencing and/or training operations associated with one or more embodiments. Details regarding logic 415 are provided herein in conjunction with FIGS. 4A and/or 4B. In at least one embodiment, logic 415 may be used in graphics core 1100 for inferencing or predicting operations based, at least in part, on weight parameters calculated using neural network training operations, neural network functions and/or architectures, or neural network use cases described herein.

In at least one embodiment, graphics core 1100 includes an interconnect and a link fabric sublayer that is attached to a switch and a GPU-GPU bridge that enables multiple graphics processors 1100 (e.g., 8) to be interlinked without glue to each other with load/store units (LSUs), data transfer units, and sync semantics across multiple graphics processors 1100. In at least one embodiment, interconnects include standardized interconnects (e.g., PCIe) or some combination thereof.

In at least one embodiment, graphics core 1100 includes multiple tiles. In at least one embodiment, a tile is an individual die or one or more dies, where individual dies can be connected with an interconnect (e.g., embedded multi-die interconnect bridge (EMIB)). In at least one embodiment, graphics core 1100 includes a compute tile, a memory tile (e.g., where a memory tile can be exclusively accessed by different tiles or different chipsets such as a Rambo tile), substrate tile, a base tile, a HMB tile, a link tile, and EMIB tile, where all tiles are packaged together in graphics core 1100 as part of a GPU. In at least one embodiment, graphics core 1100 can include multiple tiles in a single package (also referred to as a “multi tile package”). In at least one embodiment, a compute tile can have 8 graphics cores 1100, an L1 cache; and a base tile can have a host interface with PCIe 5.0, HBM2e, MDFI, and EMIB, a link tile with 8 links, 8 ports with an embedded switch. In at least one embodiment, tiles are connected with face-to-face (F2F) chip-on-chip bonding through fine-pitched, 36-micron, microbumps (e.g., copper pillars). In at least one embodiment, graphics core 1100 includes memory fabric, which includes memory, and is tile that is accessible by multiple tiles. In at least one embodiment, graphics core 1100 stores, accesses, or loads its own hardware contexts in memory, where a hardware context is a set of data loaded from registers before a process resumes, and where a hardware context can indicate a state of hardware (e.g., state of a GPU).

In at least one embodiment, graphics core 1100 includes serializer/deserializer (SERDES) circuitry that converts a serial data stream to a parallel data stream, or converts a parallel data stream to a serial data stream.

In at least one embodiment, graphics core 1100 includes a high speed coherent unified fabric (GPU to GPU), load/store units, bulk data transfer and sync semantics, and connected GPUs through an embedded switch, where a GPU-GPU bridge is controlled by a controller.

In at least one embodiment, graphics core 1100 performs an API, where said API abstracts hardware of graphics core 1100 and access libraries with instructions to perform math operations (e.g., math kernel library), deep neural network operations (e.g., deep neural network library), vector operations, collective communications, thread building blocks, video processing, data analytics library, and/or ray tracing operations.

FIG. 11B illustrates GPGPU 1130 that can be configured to enable highly-parallel compute operations to be performed by an array of graphics processing units, in at least one embodiment. In at least one embodiment, GPGPU 1130 can be linked directly to other instances of GPGPU 1130 to create a multi-GPU cluster to improve training speed for deep neural networks. In at least one embodiment, GPGPU 1130 includes a host interface 1132 to enable a connection with a host processor. In at least one embodiment, host interface 1132 is a PCI Express interface. In at least one embodiment, host interface 1132 can be a vendor-specific communications interface or communications fabric. In at least one embodiment, GPGPU 1130 receives commands from a host processor and uses a global scheduler 1134 (which may be referred to as a thread sequencer and/or asynchronous compute engine) to distribute execution threads associated with those commands to a set of compute clusters 1136A-1136H. In at least one embodiment, compute clusters 1136A-1136H share a cache memory 1138. In at least one embodiment, cache memory 1138 can serve as a higher-level cache for cache memories within compute clusters 1136A-1136H. In at least one embodiment, compute clusters 1136A-1136H comprise a slice or are referred to as “slices.” In at least one embodiment, GPGPU 1130 is part of an SoC such as part of integrated circuit 1000 (FIG. 10).

In at least one embodiment, GPGPU 1130 includes memory 1144A-1144B coupled with compute clusters 1136A-1136H via a set of memory controllers 1142A-1142B (e.g., one or more controllers for HBM2e). In at least one embodiment, memory 1144A-1144B can include various types of memory devices including dynamic random access memory (DRAM) or graphics random access memory, such as synchronous graphics random access memory (SGRAM), including graphics double data rate (GDDR) memory.

In at least one embodiment, compute clusters 1136A-1136H each include a set of graphics cores, such as graphics core 1100 of FIG. 11A, which can include multiple types of integer and floating point logic units that can perform computational operations at a range of precisions including suited for machine learning computations. For example, in at least one embodiment, at least a subset of floating point units in each of compute clusters 1136A-1136H can be configured to perform 16-bit or 32-bit floating point operations, while a different subset of floating point units can be configured to perform 64-bit floating point operations.

In at least one embodiment, multiple instances of GPGPU 1130 can be configured to operate as a compute cluster. In at least one embodiment, communication used by compute clusters 1136A-1136H for synchronization and data exchange varies across embodiments. In at least one embodiment, multiple instances of GPGPU 1130 communicate over host interface 1132. In at least one embodiment, GPGPU 1130 includes an I/O hub 1139 that couples GPGPU 1130 with a GPU link 1140 that enables a direct connection to other instances of GPGPU 1130. In at least one embodiment, GPU link 1140 is coupled to a dedicated GPU-to-GPU bridge that enables communication and synchronization between multiple instances of GPGPU 1130. In at least one embodiment, GPU link 1140 couples with a high-speed interconnect to transmit and receive data to other GPGPUs or parallel processors. In at least one embodiment, multiple instances of GPGPU 1130 are located in separate data processing systems and communicate via a network device that is accessible via host interface 1132. In at least one embodiment GPU link 1140 can be configured to enable a connection to a host processor in addition to or as an alternative to host interface 1132.

In at least one embodiment, GPGPU 1130 can be configured to train neural networks. In at least one embodiment, GPGPU 1130 can be used within an inferencing platform. In at least one embodiment, in which GPGPU 1130 is used for inferencing, GPGPU 1130 may include fewer compute clusters 1136A-1136H relative to when GPGPU 1130 is used for training a neural network. In at least one embodiment, memory technology associated with memory 1144A-1144B may differ between inferencing and training configurations, with higher bandwidth memory technologies devoted to training configurations. In at least one embodiment, an inferencing configuration of GPGPU 1130 can support inferencing specific instructions. For example, in at least one embodiment, an inferencing configuration can provide support for one or more 8-bit integer dot product instructions, which may be used during inferencing operations for deployed neural networks.

Logic 415 are used to perform inferencing and/or training operations associated with one or more embodiments. Details regarding logic 415 are provided herein in conjunction with FIGS. 4A and/or 4B. In at least one embodiment, logic 415 may be used in GPGPU 1130 for inferencing or predicting operations based, at least in part, on weight parameters calculated using neural network training operations, neural network functions and/or architectures, or neural network use cases described herein.

### Processors

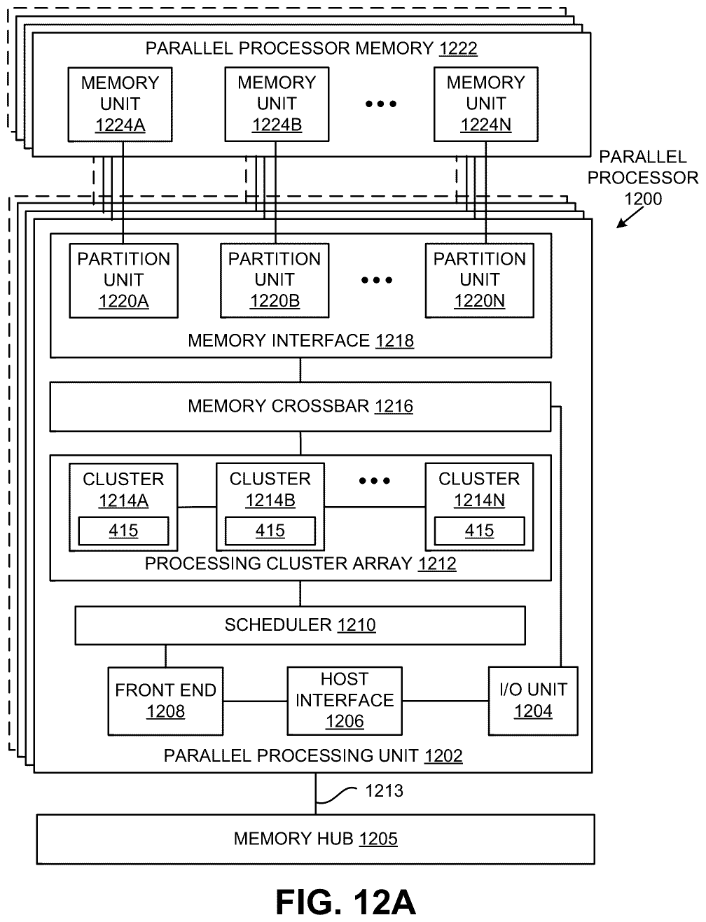

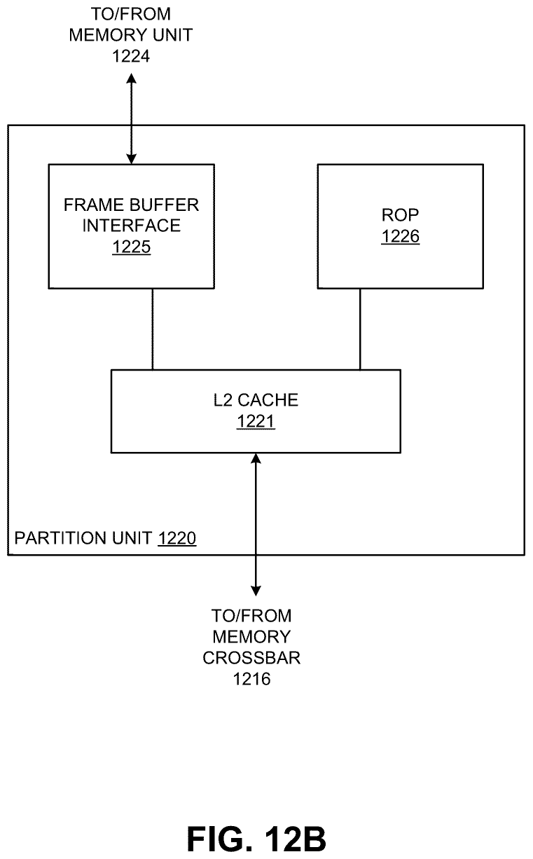

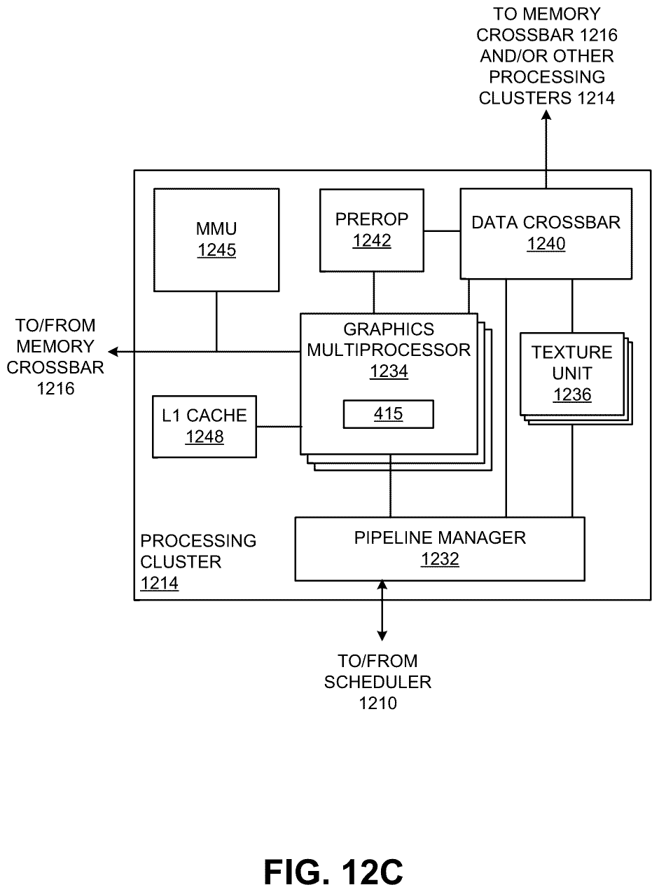

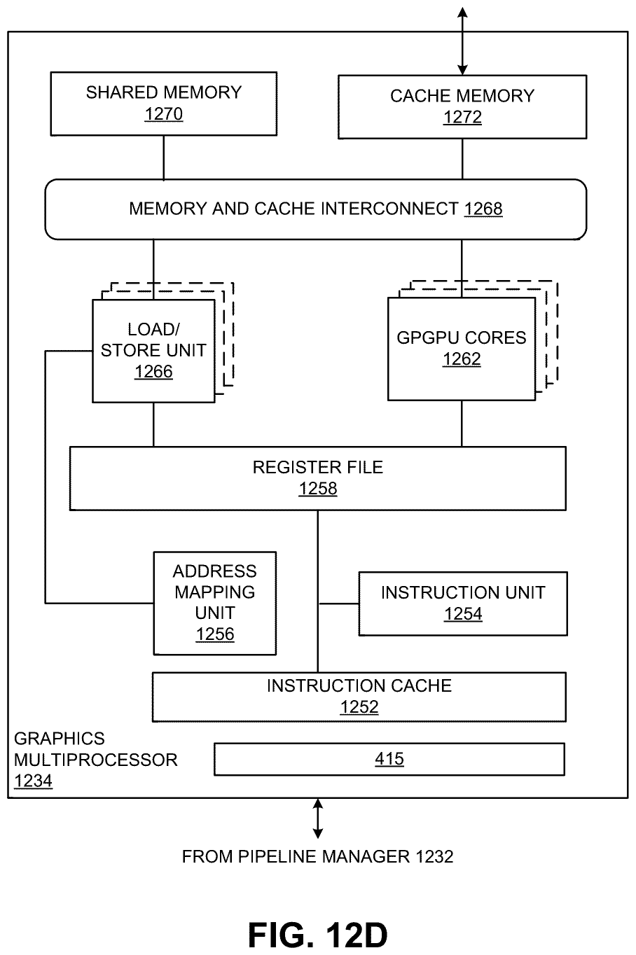

FIG. 12A illustrates a parallel processor 1200 according to at least one embodiment. In at least one embodiment, various components of parallel processor 1200 may be implemented using one or more integrated circuit devices, such as programmable processors, application specific integrated circuits (ASICs), or field programmable gate arrays (FPGA). In at least one embodiment, a parallel processor 1200 includes one or more graphics cores 1100.

In at least one embodiment, parallel processor 1200 includes a parallel processing unit 1202. In at least one embodiment, parallel processing unit 1202 includes an I/O unit 1204 that enables communication with other devices, including other instances of parallel processing unit 1202. In at least one embodiment, I/O unit 1204 may be directly connected to other devices. In at least one embodiment, I/O unit 1204 connects with other devices via use of a hub or switch interface, such as a memory hub 1205. In at least one embodiment, connections between memory hub 1205 and I/O unit 1204 form a communication link 1213. In at least one embodiment, I/O unit 1204 connects with a host interface 1206 and a memory crossbar 1216, where host interface 1206 receives commands directed to performing processing operations and memory crossbar 1216 receives commands directed to performing memory operations.

In at least one embodiment, when host interface 1206 receives a command buffer via I/O unit 1204, host interface 1206 can direct work operations to perform those commands to a front end 1208. In at least one embodiment, front end 1208 couples with a scheduler 1210 (which may be referred to as a sequencer), which is configured to distribute commands or other work items to a processing cluster array 1212. In at least one embodiment, scheduler 1210 ensures that processing cluster array 1212 is properly configured and in a valid state before tasks are distributed to a cluster of processing cluster array 1212. In at least one embodiment, scheduler 1210 is implemented via firmware logic executing on a microcontroller. In at least one embodiment, microcontroller implemented scheduler 1210 is configurable to perform complex scheduling and work distribution operations at coarse and fine granularity, enabling rapid preemption and context switching of threads executing on processing array 1212. In at least one embodiment, host software can prove workloads for scheduling on processing cluster array 1212 via one of multiple graphics processing paths. In at least one embodiment, workloads can then be automatically distributed across processing array cluster 1212 by scheduler 1210 logic within a microcontroller including scheduler 1210.

In at least one embodiment, processing cluster array 1212 can include up to “N” processing clusters (e.g., cluster 1214A, cluster 1214B, through cluster 1214N), where “N” represents a positive integer (which may be a different integer “N” than used in other figures). In at least one embodiment, each cluster 1214A-1214N of processing cluster array 1212 can execute a large number of concurrent threads. In at least one embodiment, scheduler 1210 can allocate work to clusters 1214A-1214N of processing cluster array 1212 using various scheduling and/or work distribution algorithms, which may vary depending on workload arising for each type of program or computation. In at least one embodiment, scheduling can be handled dynamically by scheduler 1210, or can be assisted in part by compiler logic during compilation of program logic configured for execution by processing cluster array 1212. In at least one embodiment, different clusters 1214A-1214N of processing cluster array 1212 can be allocated for processing different types of programs or for performing different types of computations.

In at least one embodiment, processing cluster array 1212 can be configured to perform various types of parallel processing operations. In at least one embodiment, processing cluster array 1212 is configured to perform general-purpose parallel compute operations. For example, in at least one embodiment, processing cluster array 1212 can include logic to execute processing tasks including filtering of video and/or audio data, performing modeling operations, including physics operations, and performing data transformations.

In at least one embodiment, processing cluster array 1212 is configured to perform parallel graphics processing operations. In at least one embodiment, processing cluster array 1212 can include additional logic to support execution of such graphics processing operations, including but not limited to, texture sampling logic to perform texture operations, as well as tessellation logic and other vertex processing logic. In at least one embodiment, processing cluster array 1212 can be configured to execute graphics processing related shader programs such as, but not limited to, vertex shaders, tessellation shaders, geometry shaders, and pixel shaders. In at least one embodiment, parallel processing unit 1202 can transfer data from system memory via I/O unit 1204 for processing. In at least one embodiment, during processing, transferred data can be stored to on-chip memory (e.g., parallel processor memory 1222) during processing, then written back to system memory.

In at least one embodiment, when parallel processing unit 1202 is used to perform graphics processing, scheduler 1210 can be configured to divide a processing workload into approximately equal sized tasks, to better enable distribution of graphics processing operations to multiple clusters 1214A-1214N of processing cluster array 1212. In at least one embodiment, portions of processing cluster array 1212 can be configured to perform different types of processing. For example, in at least one embodiment, a first portion may be configured to perform vertex shading and topology generation, a second portion may be configured to perform tessellation and geometry shading, and a third portion may be configured to perform pixel shading or other screen space operations, to produce a rendered image for display. In at least one embodiment, intermediate data produced by one or more of clusters 1214A-1214N may be stored in buffers to allow intermediate data to be transmitted between clusters 1214A-1214N for further processing.

In at least one embodiment, processing cluster array 1212 can receive processing tasks to be executed via scheduler 1210, which receives commands defining processing tasks from front end 1208. In at least one embodiment, processing tasks can include indices of data to be processed, e.g., surface (patch) data, primitive data, vertex data, and/or pixel data, as well as state parameters and commands defining how data is to be processed (e.g., what program is to be executed). In at least one embodiment, scheduler 1210 may be configured to fetch indices corresponding to tasks or may receive indices from front end 1208. In at least one embodiment, front end 1208 can be configured to ensure processing cluster array 1212 is configured to a valid state before a workload specified by incoming command buffers (e.g., batch-buffers, push buffers, etc.) is initiated.

In at least one embodiment, each of one or more instances of parallel processing unit 1202 can couple with a parallel processor memory 1222. In at least one embodiment, parallel processor memory 1222 can be accessed via memory crossbar 1216, which can receive memory requests from processing cluster array 1212 as well as I/O unit 1204. In at least one embodiment, memory crossbar 1216 can access parallel processor memory 1222 via a memory interface 1218. In at least one embodiment, memory interface 1218 can include multiple partition units (e.g., partition unit 1220A, partition unit 1220B, through partition unit 1220N) that can each couple to a portion (e.g., memory unit) of parallel processor memory 1222. In at least one embodiment, a number of partition units 1220A-1220N is configured to be equal to a number of memory units, such that a first partition unit 1220A has a corresponding first memory unit 1224A, a second partition unit 1220B has a corresponding memory unit 1224B, and an N-th partition unit 1220N has a corresponding N-th memory unit 1224N. In at least one embodiment, a number of partition units 1220A-1220N may not be equal to a number of memory units.

In at least one embodiment, memory units 1224A-1224N can include various types of memory devices, including dynamic random access memory (DRAM) or graphics random access memory, such as synchronous graphics random access memory (SGRAM), including graphics double data rate (GDDR) memory. In at least one embodiment, memory units 1224A-1224N may also include 3D stacked memory, including but not limited to high bandwidth memory (HBM), HBM2e, or HDM3. In at least one embodiment, render targets, such as frame buffers or texture maps may be stored across memory units 1224A-1224N, allowing partition units 1220A-1220N to write portions of each render target in parallel to efficiently use available bandwidth of parallel processor memory 1222. In at least one embodiment, a local instance of parallel processor memory 1222 may be excluded in favor of a unified memory design that utilizes system memory in conjunction with local cache memory.

In at least one embodiment, any one of clusters 1214A-1214N of processing cluster array 1212 can process data that will be written to any of memory units 1224A-1224N within parallel processor memory 1222. In at least one embodiment, memory crossbar 1216 can be configured to transfer an output of each cluster 1214A-1214N to any partition unit 1220A-1220N or to another cluster 1214A-1214N, which can perform additional processing operations on an output. In at least one embodiment, each cluster 1214A-1214N can communicate with memory interface 1218 through memory crossbar 1216 to read from or write to various external memory devices. In at least one embodiment, memory crossbar 1216 has a connection to memory interface 1218 to communicate with I/O unit 1204, as well as a connection to a local instance of parallel processor memory 1222, enabling processing units within different processing clusters 1214A-1214N to communicate with system memory or other memory that is not local to parallel processing unit 1202. In at least one embodiment, memory crossbar 1216 can use virtual channels to separate traffic streams between clusters 1214A-1214N and partition units 1220A-1220N.

In at least one embodiment, multiple instances of parallel processing unit 1202 can be provided on a single add-in card, or multiple add-in cards can be interconnected. In at least one embodiment, different instances of parallel processing unit 1202 can be configured to interoperate even if different instances have different numbers of processing cores, different amounts of local parallel processor memory, and/or other configuration differences. For example, in at least one embodiment, some instances of parallel processing unit 1202 can include higher precision floating point units relative to other instances. In at least one embodiment, systems incorporating one or more instances of parallel processing unit 1202 or parallel processor 1200 can be implemented in a variety of configurations and form factors, including but not limited to desktop, laptop, or handheld personal computers, servers, workstations, game consoles, and/or embedded systems.

FIG. 12B is a block diagram of a partition unit 1220 according to at least one embodiment. In at least one embodiment, partition unit 1220 is an instance of one of partition units 1220A-1220N of FIG. 12A. In at least one embodiment, partition unit 1220 includes an L2 cache 1221, a frame buffer interface 1225, and a ROP 1226 (raster operations unit). In at least one embodiment, L2 cache 1221 is a read/write cache that is configured to perform load and store operations received from memory crossbar 1216 and ROP 1226. In at least one embodiment, read misses and urgent write-back requests are output by L2 cache 1221 to frame buffer interface 1225 for processing. In at least one embodiment, updates can also be sent to a frame buffer via frame buffer interface 1225 for processing. In at least one embodiment, frame buffer interface 1225 interfaces with one of memory units in parallel processor memory, such as memory units 1224A-1224N of FIG. 12A (e.g., within parallel processor memory 1222).

In at least one embodiment, ROP 1226 is a processing unit that performs raster operations such as stencil, z test, blending, etc. In at least one embodiment, ROP 1226 then outputs processed graphics data that is stored in graphics memory. In at least one embodiment, ROP 1226 includes compression logic to compress depth or color data that is written to memory and decompress depth or color data that is read from memory. In at least one embodiment, compression logic can be lossless compression logic that makes use of one or more of multiple compression algorithms. In at least one embodiment, a type of compression that is performed by ROP 1226 can vary based on statistical characteristics of data to be compressed. For example, in at least one embodiment, delta color compression is performed on depth and color data on a per-tile basis.

In at least one embodiment, ROP 1226 is included within each processing cluster (e.g., cluster 1214A-1214N of FIG. 12A) instead of within partition unit 1220. In at least one embodiment, read and write requests for pixel data are transmitted over memory crossbar 1216 instead of pixel fragment data. In at least one embodiment, processed graphics data may be displayed on a display device, routed for further processing by processor(s), or routed for further processing by one of processing entities within parallel processor 1200 of FIG. 12A.

FIG. 12C is a block diagram of a processing cluster 1214 within a parallel processing unit according to at least one embodiment. In at least one embodiment, a processing cluster is an instance of one of processing clusters 1214A-1214N of FIG. 12A. In at least one embodiment, processing cluster 1214 can be configured to execute many threads in parallel, where “thread” refers to an instance of a particular program executing on a particular set of input data. In at least one embodiment, single-instruction, multiple-data (SIMD) instruction issue techniques are used to support parallel execution of a large number of threads without providing multiple independent instruction units. In at least one embodiment, single-instruction, multiple-thread (SIMT) techniques are used to support parallel execution of a large number of generally synchronized threads, using a common instruction unit configured to issue instructions to a set of processing engines within each one of processing clusters.

In at least one embodiment, operation of processing cluster 1214 can be controlled via a pipeline manager 1232 that distributes processing tasks to SIMT parallel processors. In at least one embodiment, pipeline manager 1232 receives instructions from scheduler 1210 of FIG. 12A and manages execution of those instructions via a graphics multiprocessor 1234 and/or a texture unit 1236. In at least one embodiment, graphics multiprocessor 1234 is an exemplary instance of a SIMT parallel processor. However, in at least one embodiment, various types of SIMT parallel processors of differing architectures may be included within processing cluster 1214. In at least one embodiment, one or more instances of graphics multiprocessor 1234 can be included within a processing cluster 1214. In at least one embodiment, graphics multiprocessor 1234 can process data and a data crossbar 1240 can be used to distribute processed data to one of multiple possible destinations, including other shader units. In at least one embodiment, pipeline manager 1232 can facilitate distribution of processed data by specifying destinations for processed data to be distributed via data crossbar 1240.

In at least one embodiment, each graphics multiprocessor 1234 within processing cluster 1214 can include an identical set of functional execution logic (e.g., arithmetic logic units, load-store units, etc.). In at least one embodiment, functional execution logic can be configured in a pipelined manner in which new instructions can be issued before previous instructions are complete. In at least one embodiment, functional execution logic supports a variety of operations including integer and floating point arithmetic, comparison operations, Boolean operations, bit-shifting, and computation of various algebraic functions. In at least one embodiment, same functional-unit hardware can be leveraged to perform different operations and any combination of functional units may be present.

In at least one embodiment, instructions transmitted to processing cluster 1214 constitute a thread. In at least one embodiment, a set of threads executing across a set of parallel processing engines is a thread group. In at least one embodiment, a thread group executes a common program on different input data. In at least one embodiment, each thread within a thread group can be assigned to a different processing engine within a graphics multiprocessor 1234. In at least one embodiment, a thread group may include fewer threads than a number of processing engines within graphics multiprocessor 1234. In at least one embodiment, when a thread group includes fewer threads than a number of processing engines, one or more of processing engines may be idle during cycles in which that thread group is being processed. In at least one embodiment, a thread group may also include more threads than a number of processing engines within graphics multiprocessor 1234. In at least one embodiment, when a thread group includes more threads than number of processing engines within graphics multiprocessor 1234, processing can be performed over consecutive clock cycles. In at least one embodiment, multiple thread groups can be executed concurrently on a graphics multiprocessor 1234.

In at least one embodiment, graphics multiprocessor 1234 includes an internal cache memory to perform load and store operations. In at least one embodiment, graphics multiprocessor 1234 can forego an internal cache and use a cache memory (e.g., L1 cache 1248) within processing cluster 1214. In at least one embodiment, each graphics multiprocessor 1234 also has access to L2 caches within partition units (e.g., partition units 1220A-1220N of FIG. 12A) that are shared among all processing clusters 1214 and may be used to transfer data between threads. In at least one embodiment, graphics multiprocessor 1234 may also access off-chip global memory, which can include one or more of local parallel processor memory and/or system memory. In at least one embodiment, any memory external to parallel processing unit 1202 may be used as global memory. In at least one embodiment, processing cluster 1214 includes multiple instances of graphics multiprocessor 1234 and can share common instructions and data, which may be stored in L1 cache 1248.

In at least one embodiment, each processing cluster 1214 may include an MMU 1245 (memory management unit) that is configured to map virtual addresses into physical addresses. In at least one embodiment, one or more instances of MMU 1245 may reside within memory interface 1218 of FIG. 12A. In at least one embodiment, MMU 1245 includes a set of page table entries (PTEs) used to map a virtual address to a physical address of a tile and optionally a cache line index. In at least one embodiment, MMU 1245 may include address translation lookaside buffers (TLB) or caches that may reside within graphics multiprocessor 1234 or L1 1248 cache or processing cluster 1214. In at least one embodiment, a physical address is processed to distribute surface data access locally to allow for efficient request interleaving among partition units. In at least one embodiment, a cache line index may be used to determine whether a request for a cache line is a hit or miss.

In at least one embodiment, a processing cluster 1214 may be configured such that each graphics multiprocessor 1234 is coupled to a texture unit 1236 for performing texture mapping operations, e.g., determining texture sample positions, reading texture data, and filtering texture data. In at least one embodiment, texture data is read from an internal texture L1 cache (not shown) or from an L1 cache within graphics multiprocessor 1234 and is fetched from an L2 cache, local parallel processor memory, or system memory, as needed. In at least one embodiment, each graphics multiprocessor 1234 outputs processed tasks to data crossbar 1240 to provide processed task to another processing cluster 1214 for further processing or to store processed task in an L2 cache, local parallel processor memory, or system memory via memory crossbar 1216. In at least one embodiment, a preROP 1242 (pre-raster operations unit) is configured to receive data from graphics multiprocessor 1234, and direct data to ROP units, which may be located with partition units as described herein (e.g., partition units 1220A-1220N of FIG. 12A). In at least one embodiment, preROP 1242 unit can perform optimizations for color blending, organizing pixel color data, and performing address translations.

Logic 415 are used to perform inferencing and/or training operations associated with one or more embodiments. Details regarding logic 415 are provided herein in conjunction with FIGS. 4A and/or 4B. In at least one embodiment, logic 415 may be used in graphics processing cluster 1214 for inferencing or predicting operations based, at least in part, on weight parameters calculated using neural network training operations, neural network functions and/or architectures, or neural network use cases described herein.

FIG. 12D shows a graphics multiprocessor 1234 according to at least one embodiment. In at least one embodiment, graphics multiprocessor 1234 couples with pipeline manager 1232 of processing cluster 1214. In at least one embodiment, graphics multiprocessor 1234 has an execution pipeline including but not limited to an instruction cache 1252, an instruction unit 1254, an address mapping unit 1256, a register file 1258, one or more general purpose graphics processing unit (GPGPU) cores 1262, and one or more load/store units 1266, where one or more load/store units 1266 can perform load/store operations to load/store instructions corresponding to performing an operation. In at least one embodiment, GPGPU cores 1262 and load/store units 1266 are coupled with cache memory 1272 and shared memory 1270 via a memory and cache interconnect 1268. In at least one embodiment, GPGPU cores 1262 are part of an SoC such as part of integrated circuit 1000 in FIG. 10.

In at least one embodiment, instruction cache 1252 receives a stream of instructions to execute from pipeline manager 1232. In at least one embodiment, instructions are cached in instruction cache 1252 and dispatched for execution by an instruction unit 1254. In at least one embodiment, instruction unit 1254 can dispatch instructions as thread groups (e.g., warps, wavefronts, waves), with each thread of thread group assigned to a different execution unit within GPGPU cores 1262. In at least one embodiment, an instruction can access any of a local, shared, or global address space by specifying an address within a unified address space. In at least one embodiment, address mapping unit 1256 can be used to translate addresses in a unified address space into a distinct memory address that can be accessed by load/store units 1266.

In at least one embodiment, register file 1258 provides a set of registers for functional units of graphics multiprocessor 1234. In at least one embodiment, register file 1258 provides temporary storage for operands connected to data paths of functional units (e.g., GPGPU cores 1262, load/store units 1266) of graphics multiprocessor 1234. In at least one embodiment, register file 1258 is divided between each of functional units such that each functional unit is allocated a dedicated portion of register file 1258. In at least one embodiment, register file 1258 is divided between different warps (which may be referred to as wavefronts and/or waves) being executed by graphics multiprocessor 1234.

In at least one embodiment, GPGPU cores 1262 can each include floating point units (FPUs) and/or integer arithmetic logic units (ALUs) that are used to execute instructions of graphics multiprocessor 1234. In at least one embodiment, GPGPU cores 1262 can be similar in architecture or can differ in architecture. In at least one embodiment, a first portion of GPGPU cores 1262 include a single precision FPU and an integer ALU while a second portion of GPGPU cores include a double precision FPU. In at least one embodiment, FPUs can implement IEEE 754-2008 standard floating point arithmetic or enable variable precision floating point arithmetic. In at least one embodiment, graphics multiprocessor 1234 can additionally include one or more fixed function or special function units to perform specific functions such as copy rectangle or pixel blending operations. In at least one embodiment, one or more of GPGPU cores 1262 can also include fixed or special function logic.

In at least one embodiment, GPGPU cores 1262 include SIMD logic capable of performing a single instruction on multiple sets of data. In at least one embodiment, GPGPU cores 1262 can physically execute SIMD4, SIMD8, and SIMD16 instructions and logically execute SIMD1, SIMD2, and SIMD32 instructions. In at least one embodiment, SIMD instructions for GPGPU cores can be generated at compile time by a shader compiler or automatically generated when executing programs written and compiled for single program multiple data (SPMD) or SIMT architectures. In at least one embodiment, multiple threads of a program configured for an SIMT execution model can executed via a single SIMD instruction. For example, in at least one embodiment, eight SIMT threads that perform same or similar operations can be executed in parallel via a single SIMD8 logic unit.

In at least one embodiment, memory and cache interconnect 1268 is an interconnect network that connects each functional unit of graphics multiprocessor 1234 to register file 1258 and to shared memory 1270. In at least one embodiment, memory and cache interconnect 1268 is a crossbar interconnect that allows load/store unit 1266 to implement load and store operations between shared memory 1270 and register file 1258. In at least one embodiment, register file 1258 can operate at a same frequency as GPGPU cores 1262, thus data transfer between GPGPU cores 1262 and register file 1258 can have very low latency. In at least one embodiment, shared memory 1270 can be used to enable communication between threads that execute on functional units within graphics multiprocessor 1234. In at least one embodiment, cache memory 1272 can be used as a data cache for example, to cache texture data communicated between functional units and texture unit 1236. In at least one embodiment, shared memory 1270 can also be used as a program managed cache. In at least one embodiment, threads executing on GPGPU cores 1262 can programmatically store data within shared memory in addition to automatically cached data that is stored within cache memory 1272.

In at least one embodiment, a parallel processor or GPGPU as described herein is communicatively coupled to host/processor cores to accelerate graphics operations, machine-learning operations, pattern analysis operations, and various general purpose GPU (GPGPU) functions. In at least one embodiment, a GPU may be communicatively coupled to host processor/cores over a bus or other interconnect (e.g., a high-speed interconnect such as PCIe or NVLink). In at least one embodiment, an SoC comprises a parallel processor or GPGPU as described herein, where said parallel processor or said GPGPU is performed on said SoC. In at least one embodiment, a GPU may be integrated on a package or chip as cores and communicatively coupled to cores over an internal processor bus/interconnect internal to a package or chip. In at least one embodiment, regardless a manner in which a GPU is connected, processor cores may allocate work to such GPU in a form of sequences of commands/instructions contained in a work descriptor. In at least one embodiment, that GPU then uses dedicated circuitry/logic for efficiently processing these commands/instructions.

Logic 415 are used to perform inferencing and/or training operations associated with one or more embodiments. Details regarding logic 415 are provided herein in conjunction with FIGS. 4A and/or 4B. In at least one embodiment, logic 415 may be used in graphics multiprocessor 1234 for inferencing or predicting operations based, at least in part, on weight parameters calculated using neural network training operations, neural network functions and/or architectures, or neural network use cases described herein.

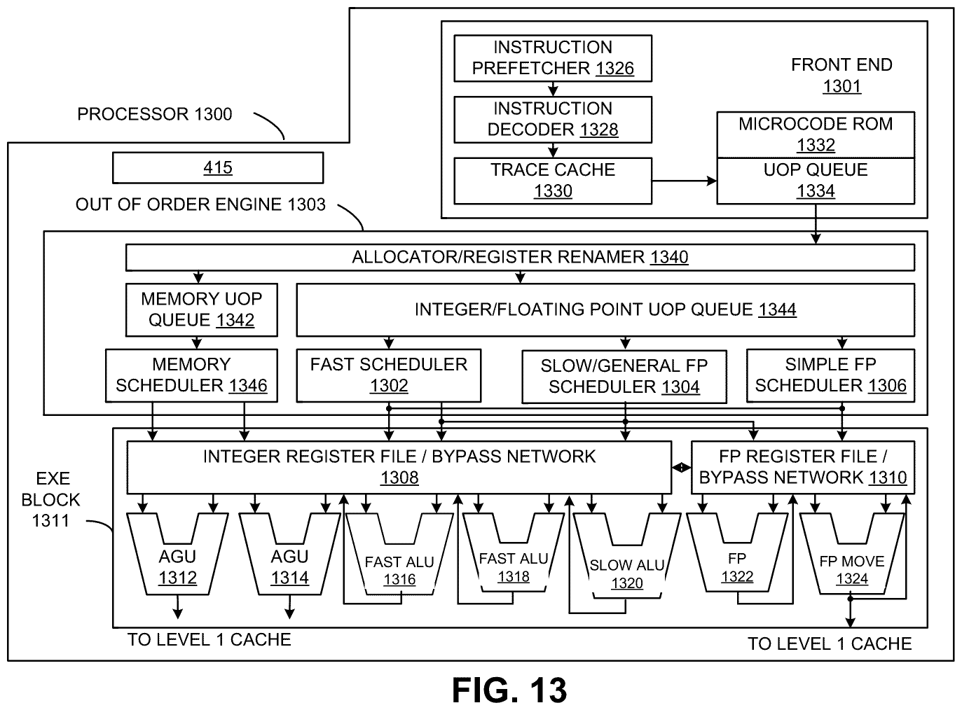

FIG. 13 is a block diagram illustrating micro-architecture for a processor 1300 that may include logic circuits to perform instructions, according to at least one embodiment. In at least one embodiment, processor 1300 may perform instructions, including x86 instructions, ARM instructions, specialized instructions for application-specific integrated circuits (ASICs), etc. In at least one embodiment, processor 1300 may include registers to store packed data, such as 64-bit wide MMX™ registers in microprocessors enabled with MMX technology from Intel Corporation of Santa Clara, Calif. In at least one embodiment, MMX registers, available in both integer and floating point forms, may operate with packed data elements that accompany single instruction, multiple data (“SIMD”) and streaming SIMD extensions (“SSE”) instructions. In at least one embodiment, 128-bit wide XMM registers relating to SSE2, SSE3, SSE4, AVX, or beyond (referred to generically as “SSEx”) technology may hold such packed data operands. In at least one embodiment, processor 1300 may perform instructions to accelerate machine learning or deep learning algorithms, training, or inferencing.

In at least one embodiment, processor 1300 includes an in-order front end (“front end”) 1301 to fetch instructions to be executed and prepare instructions to be used later in a processor pipeline. In at least one embodiment, front end 1301 may include several units. In at least one embodiment, an instruction prefetcher 1326 fetches instructions from memory and feeds instructions to an instruction decoder 1328 which in turn decodes or interprets instructions. For example, in at least one embodiment, instruction decoder 1328 decodes a received instruction into one or more operations called “micro-instructions” or “micro-operations” (also called “micro ops” or “uops” or “μ-ops”) that a machine may execute. In at least one embodiment, instruction decoder 1328 parses an instruction into an opcode and corresponding data and control fields that may be used by micro-architecture to perform operations in accordance with at least one embodiment. In at least one embodiment, a trace cache 1330 may assemble decoded uops into program ordered sequences or traces in a uop queue 1334 for execution. In at least one embodiment, when trace cache 1330 encounters a complex instruction, a microcode ROM 1332 provides uops needed to complete an operation.

In at least one embodiment, some instructions may be converted into a single micro-op, whereas others need several micro-ops to complete full operation. In at least one embodiment, if more than four micro-ops are needed to complete an instruction, instruction decoder 1328 may access microcode ROM 1332 to perform that instruction. In at least one embodiment, an instruction may be decoded into a small number of micro-ops for processing at instruction decoder 1328. In at least one embodiment, an instruction may be stored within microcode ROM 1332 should a number of micro-ops be needed to accomplish such operation. In at least one embodiment, trace cache 1330 refers to an entry point programmable logic array (“PLA”) to determine a correct micro-instruction pointer for reading microcode sequences to complete one or more instructions from microcode ROM 1332 in accordance with at least one embodiment. In at least one embodiment, after microcode ROM 1332 finishes sequencing micro-ops for an instruction, front end 1301 of a machine may resume fetching micro-ops from trace cache 1330.

In at least one embodiment, out-of-order execution engine (“out of order engine”) 1303 may prepare instructions for execution. In at least one embodiment, out-of-order execution logic has a number of buffers to smooth out and re-order flow of instructions to optimize performance as they go down a pipeline and get scheduled for execution. In at least one embodiment, out-of-order execution engine 1303 includes, without limitation, an allocator/register renamer 1340, a memory uop queue 1342, an integer/floating point uop queue 1344, a memory scheduler 1346, a fast scheduler 1302, a slow/general floating point scheduler (“slow/general FP scheduler”) 1304, and a simple floating point scheduler (“simple FP scheduler”) 1306. In at least one embodiment, fast schedule 1302, slow/general floating point scheduler 1304, and simple floating point scheduler 1306 are also collectively referred to herein as “uop schedulers 1302, 1304, 1306.” In at least one embodiment, allocator/register renamer 1340 allocates machine buffers and resources that each uop needs in order to execute. In at least one embodiment, allocator/register renamer 1340 renames logic registers onto entries in a register file. In at least one embodiment, allocator/register renamer 1340 also allocates an entry for each uop in one of two uop queues, memory uop queue 1342 for memory operations and integer/floating point uop queue 1344 for non-memory operations, in front of memory scheduler 1346 and uop schedulers 1302, 1304, 1306. In at least one embodiment, uop schedulers 1302, 1304, 1306, determine when a uop is ready to execute based on readiness of their dependent input register operand sources and availability of execution resources uops need to complete their operation. In at least one embodiment, fast scheduler 1302 may schedule on each half of a main clock cycle while slow/general floating point scheduler 1304 and simple floating point scheduler 1306 may schedule once per main processor clock cycle. In at least one embodiment, uop schedulers 1302, 1304, 1306 arbitrate for dispatch ports to schedule uops for execution.

In at least one embodiment, execution block 1311 includes, without limitation, an integer register file/bypass network 1308, a floating point register file/bypass network (“FP register file/bypass network”) 1310, address generation units (“AGUs”) 1312 and 1314, fast Arithmetic Logic Units (ALUs) (“fast ALUs”) 1316 and 1318, a slow Arithmetic Logic Unit (“slow ALU”) 1320, a floating point ALU (“FP”) 1322, and a floating point move unit (“FP move”) 1324. In at least one embodiment, integer register file/bypass network 1308 and floating point register file/bypass network 1310 are also referred to herein as “register files 1308, 1310.” In at least one embodiment, AGUSs 1312 and 1314, fast ALUs 1316 and 1318, slow ALU 1320, floating point ALU 1322, and floating point move unit 1324 are also referred to herein as “execution units 1312, 1314, 1316, 1318, 1320, 1322, and 1324.” In at least one embodiment, execution block 1311 may include, without limitation, any number (including zero) and type of register files, bypass networks, address generation units, and execution units, in any combination.

In at least one embodiment, register networks 1308, 1310 may be arranged between uop schedulers 1302, 1304, 1306, and execution units 1312, 1314, 1316, 1318, 1320, 1322, and 1324. In at least one embodiment, integer register file/bypass network 1308 performs integer operations. In at least one embodiment, floating point register file/bypass network 1310 performs floating point operations. In at least one embodiment, each of register networks 1308, 1310 may include, without limitation, a bypass network that may bypass or forward just completed results that have not yet been written into a register file to new dependent uops. In at least one embodiment, register networks 1308, 1310 may communicate data with each other. In at least one embodiment, integer register file/bypass network 1308 may include, without limitation, two separate register files, one register file for a low-order thirty-two bits of data and a second register file for a high order thirty-two bits of data. In at least one embodiment, floating point register file/bypass network 1310 may include, without limitation, 128-bit wide entries because floating point instructions typically have operands from 64 to 128 bits in width.

In at least one embodiment, execution units 1312, 1314, 1316, 1318, 1320, 1322, 1324 may execute instructions. In at least one embodiment, register networks 1308, 1310 store integer and floating point data operand values that micro-instructions need to execute. In at least one embodiment, processor 1300 may include, without limitation, any number and combination of execution units 1312, 1314, 1316, 1318, 1320, 1322, 1324. In at least one embodiment, floating point ALU 1322 and floating point move unit 1324, may execute floating point, MMX, SIMD, AVX and SSE, or other operations, including specialized machine learning instructions. In at least one embodiment, floating point ALU 1322 may include, without limitation, a 64-bit by 64-bit floating point divider to execute divide, square root, and remainder micro ops. In at least one embodiment, instructions involving a floating point value may be handled with floating point hardware. In at least one embodiment, ALU operations may be passed to fast ALUs 1316, 1318. In at least one embodiment, fast ALUS 1316, 1318 may execute fast operations with an effective latency of half a clock cycle. In at least one embodiment, most complex integer operations go to slow ALU 1320 as slow ALU 1320 may include, without limitation, integer execution hardware for long-latency type of operations, such as a multiplier, shifts, flag logic, and branch processing. In at least one embodiment, memory load/store operations may be executed by AGUs 1312, 1314. In at least one embodiment, fast ALU 1316, fast ALU 1318, and slow ALU 1320 may perform integer operations on 64-bit data operands. In at least one embodiment, fast ALU 1316, fast ALU 1318, and slow ALU 1320 may be implemented to support a variety of data bit sizes including sixteen, thirty-two, 128, 256, etc. In at least one embodiment, floating point ALU 1322 and floating point move unit 1324 may be implemented to support a range of operands having bits of various widths, such as 128-bit wide packed data operands in conjunction with SIMD and multimedia instructions.

In at least one embodiment, uop schedulers 1302, 1304, 1306 dispatch dependent operations before a parent load has finished executing. In at least one embodiment, as uops may be speculatively scheduled and executed in processor 1300, processor 1300 may also include logic to handle memory misses. In at least one embodiment, if a data load misses in a data cache, there may be dependent operations in flight in a pipeline that have left a scheduler with temporarily incorrect data. In at least one embodiment, a replay mechanism tracks and re-executes instructions that use incorrect data. In at least one embodiment, dependent operations might need to be replayed and independent ones may be allowed to complete. In at least one embodiment, schedulers and a replay mechanism of at least one embodiment of a processor may also be designed to catch instruction sequences for text string comparison operations.

In at least one embodiment, “registers” may refer to on-board processor storage locations that may be used as part of instructions to identify operands. In at least one embodiment, registers may be those that may be usable from outside of a processor (from a programmer's perspective). In at least one embodiment, registers might not be limited to a particular type of circuit. Rather, in at least one embodiment, a register may store data, provide data, and perform functions described herein. In at least one embodiment, registers described herein may be implemented by circuitry within a processor using any number of different techniques, such as dedicated physical registers, dynamically allocated physical registers using register renaming, combinations of dedicated and dynamically allocated physical registers, etc. In at least one embodiment, integer registers store 32-bit integer data. A register file of at least one embodiment also contains eight multimedia SIMD registers for packed data.

In at least one embodiment, processor 1300 or each core of processor 1300 includes one or more prefetchers, one or more fetchers, one or more pre-decoders, one or more decoders to decode data (e.g., instructions), one or more instruction queues to process instructions (e.g., corresponding to operations or API calls), one or more micro-operation (μOP) cache to store μOPs, one or more micro-operation (μOP) queues, an in-order execution engine, one or more load buffers, one or more store buffers, one or more reorder buffers, one or more fill buffers, an out-of-order execution engine, one or more ports, one or more shift and/or shifter units, one or more fused multiply accumulate (FMA) units, one or more load and store units (“LSUs”) to perform load of store operations corresponding to loading/storing data (e.g., instructions) to perform an operation (e.g., perform an API, an API call), one or more matrix multiply accumulate (MMA) units, and/or one or more shuffle units to perform any function further described herein with respect to said processor 1300. In at least one embodiment processor 1300 can access, use, perform, or execute instructions corresponding to calling an API.

In at least one embodiment, processor 1300 includes one or more ultra path interconnects (UPIs), e.g., that is a point-to-point processor interconnect; one or more PCIe's; one or more accelerators to accelerate computations or operations; and/or one or more memory controllers. In at least one embodiment, processor 1300 includes a shared last level cache (LLC) that is coupled to one or more memory controllers, which can enable shared memory access across processor cores.

In at least one embodiment, processor 1300 or a core of processor 1300 has a mesh architecture where processor cores, on-chip caches, memory controllers, and I/O controllers are organized in rows and columns, with wires and switches connecting them at each intersection to allow for turns. In at least one embodiment, processor 1300 has one or more higher memory bandwidths (HMBs, e.g., HMBe) to store data or cache data, e.g., in Double Data Rate 5 Synchronous Dynamic Random-Access Memory (DDR5 SDRAM). In at least one embodiment, one or more components of processor 1300 are interconnected using compute express link (CXL) interconnects. In at least one embodiment, a memory controller uses a “least recently used” (LRU) approach to determine what gets stored in a cache. In at least one embodiment, processor 1300 includes one or more PCIe's (e.g., PCIe 5.0).

Logic 415 are used to perform inferencing and/or training operations associated with one or more embodiments. Details regarding logic 415 are provided herein in conjunction with FIGS. 4A and/or 4B. In at least one embodiment portions or all of logic 415 may be incorporated into execution block 1311 and other memory or registers shown or not shown. For example, in at least one embodiment, training and/or inferencing techniques described herein may use one or more of ALUs illustrated in execution block 1311. Moreover, weight parameters may be stored in on-chip or off-chip memory and/or registers (shown or not shown) that configure ALUs of execution block 1311 to perform one or more machine learning algorithms, neural network architectures, use cases, or training techniques described herein.

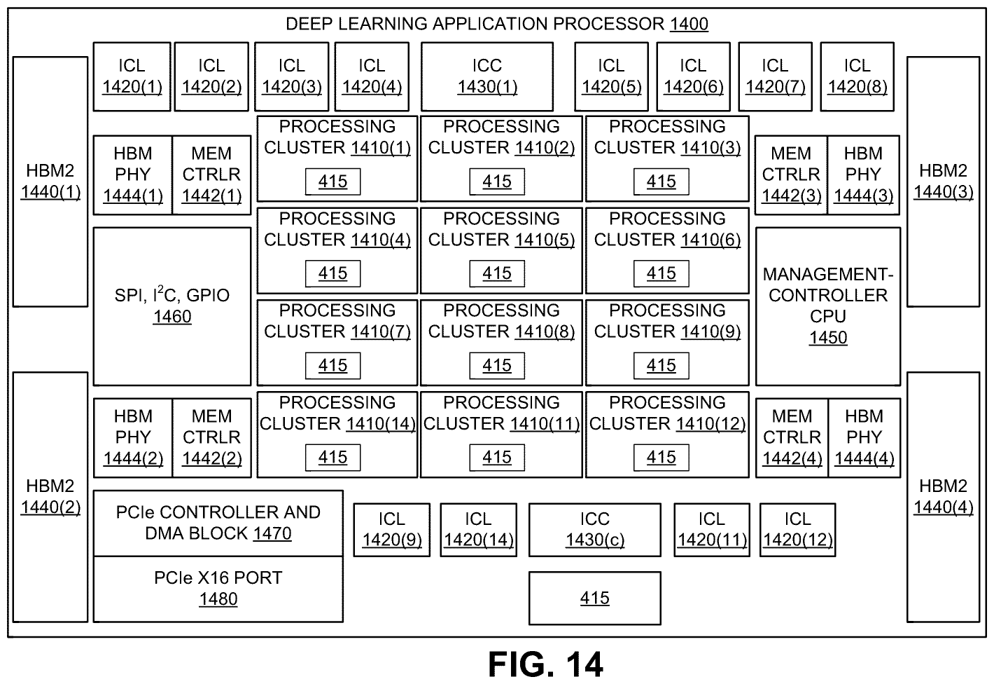

FIG. 14 illustrates a deep learning application processor 1400, according to at least one embodiment. In at least one embodiment, deep learning application processor 1400 uses instructions that, if executed by deep learning application processor 1400, cause deep learning application processor 1400 to perform some or all of processes and techniques described throughout this disclosure. In at least one embodiment, deep learning application processor 1400 is an application-specific integrated circuit (ASIC). In at least one embodiment, application processor 1400 performs matrix multiply operations either “hard-wired” into hardware as a result of performing one or more instructions or both. In at least one embodiment, deep learning application processor 1400 includes, without limitation, processing clusters 1410(1)-1410(12), Inter-Chip Links (“ICLs”) 1420(1)-1420(12), Inter-Chip Controllers (“ICCs”) 1430(1)-1430(2), high-bandwidth memory second generation (“HBM2”) 1440(1)-1440(4), memory controllers (“Mem Ctrlrs”) 1442(1)-1442(4), high bandwidth memory physical layer (“HBM PHY”) 1444(1)-1444(4), a management-controller central processing unit (“management-controller CPU”) 1450, a Serial Peripheral Interface, Inter-Integrated Circuit, and General Purpose Input/Output block (“SPI, I2C, GPIO”) 1460, a peripheral component interconnect express controller and direct memory access block (“PCIe Controller and DMA”) 1470, and a sixteen-lane peripheral component interconnect express port (“PCI Express x 16”) 1480.

In at least one embodiment, processing clusters 1410 may perform deep learning operations, including inference or prediction operations based on weight parameters calculated one or more training techniques, including those described herein. In at least one embodiment, each processing cluster 1410 may include, without limitation, any number and type of processors. In at least one embodiment, deep learning application processor 1400 may include any number and type of processing clusters 1400. In at least one embodiment, Inter-Chip Links 1420 are bi-directional. In at least one embodiment, Inter-Chip Links 1420 and Inter-Chip Controllers 1430 enable multiple deep learning application processors 1400 to exchange information, including activation information resulting from performing one or more machine learning algorithms embodied in one or more neural networks. In at least one embodiment, deep learning application processor 1400 may include any number (including zero) and type of ICLs 1420 and ICCs 1430.

In at least one embodiment, HBM2s 1440 provide a total of 32 Gigabytes (GB) of memory. In at least one embodiment, HBM2 1440(i) is associated with both memory controller 1442(i) and HBM PHY 1444(i) where “i” is an arbitrary integer. In at least one embodiment, any number of HBM2s 1440 may provide any type and total amount of high bandwidth memory and may be associated with any number (including zero) and type of memory controllers 1442 and HBM PHYs 1444. In at least one embodiment, SPI, I2C, GPIO 1460, PCIe Controller and DMA 1470, and/or PCIe 1480 may be replaced with any number and type of blocks that enable any number and type of communication standards in any technically feasible fashion.

Logic 415 are used to perform inferencing and/or training operations associated with one or more embodiments. Details regarding logic 415 are provided herein in conjunction with FIGS. 4A and/or 4B. In at least one embodiment, deep learning application processor is used to train a machine learning model, such as a neural network, to predict or infer information provided to deep learning application processor 1400. In at least one embodiment, deep learning application processor 1400 is used to infer or predict information based on a trained machine learning model (e.g., neural network) that has been trained by another processor or system or by deep learning application processor 1400. In at least one embodiment, processor 1400 may be used to perform one or more neural network use cases described herein.

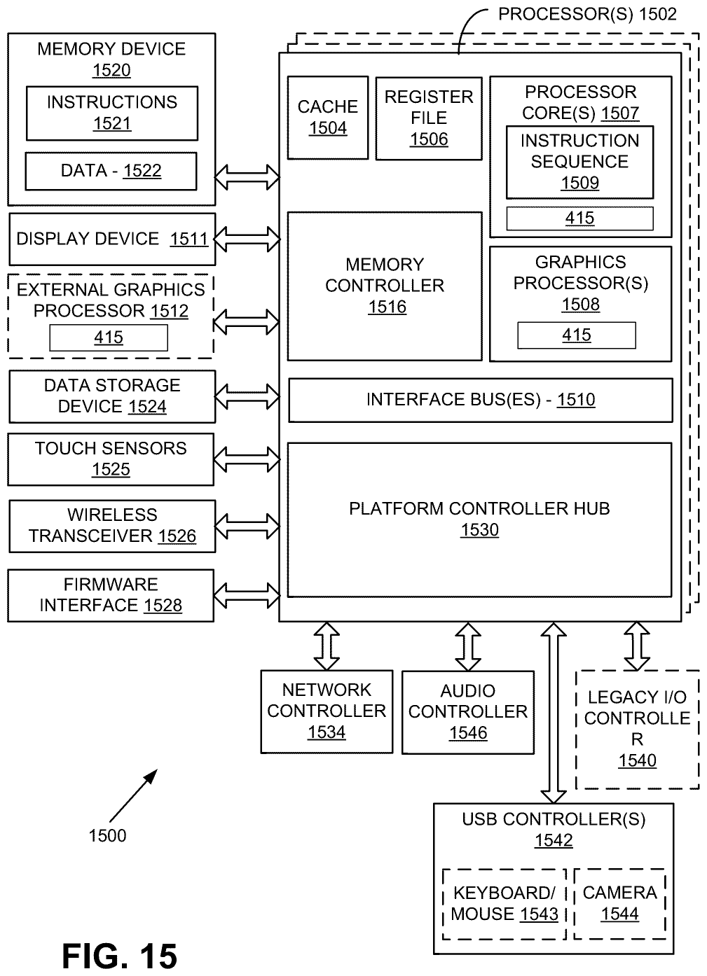

FIG. 15 is a block diagram of a processing system, according to at least one embodiment. In at least one embodiment, system 1500 includes one or more processors 1502 and one or more graphics processors 1508, and may be a single processor desktop system, a multiprocessor workstation system, or a server system having a large number of processors 1502 or processor cores 1507. In at least one embodiment, system 1500 is a processing platform incorporated within a system-on-a-chip (SoC) integrated circuit for use in mobile, handheld, or embedded devices. In at least one embodiment, one or more graphics processors 1508 include one or more graphics cores 1100.

In at least one embodiment, system 1500 can include, or be incorporated within a server-based gaming platform, a game console, including a game and media console, a mobile gaming console, a handheld game console, or an online game console. In at least one embodiment, system 1500 is a mobile phone, a smart phone, a tablet computing device or a mobile Internet device. In at least one embodiment, processing system 1500 can also include, couple with, or be integrated within a wearable device, such as a smart watch wearable device, a smart eyewear device, an augmented reality device, or a virtual reality device. In at least one embodiment, processing system 1500 is a television or set top box device having one or more processors 1502 and a graphical interface generated by one or more graphics processors 1508.

In at least one embodiment, one or more processors 1502 each include one or more processor cores 1507 to process instructions which, when executed, perform operations for system and user software. In at least one embodiment, each of one or more processor cores 1507 is configured to process a specific instruction sequence 1509. In at least one embodiment, instruction sequence 1509 may facilitate Complex Instruction Set Computing (CISC), Reduced Instruction Set Computing (RISC), or computing via a Very Long Instruction Word (VLIW). In at least one embodiment, processor cores 1507 may each process a different instruction sequence 1509, which may include instructions to facilitate emulation of other instruction sequences. In at least one embodiment, processor core 1507 may also include other processing devices, such a Digital Signal Processor (DSP).

In at least one embodiment, processor 1502 includes a cache memory 1504. In at least one embodiment, processor 1502 can have a single internal cache or multiple levels of internal cache. In at least one embodiment, cache memory is shared among various components of processor 1502. In at least one embodiment, processor 1502 also uses an external cache (e.g., a Level-3 (L3) cache or Last Level Cache (LLC)) (not shown), which may be shared among processor cores 1507 using known cache coherency techniques. In at least one embodiment, a register file 1506 is additionally included in processor 1502, which may include different types of registers for storing different types of data (e.g., integer registers, floating point registers, status registers, and an instruction pointer register). In at least one embodiment, register file 1506 may include general-purpose registers or other registers.

In at least one embodiment, one or more processor(s) 1502 are coupled with one or more interface bus(es) 1510 to transmit communication signals such as address, data, or control signals between processor 1502 and other components in system 1500. In at least one embodiment, interface bus 1510 can be a processor bus, such as a version of a Direct Media Interface (DMI) bus. In at least one embodiment, interface bus 1510 is not limited to a DMI bus, and may include one or more Peripheral Component Interconnect buses (e.g., PCI, PCI Express), memory busses, or other types of interface busses. In at least one embodiment processor(s) 1502 include an integrated memory controller 1516 and a platform controller hub 1530. In at least one embodiment, memory controller 1516 facilitates communication between a memory device and other components of system 1500, while platform controller hub (PCH) 1530 provides connections to I/O devices via a local I/O bus.

In at least one embodiment, a memory device 1520 can be a dynamic random access memory (DRAM) device, a static random access memory (SRAM) device, flash memory device, phase-change memory device, or some other memory device having suitable performance to serve as process memory. In at least one embodiment, memory device 1520 can operate as system memory for system 1500, to store data 1522 and instructions 1521 for use when one or more processors 1502 executes an application or process. In at least one embodiment, memory controller 1516 also couples with an optional external graphics processor 1512, which may communicate with one or more graphics processors 1508 in processors 1502 to perform graphics and media operations. In at least one embodiment, a display device 1511 can connect to processor(s) 1502. In at least one embodiment, display device 1511 can include one or more of an internal display device, as in a mobile electronic device or a laptop device, or an external display device attached via a display interface (e.g., DisplayPort, etc.). In at least one embodiment, display device 1511 can include a head mounted display (HMD) such as a stereoscopic display device for use in virtual reality (VR) applications or augmented reality (AR) applications.

In at least one embodiment, platform controller hub 1530 enables peripherals to connect to memory device 1520 and processor 1502 via a high-speed I/O bus. In at least one embodiment, I/O peripherals include, but are not limited to, an audio controller 1546, a network controller 1534, a firmware interface 1528, a wireless transceiver 1526, touch sensors 1525, a data storage device 1524 (e.g., hard disk drive, flash memory, etc.). In at least one embodiment, data storage device 1524 can connect via a storage interface (e.g., SATA) or via a peripheral bus, such as a Peripheral Component Interconnect bus (e.g., PCI, PCI Express). In at least one embodiment, touch sensors 1525 can include touch screen sensors, pressure sensors, or fingerprint sensors. In at least one embodiment, wireless transceiver 1526 can be a Wi-Fi transceiver, a Bluetooth transceiver, or a mobile network transceiver such as a 3G, 4G, or Long Term Evolution (LTE) transceiver. In at least one embodiment, firmware interface 1528 enables communication with system firmware, and can be, for example, a unified extensible firmware interface (UEFI). In at least one embodiment, network controller 1534 can enable a network connection to a wired network. In at least one embodiment, a high-performance network controller (not shown) couples with interface bus 1510. In at least one embodiment, audio controller 1546 is a multi-channel high definition audio controller. In at least one embodiment, system 1500 includes an optional legacy I/O controller 1540 for coupling legacy (e.g., Personal System 2 (PS/2)) devices to system 1500. In at least one embodiment, platform controller hub 1530 can also connect to one or more Universal Serial Bus (USB) controllers 1542 connect input devices, such as keyboard and mouse 1543 combinations, a camera 1544, or other USB input devices.

In at least one embodiment, an instance of memory controller 1516 and platform controller hub 1530 may be integrated into a discreet external graphics processor, such as external graphics processor 1512. In at least one embodiment, platform controller hub 1530 and/or memory controller 1516 may be external to one or more processor(s) 1502. For example, in at least one embodiment, system 1500 can include an external memory controller 1516 and platform controller hub 1530, which may be configured as a memory controller hub and peripheral controller hub within a system chipset that is in communication with processor(s) 1502.

Logic 415 are used to perform inferencing and/or training operations associated with one or more embodiments. Details regarding logic 415 are provided herein in conjunction with FIGS. 4A and/or 4B. In at least one embodiment portions or all of logic 415 may be incorporated into graphics processor 1508. For example, in at least one embodiment, training and/or inferencing techniques described herein may use one or more of ALUs embodied in a 3D pipeline. Moreover, in at least one embodiment, inferencing and/or training operations described herein may be done using logic other than logic illustrated in FIG. 4A or 4B. In at least one embodiment, weight parameters may be stored in on-chip or off-chip memory and/or registers (shown or not shown) that configure ALUs of graphics processor 1508 to perform one or more machine learning algorithms, neural network architectures, use cases, or training techniques described herein.

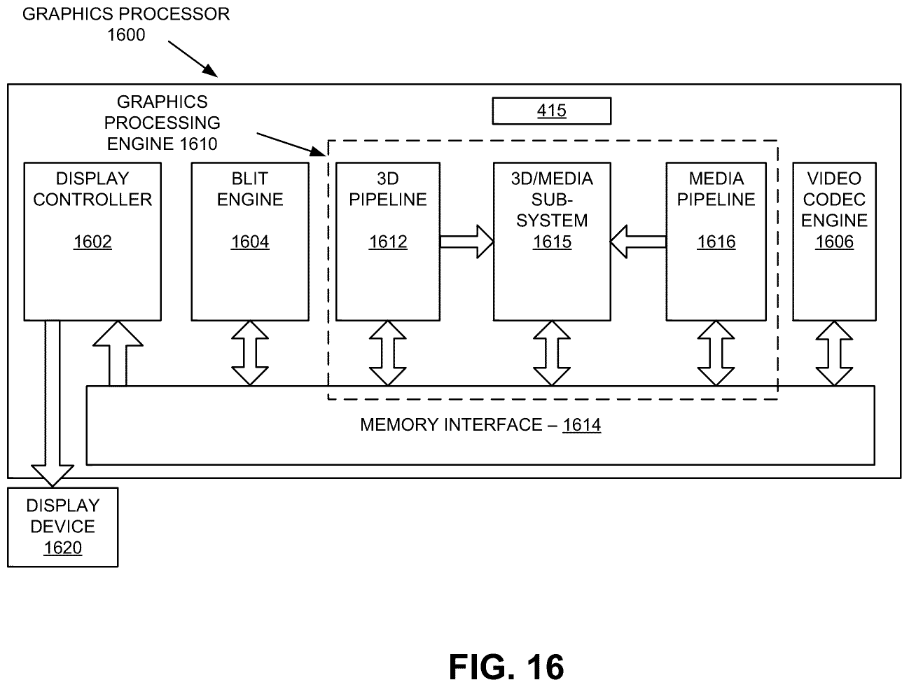

FIG. 16 is a block diagram of a graphics processor 1600, which may be a discrete graphics processing unit, or may be a graphics processor integrated with a plurality of processing cores. In at least one embodiment, graphics processor 1600 communicates via a memory mapped I/O interface to registers on graphics processor 1600 and with commands placed into memory. In at least one embodiment, graphics processor 1600 includes a memory interface 1614 to access memory. In at least one embodiment, memory interface 1614 is an interface to local memory, one or more internal caches, one or more shared external caches, and/or to system memory. In at least one embodiment, graphics processor 1600 includes graphics core 1100.

In at least one embodiment, graphics processor 1600 also includes a display controller 1602 to drive display output data to a display device 1620. In at least one embodiment, display controller 1602 includes hardware for one or more overlay planes for display device 1620 and composition of multiple layers of video or user interface elements. In at least one embodiment, display device 1620 can be an internal or external display device. In at least one embodiment, display device 1620 is a head mounted display device, such as a virtual reality (VR) display device or an augmented reality (AR) display device. In at least one embodiment, graphics processor 1600 includes a video codec engine 1606 to encode, decode, or transcode media to, from, or between one or more media encoding formats, including, but not limited to Moving Picture Experts Group (MPEG) formats such as MPEG-2, Advanced Video Coding (AVC) formats such as H.264/MPEG-4 AVC, as well as the Society of Motion Picture & Television Engineers (SMPTE) 421M/VC-1, and Joint Photographic Experts Group (JPEG) formats such as JPEG, and Motion JPEG (MJPEG) formats.

In at least one embodiment, graphics processor 1600 includes a block image transfer (BLIT) engine 1604 to perform two-dimensional (2D) rasterizer operations including, for example, bit-boundary block transfers. However, in at least one embodiment, 2D graphics operations are performed using one or more components of a graphics processing engine (GPE) 1610. In at least one embodiment, GPE 1610 is a compute engine for performing graphics operations, including three-dimensional (3D) graphics operations and media operations.

In at least one embodiment, GPE 1610 includes a 3D pipeline 1612 for performing 3D operations, such as rendering three-dimensional images and scenes using processing functions that act upon 3D primitive shapes (e.g., rectangle, triangle, etc.). In at least one embodiment, 3D pipeline 1612 includes programmable and fixed function elements that perform various tasks and/or spawn execution threads to a 3D/Media sub-system 1615. While 3D pipeline 1612 can be used to perform media operations, in at least one embodiment, GPE 1610 also includes a media pipeline 1616 that is used to perform media operations, such as video post-processing and image enhancement.

In at least one embodiment, media pipeline 1616 includes fixed function or programmable logic units to perform one or more specialized media operations, such as video decode acceleration, video de-interlacing, and video encode acceleration in place of, or on behalf of, video codec engine 1606. In at least one embodiment, media pipeline 1616 additionally includes a thread spawning unit to spawn threads for execution on 3D/Media sub-system 1615. In at least one embodiment, spawned threads perform computations for media operations on one or more graphics execution units included in 3D/Media sub-system 1615.

In at least one embodiment, 3D/Media subsystem 1615 includes logic for executing threads spawned by 3D pipeline 1612 and media pipeline 1616. In at least one embodiment, 3D pipeline 1612 and media pipeline 1616 send thread execution requests to 3D/Media subsystem 1615, which includes thread dispatch logic for arbitrating and dispatching various requests to available thread execution resources. In at least one embodiment, execution resources include an array of graphics execution units to process 3D and media threads. In at least one embodiment, 3D/Media subsystem 1615 includes one or more internal caches for thread instructions and data. In at least one embodiment, subsystem 1615 also includes shared memory, including registers and addressable memory, to share data between threads and to store output data.

Logic 415 are used to perform inferencing and/or training operations associated with one or more embodiments. Details regarding logic 415 are provided herein in conjunction with FIGS. 4A and/or 4B. In at least one embodiment portions or all of logic 415 may be incorporated into graphics processor 1600. For example, in at least one embodiment, training and/or inferencing techniques described herein may use one or more of ALUs embodied in 3D pipeline 1612. Moreover, in at least one embodiment, inferencing and/or training operations described herein may be done using logic other than logic illustrated in FIG. 4A or 4B. In at least one embodiment, weight parameters may be stored in on-chip or off-chip memory and/or registers (shown or not shown) that configure ALUs of graphics processor 1600 to perform one or more machine learning algorithms, neural network architectures, use cases, or training techniques described herein.

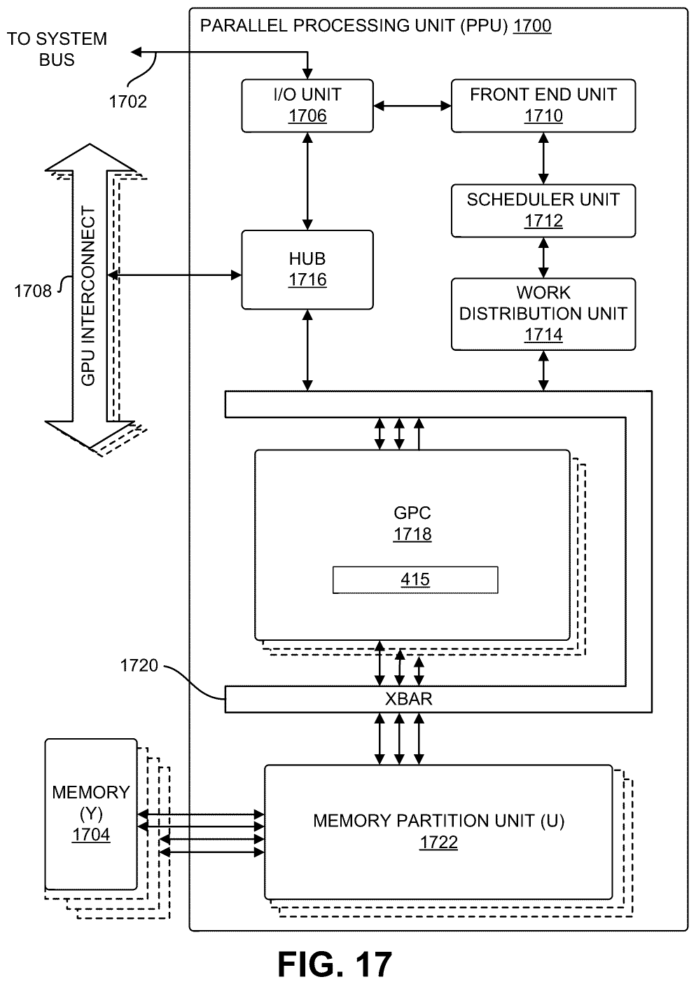

FIG. 17 illustrates a parallel processing unit (“PPU”) 1700, according to at least one embodiment. In at least one embodiment, PPU 1700 is configured with machine-readable code that, if executed by PPU 1700, causes PPU 1700 to perform some or all of processes and techniques described throughout this disclosure. In at least one embodiment, PPU 1700 is a multi-threaded processor that is implemented on one or more integrated circuit devices and that utilizes multithreading as a latency-hiding technique designed to process computer-readable instructions (also referred to as machine-readable instructions or simply instructions) on multiple threads in parallel. In at least one embodiment, PPU 1700 includes one or more graphics cores 1100. In at least one embodiment, a thread refers to a thread of execution and is an instantiation of a set of instructions configured to be executed by PPU 1700. In at least one embodiment, PPU 1700 is a graphics processing unit (“GPU”) configured to implement a graphics rendering pipeline for processing three-dimensional (“3D”) graphics data in order to generate two-dimensional (“2D”) image data for display on a display device such as a liquid crystal display (“LCD”) device. In at least one embodiment, PPU 1700 is utilized to perform computations such as linear algebra operations and machine-learning operations. FIG. 17 illustrates an example parallel processor for illustrative purposes only and should be construed as a non-limiting example of processor architectures contemplated within scope of this disclosure and that any suitable processor may be employed to supplement and/or substitute for same.

In at least one embodiment, one or more PPUs 1700 are configured to accelerate High Performance Computing (“HPC”), data center, and machine learning applications. In at least one embodiment, PPU 1700 is configured to accelerate deep learning systems and applications including following non-limiting examples: autonomous vehicle platforms, deep learning, high-accuracy speech, image, text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and more.

In at least one embodiment, PPU 1700 includes, without limitation, an Input/Output (“I/O”) unit 1706, a front-end unit 1710, a scheduler (sequencer) unit 1712, a work distribution unit 1714, a hub 1716, a crossbar (“XBar”) 1720, one or more general processing clusters (“GPCs”) 1718, and one or more partition units (“memory partition units”) 1722. In at least one embodiment, PPU 1700 is connected to a host processor or other PPUs 1700 via one or more high-speed GPU interconnects (“GPU interconnects”) 1708. In at least one embodiment, PPU 1700 is connected to a host processor or other peripheral devices via a system bus 1702. In at least one embodiment, PPU 1700 is connected to a local memory comprising one or more memory devices (“memory”) 1704. In at least one embodiment, memory devices 1704 include, without limitation, one or more dynamic random access memory (“DRAM”) devices. In at least one embodiment, one or more DRAM devices are configured and/or configurable as high-bandwidth memory (“HBM”) subsystems, with multiple DRAM dies stacked within each device.

In at least one embodiment, high-speed GPU interconnect 1708 may refer to a wire-based multi-lane communications link that is used by systems to scale and include one or more PPUs 1700 combined with one or more central processing units (“CPUs”), supports cache coherence between PPUs 1700 and CPUs, and CPU mastering. In at least one embodiment, data and/or commands are transmitted by high-speed GPU interconnect 1708 through hub 1716 to/from other units of PPU 1700 such as one or more copy engines, video encoders, video decoders, power management units, and other components which may not be explicitly illustrated in FIG. 17.

In at least one embodiment, I/O unit 1706 is configured to transmit and receive communications (e.g., commands, data) from a host processor (not illustrated in FIG. 17) over system bus 1702. In at least one embodiment, I/O unit 1706 communicates with host processor directly via system bus 1702 or through one or more intermediate devices such as a memory bridge. In at least one embodiment, I/O unit 1706 may communicate with one or more other processors, such as one or more of PPUs 1700 via system bus 1702. In at least one embodiment, I/O unit 1706 implements a Peripheral Component Interconnect Express (“PCIe”) interface for communications over a PCIe bus. In at least one embodiment, I/O unit 1706 implements interfaces for communicating with external devices.

In at least one embodiment, I/O unit 1706 decodes packets received via system bus 1702. In at least one embodiment, at least some packets represent commands configured to cause PPU 1700 to perform various operations. In at least one embodiment, I/O unit 1706 transmits decoded commands to various other units of PPU 1700 as specified by commands. In at least one embodiment, commands are transmitted to front-end unit 1710 and/or transmitted to hub 1716 or other units of PPU 1700 such as one or more copy engines, a video encoder, a video decoder, a power management unit, etc. (not explicitly illustrated in FIG. 17). In at least one embodiment, I/O unit 1706 is configured to route communications between and among various logical units of PPU 1700.

In at least one embodiment, a program executed by host processor encodes a command stream in a buffer that provides workloads to PPU 1700 for processing. In at least one embodiment, a workload comprises instructions and data to be processed by those instructions. In at least one embodiment, a buffer is a region in a memory that is accessible (e.g., read/write) by both a host processor and PPU 1700—a host interface unit may be configured to access that buffer in a system memory connected to system bus 1702 via memory requests transmitted over system bus 1702 by I/O unit 1706. In at least one embodiment, a host processor writes a command stream to a buffer and then transmits a pointer to a start of a command stream to PPU 1700 such that front-end unit 1710 receives pointers to one or more command streams and manages one or more command streams, reading commands from command streams and forwarding commands to various units of PPU 1700.

In at least one embodiment, front-end unit 1710 is coupled to scheduler unit 1712 (which may be referred to as a sequencer unit, a thread sequencer, and/or an asynchronous compute engine) that configures various GPCs 1718 to process tasks defined by one or more command streams. In at least one embodiment, scheduler unit 1712 is configured to track state information related to various tasks managed by scheduler unit 1712 where state information may indicate which of GPCs 1718 a task is assigned to, whether task is active or inactive, a priority level associated with task, and so forth. In at least one embodiment, scheduler unit 1712 manages execution of a plurality of tasks on one or more of GPCs 1718.

In at least one embodiment, scheduler unit 1712 is coupled to work distribution unit 1714 that is configured to dispatch tasks for execution on GPCs 1718. In at least one embodiment, work distribution unit 1714 tracks a number of scheduled tasks received from scheduler unit 1712 and work distribution unit 1714 manages a pending task pool and an active task pool for each of GPCs 1718. In at least one embodiment, pending task pool comprises a number of slots (e.g., 32 slots) that contain tasks assigned to be processed by a particular GPC 1718; an active task pool may comprise a number of slots (e.g., 4 slots) for tasks that are actively being processed by GPCs 1718 such that as one of GPCs 1718 completes execution of a task, that task is evicted from that active task pool for GPC 1718 and another task from a pending task pool is selected and scheduled for execution on GPC 1718. In at least one embodiment, if an active task is idle on GPC 1718, such as while waiting for a data dependency to be resolved, then that active task is evicted from GPC 1718 and returned to that pending task pool while another task in that pending task pool is selected and scheduled for execution on GPC 1718.

In at least one embodiment, work distribution unit 1714 communicates with one or more GPCs 1718 via XBar 1720. In at least one embodiment, XBar 1720 is an interconnect network that couples many of units of PPU 1700 to other units of PPU 1700 and can be configured to couple work distribution unit 1714 to a particular GPC 1718. In at least one embodiment, one or more other units of PPU 1700 may also be connected to XBar 1720 via hub 1716.

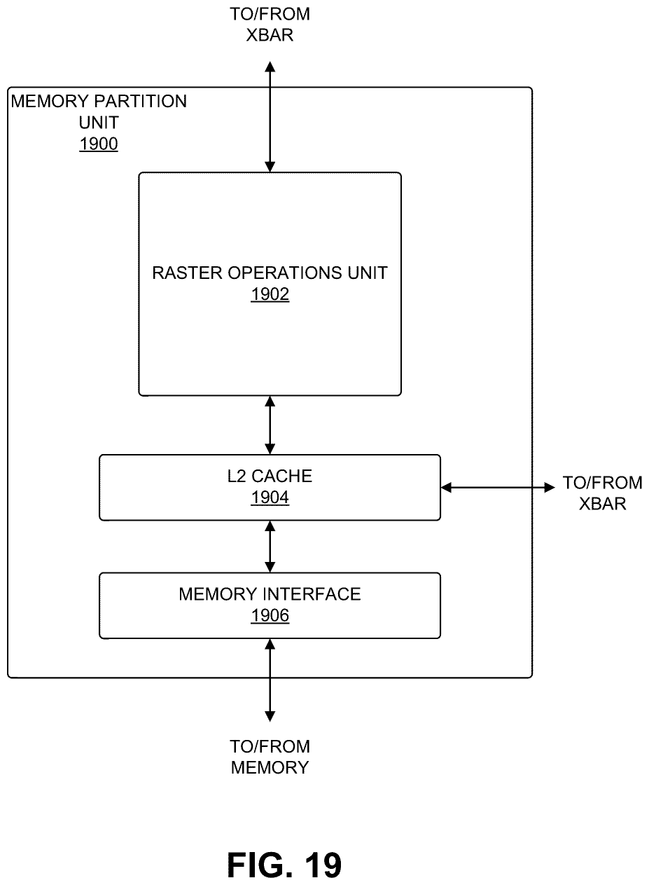

In at least one embodiment, tasks are managed by scheduler unit 1712 and dispatched to one of GPCs 1718 by work distribution unit 1714. In at least one embodiment, GPC 1718 is configured to process task and generate results. In at least one embodiment, results may be consumed by other tasks within GPC 1718, routed to a different GPC 1718 via XBar 1720, or stored in memory 1704. In at least one embodiment, results can be written to memory 1704 via partition units 1722, which implement a memory interface for reading and writing data to/from memory 1704. In at least one embodiment, results can be transmitted to another PPU or CPU via high-speed GPU interconnect 1708. In at least one embodiment, PPU 1700 includes, without limitation, a number U of partition units 1722 that is equal to a number of separate and distinct memory devices 1704 coupled to PPU 1700, as described in more detail herein in conjunction with FIG. 19.

In at least one embodiment, a host processor executes a driver kernel that implements an application programming interface (“API”) that enables one or more applications executing on a host processor to schedule operations for execution on PPU 1700. In at least one embodiment, multiple compute applications are simultaneously executed by PPU 1700 and PPU 1700 provides isolation, quality of service (“QoS”), and independent address spaces for multiple compute applications. In at least one embodiment, an application generates instructions (e.g., in form of API calls) that cause a driver kernel to generate one or more tasks for execution by PPU 1700 and that driver kernel outputs tasks to one or more streams being processed by PPU 1700. In at least one embodiment, each task comprises one or more groups of related threads, which may be referred to as a warp, wavefront, and/or wave. In at least one embodiment, a warp, wavefront, and/or wave comprises a plurality of related threads (e.g., 32 threads) that can be executed in parallel. In at least one embodiment, cooperating threads can refer to a plurality of threads including instructions to perform task and that exchange data through shared memory. In at least one embodiment, threads and cooperating threads are described in more detail in conjunction with FIG. 19.

Logic 415 are used to perform inferencing and/or training operations associated with one or more embodiments. Details regarding logic 415 are provided herein in conjunction with FIGS. 4A and/or 4B. In at least one embodiment, deep learning application processor is used to train a machine learning model, such as a neural network, to predict or infer information provided to PPU 1700. In at least one embodiment, deep learning application processor is used to infer or predict information based on a trained machine learning model (e.g., neural network) that has been trained by another processor or system or by PPU 1700. In at least one embodiment, PPU 1700 may be used to perform one or more neural network use cases described herein.

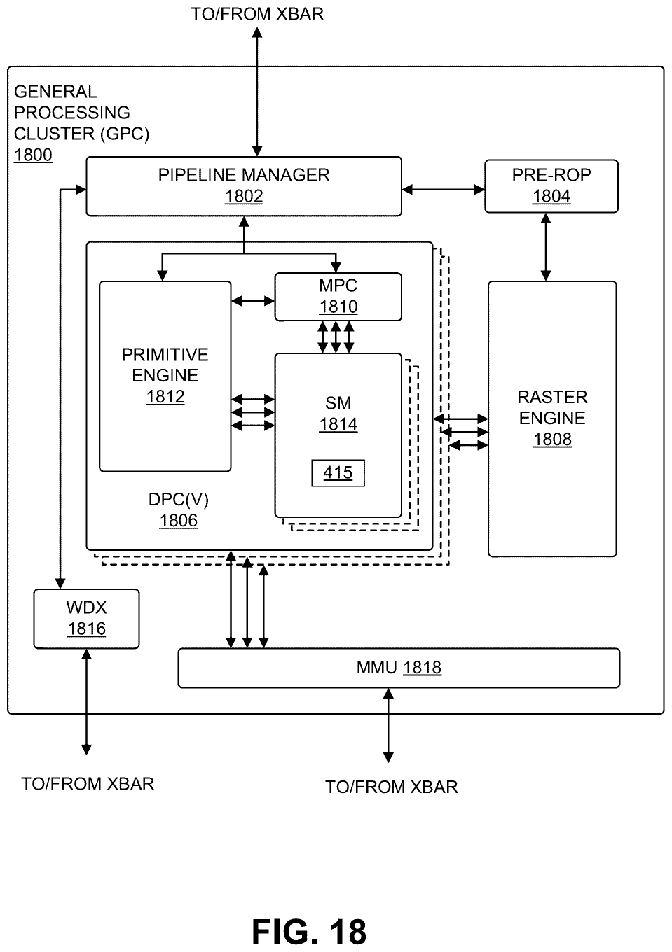

FIG. 18 illustrates a general processing cluster (“GPC”) 1800, according to at least one embodiment. In at least one embodiment, GPC 1800 is GPC 1718 of FIG. 17. In at least one embodiment, each GPC 1800 includes, without limitation, a number of hardware units for processing tasks and each GPC 1800 includes, without limitation, a pipeline manager 1802, a pre-raster operations unit (“preROP”) 1804, a raster engine 1808, a work distribution crossbar (“WDX”) 1816, a memory management unit (“MMU”) 1818, one or more Data Processing Clusters (“DPCs”) 1806, and any suitable combination of parts.

In at least one embodiment, operation of GPC 1800 is controlled by pipeline manager 1802. In at least one embodiment, pipeline manager 1802 manages configuration of one or more DPCs 1806 for processing tasks allocated to GPC 1800. In at least one embodiment, pipeline manager 1802 configures at least one of one or more DPCs 1806 to implement at least a portion of a graphics rendering pipeline. In at least one embodiment, DPC 1806 is configured to execute a vertex shader program on a programmable streaming multi-processor (“SM”) 1814. In at least one embodiment, pipeline manager 1802 is configured to route packets received from a work distribution unit to appropriate logical units within GPC 1800, in at least one embodiment, and some packets may be routed to fixed function hardware units in preROP 1804 and/or raster engine 1808 while other packets may be routed to DPCs 1806 for processing by a primitive engine 1812 or SM 1814. In at least one embodiment, pipeline manager 1802 configures at least one of DPCs 1806 to implement a neural network model and/or a computing pipeline.

In at least one embodiment, preROP unit 1804 is configured, in at least one embodiment, to route data generated by raster engine 1808 and DPCs 1806 to a Raster Operations (“ROP”) unit in partition unit 1722, described in more detail above in conjunction with FIG. 17. In at least one embodiment, preROP unit 1804 is configured to perform optimizations for color blending, organize pixel data, perform address translations, and more. In at least one embodiment, raster engine 1808 includes, without limitation, a number of fixed function hardware units configured to perform various raster operations, in at least one embodiment, and raster engine 1808 includes, without limitation, a setup engine, a coarse raster engine, a culling engine, a clipping engine, a fine raster engine, a tile coalescing engine, and any suitable combination thereof. In at least one embodiment, setup engine receives transformed vertices and generates plane equations associated with geometric primitive defined by vertices; plane equations are transmitted to a coarse raster engine to generate coverage information (e.g., an x, y coverage mask for a tile) for primitive; output of a coarse raster engine is transmitted to a culling engine where fragments associated with a primitive that fail a z-test are culled, and transmitted to a clipping engine where fragments lying outside a viewing frustum are clipped. In at least one embodiment, fragments that survive clipping and culling are passed to a fine raster engine to generate attributes for pixel fragments based on plane equations generated by a setup engine. In at least one embodiment, an output of raster engine 1808 comprises fragments to be processed by any suitable entity, such as by a fragment shader implemented within DPC 1806.

In at least one embodiment, each DPC 1806 included in GPC 1800 comprises, without limitation, an M-Pipe Controller (“MPC”) 1810; primitive engine 1812; one or more SMs 1814; and any suitable combination thereof. In at least one embodiment, MPC 1810 controls operation of DPC 1806, routing packets received from pipeline manager 1802 to appropriate units in DPC 1806. In at least one embodiment, packets associated with a vertex are routed to primitive engine 1812, which is configured to fetch vertex attributes associated with a vertex from memory; in contrast, packets associated with a shader program may be transmitted to SM 1814.

In at least one embodiment, SM 1814 comprises, without limitation, a programmable streaming processor that is configured to process tasks represented by a number of threads. In at least one embodiment, SM 1814 is multi-threaded and configured to execute a plurality of threads (e.g., 32 threads) from a particular group of threads concurrently and implements a Single-Instruction, Multiple-Data (“SIMD”) architecture where each thread in a group of threads (e.g., a warp, wavefront, wave) is configured to process a different set of data based on same set of instructions. In at least one embodiment, all threads in group of threads execute a common set of instructions. In at least one embodiment, SM 1814 implements a Single-Instruction, Multiple Thread (“SIMT”) architecture wherein each thread in a group of threads is configured to process a different set of data based on that common set of instructions, but where individual threads in a group of threads are allowed to diverge during execution. In at least one embodiment, a program counter, call stack, and execution state is maintained for each warp (which may be referred to as wavefronts and/or waves), enabling concurrency between warps and serial execution within warps when threads within a warp diverge. In another embodiment, a program counter, call stack, and execution state is maintained for each individual thread, enabling equal concurrency between all threads, within and between warps. In at least one embodiment, execution state is maintained for each individual thread and threads executing common instructions may be converged and executed in parallel for better efficiency. At least one embodiment of SM 1814 is described in more detail herein.

In at least one embodiment, MMU 1818 provides an interface between GPC 1800 and a memory partition unit (e.g., partition unit 1722 of FIG. 17) and MMU 1818 provides translation of virtual addresses into physical addresses, memory protection, and arbitration of memory requests. In at least one embodiment, MMU 1818 provides one or more translation lookaside buffers (“TLBs”) for performing translation of virtual addresses into physical addresses in memory.

Logic 415 are used to perform inferencing and/or training operations associated with one or more embodiments. Details regarding logic 415 are provided herein in conjunction with FIGS. 4A and/or 4B. In at least one embodiment, deep learning application processor is used to train a machine learning model, such as a neural network, to predict or infer information provided to GPC 1800. In at least one embodiment, GPC 1800 is used to infer or predict information based on a trained machine learning model (e.g., neural network) that has been trained by another processor or system or by GPC 1800. In at least one embodiment, GPC 1800 may be used to perform one or more neural network use cases described herein.

FIG. 19 illustrates a memory partition unit 1900 of a parallel processing unit (“PPU”), in accordance with at least one embodiment. In at least one embodiment, memory partition unit 1900 includes, without limitation, a Raster Operations (“ROP”) unit 1902, a level two (“L2”) cache 1904, a memory interface 1906, and any suitable combination thereof. In at least one embodiment, memory interface 1906 is coupled to memory. In at least one embodiment, memory interface 1906 may implement 32, 64, 128, 1024-bit data buses, or like, for high-speed data transfer. In at least one embodiment, PPU incorporates U memory interfaces 1906 where U is a positive integer, with one memory interface 1906 per pair of partition units 1900, where each pair of partition units 1900 is connected to a corresponding memory device. For example, in at least one embodiment, PPU may be connected to up to Y memory devices, such as high bandwidth memory stacks or graphics double-data-rate, version 5, synchronous dynamic random access memory (“GDDR5 SDRAM”).

In at least one embodiment, memory interface 1906 implements a high bandwidth memory second generation (“HBM2”) memory interface and Y equals half of U. In at least one embodiment, HBM2 memory stacks are located on a physical package with a PPU, providing substantial power and area savings compared with conventional GDDR5 SDRAM systems. In at least one embodiment, each HBM2 stack includes, without limitation, four memory dies with Y=4, with each HBM2 stack including two 128-bit channels per die for a total of 8 channels and a data bus width of 1024 bits. In at least one embodiment, that memory supports Single-Error Correcting Double-Error Detecting (“SECDED”) Error Correction Code (“ECC”) to protect data. In at least one embodiment, ECC can provide higher reliability for compute applications that are sensitive to data corruption.

In at least one embodiment, PPU implements a multi-level memory hierarchy. In at least one embodiment, memory partition unit 1900 supports a unified memory to provide a single unified virtual address space for central processing unit (“CPU”) and PPU memory, enabling data sharing between virtual memory systems. In at least one embodiment frequency of accesses by a PPU to a memory located on other processors is traced to ensure that memory pages are moved to physical memory of PPU that is accessing pages more frequently. In at least one embodiment, high-speed GPU interconnect 1708 supports address translation services allowing PPU to directly access a CPU's page tables and providing full access to CPU memory by a PPU.

In at least one embodiment, copy engines transfer data between multiple PPUs or between PPUs and CPUs. In at least one embodiment, copy engines can generate page faults for addresses that are not mapped into page tables and memory partition unit 1900 then services page faults, mapping addresses into page table, after which copy engine performs a transfer. In at least one embodiment, memory is pinned (i.e., non-pageable) for multiple copy engine operations between multiple processors, substantially reducing available memory. In at least one embodiment, with hardware page faulting, addresses can be passed to copy engines without regard as to whether memory pages are resident, and a copy process is transparent.

Data from memory 1704 of FIG. 17 or other system memory is fetched by memory partition unit 1900 and stored in L2 cache 1904, which is located on-chip and is shared between various GPCs, in accordance with at least one embodiment. Each memory partition unit 1900, in at least one embodiment, includes, without limitation, at least a portion of L2 cache associated with a corresponding memory device. In at least one embodiment, lower level caches are implemented in various units within GPCs. In at least one embodiment, each of SMs 1814 in FIG. 18 may implement a Level 1 (“L1”) cache wherein that L1 cache is private memory that is dedicated to a particular SM 1814 and data from L2 cache 1904 is fetched and stored in each L1 cache for processing in functional units of SMs 1814. In at least one embodiment, L2 cache 1904 is coupled to memory interface 1906 and XBar 1720 shown in FIG. 17.

ROP unit 1902 performs graphics raster operations related to pixel color, such as color compression, pixel blending, and more, in at least one embodiment. ROP unit 1902, in at least one embodiment, implements depth testing in conjunction with raster engine 1808, receiving a depth for a sample location associated with a pixel fragment from a culling engine of raster engine 1808. In at least one embodiment, depth is tested against a corresponding depth in a depth buffer for a sample location associated with a fragment. In at least one embodiment, if that fragment passes that depth test for that sample location, then ROP unit 1902 updates depth buffer and transmits a result of that depth test to raster engine 1808. It will be appreciated that a number of partition units 1900 may be different than a number of GPCs and, therefore, each ROP unit 1902 can, in at least one embodiment, be coupled to each GPC. In at least one embodiment, ROP unit 1902 tracks packets received from different GPCs and determines whether a result generated by ROP unit 1902 is to be routed to through XBar 1720.

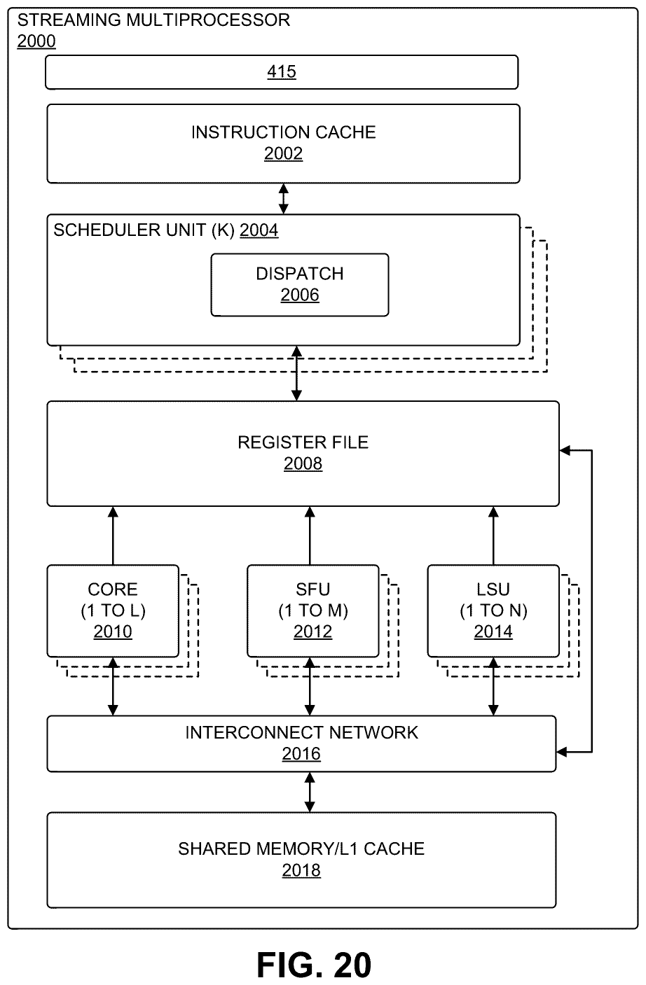

FIG. 20 illustrates a streaming multi-processor (“SM”) 2000, according to at least one embodiment. In at least one embodiment, SM 2000 is SM of FIG. 18. In at least one embodiment, SM 2000 includes, without limitation, an instruction cache 2002, one or more scheduler units 2004 (which may be referred to as sequencer units), a register file 2008, one or more processing cores (“cores”) 2010, one or more special function units (“SFUs”) 2012, one or more load/store units (“LSUs”) 2014, an interconnect network 2016, a shared memory/level one (“L1”) cache 2018, and/or any suitable combination thereof. In at least one embodiment, LSUs 2014 perform load of store operations corresponding to loading/storing data (e.g., instructions) to perform an operation (e.g., perform an API, an API call).

In at least one embodiment, a work distribution unit dispatches tasks for execution on general processing clusters (“GPCs”) of parallel processing units (“PPUs”) and each task is allocated to a particular Data Processing Cluster (“DPC”) within a GPC and, if a task is associated with a shader program, that task is allocated to one of SMs 2000 (which may be referred to as CUs and/or slices). In at least one embodiment, scheduler unit 2004 (which may be referred to as a sequencer and/or asynchronous compute engine) receives tasks from a work distribution unit and manages instruction scheduling for one or more thread blocks assigned to SM 2000. In at least one embodiment, scheduler unit 2004 schedules thread blocks for execution as warps (which may be referred to as wavefronts and/or waves) of parallel threads, wherein each thread block is allocated at least one warp. In at least one embodiment, each warp executes threads. In at least one embodiment, scheduler unit 2004 manages a plurality of different thread blocks, allocating warps to different thread blocks and then dispatching instructions from plurality of different cooperative groups to various functional units (e.g., processing cores 2010, SFUs 2012, and LSUs 2014) during each clock cycle.

In at least one embodiment, Cooperative Groups (which may also be referred to as wavefronts and/or waves) may refer to a programming model for organizing groups of communicating threads that allows developers to express granularity at which threads are communicating, enabling expression of richer, more efficient parallel decompositions. In at least one embodiment, cooperative launch APIs support synchronization amongst thread blocks for execution of parallel algorithms. In at least one embodiment, applications of conventional programming models provide a single, simple construct for synchronizing cooperating threads: a barrier across all threads of a thread block (e.g., syncthreads ( ) function). However, in at least one embodiment, programmers may define groups of threads at smaller than thread block granularities and synchronize within defined groups to enable greater performance, design flexibility, and software reuse in form of collective group-wide function interfaces. In at least one embodiment, Cooperative Groups enables programmers to define groups of threads explicitly at sub-block (i.e., as small as a single thread) and multi-block granularities, and to perform collective operations such as synchronization on threads in a cooperative group. In at least one embodiment, that programming model supports clean composition across software boundaries, so that libraries and utility functions can synchronize safely within their local context without having to make assumptions about convergence. In at least one embodiment, Cooperative Groups primitives enable new patterns of cooperative parallelism, including, without limitation, producer-consumer parallelism, opportunistic parallelism, and global synchronization across an entire grid of thread blocks.

In at least one embodiment, a dispatch unit 2006 is configured to transmit instructions to one or more functional units and scheduler unit 2004 and includes, without limitation, two dispatch units 2006 that enable two different instructions from a common warp to be dispatched during each clock cycle. In at least one embodiment, each scheduler unit 2004 includes a single dispatch unit 2006 or additional dispatch units 2006.

In at least one embodiment, each SM 2000 (which may be referred to as a CU and/or slice), in at least one embodiment, includes, without limitation, register file 2008 that provides a set of registers for functional units of SM 2000. In at least one embodiment, register file 2008 is divided between each functional unit such that each functional unit is allocated a dedicated portion of register file 2008. In at least one embodiment, register file 2008 is divided between different warps being executed by SM 2000 and register file 2008 provides temporary storage for operands connected to data paths of functional units. In at least one embodiment, each SM 2000 comprises, without limitation, a plurality of L processing cores 2010, where L is a positive integer. In at least one embodiment, SM 2000 includes, without limitation, a large number (e.g., 128 or more) of distinct processing cores 2010. In at least one embodiment, each processing core 2010 includes, without limitation, a fully-pipelined, single-precision, double-precision, and/or mixed precision processing unit that includes, without limitation, a floating point arithmetic logic unit and an integer arithmetic logic unit. In at least one embodiment, floating point arithmetic logic units implement IEEE 754-2008 standard for floating point arithmetic. In at least one embodiment, processing cores 2010 include, without limitation, 64 single-precision (32-bit) floating point cores, 64 integer cores, 32 double-precision (64-bit) floating point cores, and 8 tensor cores.

Tensor cores are configured to perform matrix operations in accordance with at least one embodiment. In at least one embodiment, one or more tensor cores are included in processing cores 2010. In at least one embodiment, tensor cores are configured to perform deep learning matrix arithmetic, such as convolution operations for neural network training and inferencing. In at least one embodiment, each tensor core operates on a 4×4 matrix and performs a matrix multiply and accumulate operation, D=A×B+C, where A, B, C, and D are 4×4 matrices.

In at least one embodiment, matrix multiply inputs A and B are 16-bit floating point matrices and accumulation matrices C and D are 16-bit floating point or 32-bit floating point matrices. In at least one embodiment, tensor cores operate on 16-bit floating point input data with 32-bit floating point accumulation. In at least one embodiment, 16-bit floating point multiply uses 64 operations and results in a full precision product that is then accumulated using 32-bit floating point addition with other intermediate products for a 4×4×4 matrix multiply. Tensor cores are used to perform much larger two-dimensional or higher dimensional matrix operations, built up from these smaller elements, in at least one embodiment. In at least one embodiment, an API, such as a CUDA 9 C++ API, exposes specialized matrix load, matrix multiply and accumulate, and matrix store operations to efficiently use tensor cores from a CUDA-C++ program. In at least one embodiment, at a CUDA level, a warp-level interface assumes 16×16 size matrices spanning all 32 threads of warp (which may be referred to as a wavefront and/or wave).

In at least one embodiment, each SM 2000 comprises, without limitation, M SFUs 2012 that perform special functions (e.g., attribute evaluation, reciprocal square root, and like). In at least one embodiment, SFUs 2012 include, without limitation, a tree traversal unit configured to traverse a hierarchical tree data structure. In at least one embodiment, SFUs 2012 include, without limitation, a texture unit configured to perform texture map filtering operations. In at least one embodiment, texture units are configured to load texture maps (e.g., a 2D array of texels) from memory and sample texture maps to produce sampled texture values for use in shader programs executed by SM 2000. In at least one embodiment, texture maps are stored in shared memory/L1 cache 2018. In at least one embodiment, texture units implement texture operations such as filtering operations using mip-maps (e.g., texture maps of varying levels of detail), in accordance with at least one embodiment. In at least one embodiment, each SM 2000 includes, without limitation, two texture units.

Each SM 2000 comprises, without limitation, N LSUs 2014 that implement load and store operations between shared memory/L1 cache 2018 and register file 2008, in at least one embodiment. Interconnect network 2016 connects each functional unit to register file 2008 and LSU 2014 to register file 2008 and shared memory/L1 cache 2018 in at least one embodiment. In at least one embodiment, interconnect network 2016 is a crossbar that can be configured to connect any functional units to any registers in register file 2008 and connect LSUs 2014 to register file 2008 and memory locations in shared memory/L1 cache 2018.

In at least one embodiment, shared memory/L1 cache 2018 is an array of on-chip memory that allows for data storage and communication between SM 2000 and primitive engine and between threads in SM 2000, in at least one embodiment. In at least one embodiment, shared memory/L1 cache 2018 comprises, without limitation, 128 KB of storage capacity and is in a path from SM 2000 to a partition unit. In at least one embodiment, shared memory/L1 cache 2018, in at least one embodiment, is used to cache reads and writes. In at least one embodiment, one or more of shared memory/L1 cache 2018, L2 cache, and memory are backing stores.

Combining data cache and shared memory functionality into a single memory block provides improved performance for both types of memory accesses, in at least one embodiment. In at least one embodiment, capacity is used or is usable as a cache by programs that do not use shared memory, such as if shared memory is configured to use half of a capacity, and texture and load/store operations can use remaining capacity. Integration within shared memory/L1 cache 2018 enables shared memory/L1 cache 2018 to function as a high-throughput conduit for streaming data while simultaneously providing high-bandwidth and low-latency access to frequently reused data, in accordance with at least one embodiment. In at least one embodiment, when configured for general purpose parallel computation, a simpler configuration can be used compared with graphics processing. In at least one embodiment, fixed function graphics processing units are bypassed, creating a much simpler programming model. In a general purpose parallel computation configuration, a work distribution unit assigns and distributes blocks of threads directly to DPCs, in at least one embodiment. In at least one embodiment, threads in a block execute a common program, using a unique thread ID in calculation to ensure each thread generates unique results, using SM 2000 to execute program and perform calculations, shared memory/L1 cache 2018 to communicate between threads, and LSU 2014 to read and write global memory through shared memory/L1 cache 2018 and memory partition unit. In at least one embodiment, when configured for general purpose parallel computation, SM 2000 writes commands that scheduler unit 2004 can use to launch new work on DPCs.

In at least one embodiment, a PPU is included in or coupled to a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, and more. In at least one embodiment, a PPU is embodied on a single semiconductor substrate. In at least one embodiment, a PPU is included in a system-on-a-chip (“SoC”) along with one or more other devices such as additional PPUs, memory, a reduced instruction set computer (“RISC”) CPU, a memory management unit (“MMU”), a digital-to-analog converter (“DAC”), and like.

In at least one embodiment, a PPU may be included on a graphics card that includes one or more memory devices. In at least one embodiment, that graphics card may be configured to interface with a PCIe slot on a motherboard of a desktop computer. In at least one embodiment, that PPU may be an integrated graphics processing unit (“iGPU”) included in chipset of a motherboard.

Logic 415 are used to perform inferencing and/or training operations associated with one or more embodiments. Details regarding logic 415 are provided herein in conjunction with FIGS. 4A and/or 4B. In at least one embodiment, deep learning application processor is used to train a machine learning model, such as a neural network, to predict or infer information provided to SM 2000. In at least one embodiment, SM 2000 is used to infer or predict information based on a trained machine learning model (e.g., neural network) that has been trained by another processor or system or by SM 2000. In at least one embodiment, SM 2000 may be used to perform one or more neural network use cases described herein.

At least one embodiment of the disclosure can be described in view of the following clauses:

According to at least one embodiment, a processor is provided comprising one or more arithmetic logic units (ALUs) to train a neural network, at least in part, by performing, for a concatenation layer of the neural network and for each of a plurality of training iterations: a forward pass, the forward pass comprising: receiving, from a plurality of upstream layers via a plurality of input paths, a plurality of concatenation layer inputs, scaling each respective concatenation layer input of the plurality of concatenation layer inputs to generate a plurality of scaled inputs, wherein each respective concatenation layer input is scaled by multiplying the respective concatenation layer input by a respective scaling factor, the respective scaling factor being determined based on a number of channels of the respective concatenation layer input and a mixing factor for the respective concatenation layer input, and concatenating the plurality of scaled inputs to provide a concatenation layer output.

According to at least one embodiment, the one or more ALUs are provided to train the neural network, at least in part, by further performing, for the concatenation layer of the neural network and for each of a plurality of training iterations: a backward pass, the backward pass comprising: receiving gradients of a model loss with respect to the concatenation layer output, splitting the received gradients into a plurality of gradient outputs, each respective gradient output corresponding to a respective concatenation layer input of the plurality of concatenation layer inputs, and routing, in a backward direction, the plurality of gradient outputs via a plurality of gradient paths to the plurality of upstream layers, each respective gradient path corresponding to a respective input path of the plurality of input paths.

According to at least one embodiment of the processor, each respective scaling factor is further determined based on a number of channels in one or more other concatenation layer inputs of the plurality of concatenation layer inputs and one or more other mixing factors for the other concatenation layer inputs of the plurality of concatenation layer inputs.

According to at least one embodiment of the processor, the plurality of concatenation layer inputs are n concatenation layer inputs, wherein the ith concatenation layer input, i=1, . . . , n, is a vector aᵢ, and the ith scaling factor [symbol] ᵢ is:

$${i}_{} = \sqrt{\frac{{\sum }_{j = 1}^{n} {N}_{j}}{{\sum }_{j = 1}^{n} {t}_{j}^{2}}} \cdot \frac{{t}_{i}}{\sqrt{{N}_{i}}} ,$$

wherein Nᵢ is the channel count of the ith concatenation layer input, tᵢ is the mixing factor for the ith respective concatenation layer input, and Σ₁ⁿ tᵢ=1.

According to at least one embodiment of the processor, the neural network is one of a diffusion model (DM), a generative pretrained transformer (GPT), a convolutional neural network (CNN), a recurrent neural network (RNN), an autoencoder, a feedforward neural network (FFNN), a graph neural network (GNN), or a generative adversarial network (GAN).

According to at least one embodiment, a system is provided comprising one or more processors to calculate parameters corresponding to a neural network, at least in part, by performing, for a concatenation layer of the neural network and for each of a plurality of training iterations: a forward pass, the forward pass comprising: receiving, from a plurality of upstream layers via a plurality of input paths, a plurality of concatenation layer inputs, scaling each respective concatenation layer input of the plurality of concatenation layer inputs to generate a plurality of scaled inputs, wherein each respective concatenation layer input is scaled by multiplying the respective concatenation layer input by a respective scaling factor, the respective scaling factor being determined based on a number of channels of the respective concatenation layer input and a mixing factor for the respective concatenation layer input, and concatenating the plurality of scaled inputs to provide a concatenation layer output. The system further comprises one or more memories to store the neural network.

According to at least one embodiment of the system, the one or more processors are provided to calculate parameters corresponding to the neural network, at least in part, by further performing, for the concatenation layer of the neural network and for each of a plurality of training iterations: a backward pass, the backward pass comprising: receiving gradients of a model loss with respect to the concatenation layer output, splitting the received gradients into a plurality of gradient outputs, each respective gradient output corresponding to a respective concatenation layer input of the plurality of concatenation layer inputs, and routing, in a backward direction, the plurality of gradient outputs via a plurality of gradient paths to the plurality of upstream layers, each respective gradient path corresponding to a respective input path of the plurality of input paths.

According to at least one embodiment of the system, each respective scaling factor is further determined based on a number of channels in one or more other concatenation layer inputs of the plurality of concatenation layer inputs and one or more other mixing factors for the According to at least one embodiment of the system, the plurality of concatenation layer inputs are n concatenation layer inputs, wherein the ith concatenation layer input, i=1, . . . , n, is a vector aᵢ, and the ith scaling factor [symbol] ᵢ is:

$${i}_{} = \sqrt{\frac{{\sum }_{j = 1}^{n} {N}_{j}}{{\sum }_{j = 1}^{n} {t}_{j}^{2}}} \cdot \frac{{t}_{i}}{\sqrt{{N}_{i}}} ,$$

wherein Nᵢ is the channel count of the ith concatenation layer input, tᵢ is the mixing factor for the ith respective concatenation layer input, and Σ₁ⁿ tᵢ=1.

According to at least one embodiment of the system, the neural network is one of a diffusion model (DM), a generative pretrained transformer (GPT), a convolutional neural network (CNN), a recurrent neural network (RNN), an autoencoder, a feedforward neural network (FFNN), a graph neural network (GNN), or a generative adversarial network (GAN).

According to at least one embodiment, a machine-readable medium is provided having stored thereon a set of instructions, which if performed by one or more processors, cause the one or more processors to at least: cause a neural network to be trained, at least in part, by performing, for a concatenation layer of the neural network and for each of a plurality of training iterations: a forward pass, the forward pass comprising: receiving, from a plurality of upstream layers via a plurality of input paths, a plurality of concatenation layer inputs, scaling each respective concatenation layer input of the plurality of concatenation layer inputs to generate a plurality of scaled inputs, wherein each respective concatenation layer input is scaled by multiplying the respective concatenation layer input by a respective scaling factor, the respective scaling factor being determined based on a number of channels of the respective concatenation layer input and a mixing factor for the respective concatenation layer input, and concatenating the plurality of scaled inputs to provide a concatenation layer output.

According to at least one embodiment of the machine readable medium, the instructions, if performed by the one or more processors, further cause the one or more processors to cause the neural network to be trained, at least in part, by further performing, for the concatenation layer of the neural network and for each of a plurality of training iterations: a backward pass, the backward pass comprising: receiving gradients of a model loss with respect to the concatenation layer output, splitting the received gradients into a plurality of gradient outputs, each respective gradient output corresponding to a respective concatenation layer input of the plurality of concatenation layer inputs, and routing, in a backward direction, the plurality of gradient outputs via a plurality of gradient paths to the plurality of upstream layers, each respective gradient path corresponding to a respective input path of the plurality of input paths.

According to at least one embodiment of the machine readable medium, each respective scaling factor is further determined based on a number of channels in one or more other concatenation layer inputs of the plurality of concatenation layer inputs and one or more other mixing factors for the other concatenation layer inputs of the plurality of concatenation layer inputs.

According to at least one embodiment of the machine readable medium, the plurality of concatenation layer inputs are n concatenation layer inputs, wherein the ith concatenation layer input, i=1, . . . , n, is a vector aᵢ, and the ith scaling factor [symbol] ᵢ is:

$${i}_{} = \sqrt{\frac{{\sum }_{j = 1}^{n} {N}_{j}}{{\sum }_{j = 1}^{n} {t}_{j}^{2}}} \cdot \frac{{t}_{i}}{\sqrt{{N}_{i}}} ,$$

wherein Nᵢ is the channel count of the ith concatenation layer input, tᵢ is the mixing factor for the ith respective concatenation layer input, and Σ₁ⁿ tᵢ=1.

According to at least one embodiment of the machine readable medium, the neural network is one of a diffusion model (DM), a generative pretrained transformer (GPT), a convolutional neural network (CNN), a recurrent neural network (RNN), an autoencoder, a feedforward neural network (FFNN), a graph neural network (GNN), or a generative adversarial network (GAN).

According to at least one embodiment, a method is provided for training a neural network, the method comprising: performing a forward pass, the forward pass comprising: receiving, from a plurality of upstream layers via a plurality of input paths, a plurality of concatenation layer inputs, scaling each respective concatenation layer input of the plurality of concatenation layer inputs to generate a plurality of scaled inputs, wherein each respective concatenation layer input is scaled by multiplying the respective concatenation layer input by a respective scaling factor, the respective scaling factor being determined based on a number of channels of the respective concatenation layer input and a mixing factor for the respective concatenation layer input, and concatenating the plurality of scaled inputs to provide a concatenation layer output.

According to at least one embodiment of the method, each respective scaling factor is further determined based on a number of channels in one or more other concatenation layer inputs of the plurality of concatenation layer inputs and one or more other mixing factors for the other concatenation layer inputs of the plurality of concatenation layer inputs.

According to at least one embodiment of the method, the plurality of concatenation layer inputs are n concatenation layer inputs, wherein the ith concatenation layer input, i=1, . . . , n, is a vector aᵢ, and the ith scaling factor [symbol] ᵢ is:

$${i}_{} = \sqrt{\frac{{\sum }_{j = 1}^{n} {N}_{j}}{{\sum }_{j = 1}^{n} {t}_{j}^{2}}} \cdot \frac{{t}_{i}}{\sqrt{{N}_{i}}} ,$$

wherein Nᵢ is the channel count of the ith concatenation layer input, tᵢ is the mixing factor for the ith respective concatenation layer input, and Σ₁ⁿ tᵢ=1.

According to at least one embodiment, a system is provided comprising one or more processors to perform inference using a neural network trained, at least in part, by the method according to at least one embodiment, and further comprising one or more memories to store the neural network.

According to at least one embodiment, a machine-readable medium is provided having stored thereon a set of instructions, which if performed by one or more processors, cause the one or more processors to at least: perform inference using the neural network trained, at least in part, by the method according to at least one embodiment.

In at least one embodiment, a single semiconductor platform may refer to a sole unitary semiconductor-based integrated circuit or chip. In at least one embodiment, multi-chip modules may be used with increased connectivity which simulate on-chip operation, and make substantial improvements over utilizing a conventional central processing unit (“CPU”) and bus implementation. In at least one embodiment, various modules may also be situated separately or in various combinations of semiconductor platforms per desires of user.

In at least one embodiment, referring back to FIG. 8, computer programs in form of machine-readable executable code or computer control logic algorithms are stored in main memory 804 and/or secondary storage. Computer programs, if executed by one or more processors, enable system 800 to perform various functions in accordance with at least one embodiment. In at least one embodiment, memory 804, storage, and/or any other storage are possible examples of computer-readable media. In at least one embodiment, secondary storage may refer to any suitable storage device or system such as a hard disk drive and/or a removable storage drive, representing a floppy disk drive, a magnetic tape drive, a compact disk drive, digital versatile disk (“DVD”) drive, recording device, universal serial bus (“USB”) flash memory, etc. In at least one embodiment, architecture and/or functionality of various previous figures are implemented in context of CPU 802, parallel processing system 812, an integrated circuit capable of at least a portion of capabilities of both CPU 802, parallel processing system 812, a chipset (e.g., a group of integrated circuits designed to work and sold as a unit for performing related functions, etc.), and/or any suitable combination of integrated circuit(s).

In at least one embodiment, architecture and/or functionality of various previous figures are implemented in context of a general computer system, a circuit board system, a game console system dedicated for entertainment purposes, an application-specific system, and more. In at least one embodiment, computer system 800 may take form of a desktop computer, a laptop computer, a tablet computer, servers, supercomputers, a smart-phone (e.g., a wireless, hand-held device), personal digital assistant (“PDA”), a digital camera, a vehicle, a head mounted display, a hand-held electronic device, a mobile phone device, a television, workstation, game consoles, embedded system, and/or any other type of logic.

In at least one embodiment, parallel processing system 812 includes, without limitation, a plurality of parallel processing units (“PPUs”) 814 and associated memories 816. In at least one embodiment, PPUs 814 are connected to a host processor or other peripheral devices via an interconnect 818 and a switch 820 or multiplexer. In at least one embodiment, parallel processing system 812 distributes computational tasks across PPUs 814 which can be parallelizable—for example, as part of distribution of computational tasks across multiple graphics processing unit (“GPU”) thread blocks. In at least one embodiment, memory is shared and accessible (e.g., for read and/or write access) across some or all of PPUs 814, although such shared memory may incur performance penalties relative to use of local memory and registers resident to a PPU 814. In at least one embodiment, operation of PPUs 814 is synchronized through use of a command such as _syncthreads( ), wherein all threads in a block (e.g., executed across multiple PPUs 814) to reach a certain point of execution of code before proceeding.

In at least one embodiment, one or more techniques described herein utilize a oneAPI programming model. In at least one embodiment, a oneAPI programming model refers to a programming model for interacting with various compute accelerator architectures. In at least one embodiment, oneAPI refers to an application programming interface (API) designed to interact with various compute accelerator architectures. In at least one embodiment, a oneAPI programming model utilizes a DPC++ programming language. In at least one embodiment, a DPC++ programming language refers to a high-level language for data parallel programming productivity. In at least one embodiment, a DPC++ programming language is based at least in part on C and/or C++ programming languages. In at least one embodiment, a oneAPI programming model is a programming model such as those developed by Intel Corporation of Santa Clara, CA.

In at least one embodiment, oneAPI and/or oneAPI programming model is utilized to interact with various accelerator, GPU, processor, and/or variations thereof, architectures. In at least one embodiment, oneAPI includes a set of libraries that implement various functionalities. In at least one embodiment, oneAPI includes at least a oneAPI DPC++ library, a oneAPI math kernel library, a oneAPI data analytics library, a oneAPI deep neural network library, a oneAPI collective communications library, a oneAPI threading building blocks library, a oneAPI video processing library, and/or variations thereof.

In at least one embodiment, a oneAPI DPC++ library, also referred to as oneDPL, is a library that implements algorithms and functions to accelerate DPC++ kernel programming. In at least one embodiment, oneDPL implements one or more standard template library (STL) functions. In at least one embodiment, oneDPL implements one or more parallel STL functions. In at least one embodiment, oneDPL provides a set of library classes and functions such as parallel algorithms, iterators, function object classes, range-based API, and/or variations thereof. In at least one embodiment, oneDPL implements one or more classes and/or functions of a C++ standard library. In at least one embodiment, oneDPL implements one or more random number generator functions.

In at least one embodiment, a oneAPI math kernel library, also referred to as oneMKL, is a library that implements various optimized and parallelized routines for various mathematical functions and/or operations. In at least one embodiment, oneMKL implements one or more basic linear algebra subprograms (BLAS) and/or linear algebra package (LAPACK) dense linear algebra routines. In at least one embodiment, oneMKL implements one or more sparse BLAS linear algebra routines. In at least one embodiment, oneMKL implements one or more random number generators (RNGs). In at least one embodiment, oneMKL implements one or more vector mathematics (VM) routines for mathematical operations on vectors. In at least one embodiment, oneMKL implements one or more Fast Fourier Transform (FFT) functions.

In at least one embodiment, a oneAPI data analytics library, also referred to as oneDAL, is a library that implements various data analysis applications and distributed computations. In at least one embodiment, oneDAL implements various algorithms for preprocessing, transformation, analysis, modeling, validation, and decision making for data analytics, in batch, online, and distributed processing modes of computation. In at least one embodiment, oneDAL implements various C++ and/or Java APIs and various connectors to one or more data sources. In at least one embodiment, oneDAL implements DPC++ API extensions to a traditional C++ interface and enables GPU usage for various algorithms.

In at least one embodiment, a oneAPI deep neural network library, also referred to as oneDNN, is a library that implements various deep learning functions. In at least one embodiment, oneDNN implements various neural network, machine learning, and deep learning functions, algorithms, and/or variations thereof.

In at least one embodiment, a oneAPI collective communications library, also referred to as oneCCL, is a library that implements various applications for deep learning and machine learning workloads. In at least one embodiment, oneCCL is built upon lower-level communication middleware, such as message passing interface (MPI) and libfabrics. In at least one embodiment, oneCCL enables a set of deep learning specific optimizations, such as prioritization, persistent operations, out of order executions, and/or variations thereof. In at least one embodiment, oneCCL implements various CPU and GPU functions.

In at least one embodiment, a oneAPI threading building blocks library, also referred to as oneTBB, is a library that implements various parallelized processes for various applications. In at least one embodiment, oneTBB is utilized for task-based, shared parallel programming on a host. In at least one embodiment, oneTBB implements generic parallel algorithms. In at least one embodiment, oneTBB implements concurrent containers. In at least one embodiment, oneTBB implements a scalable memory allocator. In at least one embodiment, oneTBB implements a work-stealing task scheduler. In at least one embodiment, oneTBB implements low-level synchronization primitives. In at least one embodiment, oneTBB is compiler-independent and usable on various processors, such as GPUs, PPUs, CPUs, and/or variations thereof.

In at least one embodiment, a oneAPI video processing library, also referred to as oneVPL, is a library that is utilized for accelerating video processing in one or more applications. In at least one embodiment, oneVPL implements various video decoding, encoding, and processing functions. In at least one embodiment, oneVPL implements various functions for media pipelines on CPUs, GPUs, and other accelerators. In at least one embodiment, one VPL implements device discovery and selection in media centric and video analytics workloads. In at least one embodiment, oneVPL implements API primitives for zero-copy buffer sharing.

In at least one embodiment, a oneAPI programming model utilizes a DPC++ programming language. In at least one embodiment, a DPC++ programming language is a programming language that includes, without limitation, functionally similar versions of CUDA mechanisms to define device code and distinguish between device code and host code. In at least one embodiment, a DPC++ programming language may include a subset of functionality of a CUDA programming language. In at least one embodiment, one or more CUDA programming model operations are performed using a oneAPI programming model using a DPC++ programming language.

In at least one embodiment, any application programming interface (API) described herein is compiled into one or more instructions, operations, or any other signal by a compiler, interpreter, or other software tool. In at least one embodiment, compilation comprises generating one or more machine-executable instructions, operations, or other signals from source code. In at least one embodiment, an API compiled into one or more instructions, operations, or other signals, when performed, causes one or more processors such as graphics processors 1600, graphics cores 1100, parallel processor 1200, processor 1300, processor core 1300, or any other logic circuit further described herein to perform one or more computing operations.

It should be noted that, while example embodiments described herein may relate to a CUDA programming model, techniques described herein can be utilized with any suitable programming model, such HIP, oneAPI, and/or variations thereof.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

In at least one embodiment, one or more components of systems and/or processors disclosed above can communicate with one or more CPUs, ASICs, GPUs, FPGAs, or other hardware, circuitry, or integrated circuit components that include, e.g., an upscaler or upsampler to upscale an image, an image blender or image blender component to blend, mix, or add images together, a sampler to sample an image (e.g., as part of a DSP), a neural network circuit that is configured to perform an upscaler to upscale an image (e.g., from a low resolution image to a high resolution image), or other hardware to modify or generate an image, frame, or video to adjust its resolution, size, or pixels; one or more components of systems and/or processors disclosed above can use components described in this disclosure to perform methods, operations, or instructions that generate or modify an image.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A processor comprising:
one or more arithmetic logic units (ALUs) to train a neural network, at least in part, by performing, for a concatenation layer of the neural network and for each of a plurality of training iterations:
a forward pass, the forward pass comprising:
receiving, from a plurality of upstream layers via a plurality of input paths, a plurality of concatenation layer inputs,
scaling each respective concatenation layer input of the plurality of concatenation layer inputs to generate a plurality of scaled inputs, wherein each respective concatenation layer input is scaled by multiplying the respective concatenation layer input by a respective scaling factor, the respective scaling factor being determined based on a number of channels of the respective concatenation layer input and a mixing factor for the respective concatenation layer input, and
concatenating the plurality of scaled inputs to provide a concatenation layer output.

2. The processor according to claim 1, the one or more ALUs to train the neural network, at least in part, by further performing, for the concatenation layer of the neural network and for each of a plurality of training iterations:
a backward pass, the backward pass comprising:
receiving gradients of a model loss with respect to the concatenation layer output,
splitting the received gradients into a plurality of gradient outputs, each respective gradient output corresponding to a respective concatenation layer input of the plurality of concatenation layer inputs, and
routing, in a backward direction, the plurality of gradient outputs via a plurality of gradient paths to the plurality of upstream layers, each respective gradient path corresponding to a respective input path of the plurality of input paths.

3. The processor according to claim 1, wherein each respective scaling factor is further determined based on a number of channels in one or more other concatenation layer inputs of the plurality of concatenation layer inputs and one or more other mixing factors for the other concatenation layer inputs of the plurality of concatenation layer inputs.

4. The processor according to claim 1, wherein the plurality of concatenation layer inputs are n concatenation layer inputs, wherein the ith concatenation layer input, i=1, . . . , n, is a vector aᵢ, and the ith scaling factor [symbol] ᵢ is:
$${i}_{} = \sqrt{\frac{{\sum }_{j = 1}^{n} {N}_{j}}{{\sum }_{j = 1}^{n} {t}_{j}^{2}}} \cdot \frac{{t}_{i}}{\sqrt{{N}_{i}}} ,$$
wherein Nᵢ is the channel count of the ith concatenation layer input, tᵢ is the mixing factor for the ith respective concatenation layer input, and Σ₁ⁿ tᵢ=1.

5. The processor according to claim 1, wherein the neural network is one of a diffusion model (DM), a generative pretrained transformer (GPT), a convolutional neural network (CNN), a recurrent neural network (RNN), an autoencoder, a feedforward neural network (FFNN), a graph neural network (GNN), or a generative adversarial network (GAN).

6. A system comprising:
one or more processors to calculate parameters corresponding to a neural network, at least in part, by performing, for a concatenation layer of the neural network and for each of a plurality of training iterations:
a forward pass, the forward pass comprising:
receiving, from a plurality of upstream layers via a plurality of input paths, a plurality of concatenation layer inputs,
scaling each respective concatenation layer input of the plurality of concatenation layer inputs to generate a plurality of scaled inputs, wherein each respective concatenation layer input is scaled by multiplying the respective concatenation layer input by a respective scaling factor, the respective scaling factor being determined based on a number of channels of the respective concatenation layer input and a mixing factor for the respective concatenation layer input, and
concatenating the plurality of scaled inputs to provide a concatenation layer output; and
one or more memories to store the neural network.

7. The system according to claim 6, the one or more processors to calculate parameters corresponding to the neural network, at least in part, by further performing, for the concatenation layer of the neural network and for each of a plurality of training iterations:
a backward pass, the backward pass comprising:
receiving gradients of a model loss with respect to the concatenation layer output,
splitting the received gradients into a plurality of gradient outputs, each respective gradient output corresponding to a respective concatenation layer input of the plurality of concatenation layer inputs, and
routing, in a backward direction, the plurality of gradient outputs via a plurality of gradient paths to the plurality of upstream layers, each respective gradient path corresponding to a respective input path of the plurality of input paths.

8. The system according to claim 6, wherein each respective scaling factor is further determined based on a number of channels in one or more other concatenation layer inputs of the plurality of concatenation layer inputs and one or more other mixing factors for the other concatenation layer inputs of the plurality of concatenation layer inputs.

9. The system according to claim 6, wherein the plurality of concatenation layer inputs are n concatenation layer inputs, wherein the ith concatenation layer input, i=1, . . . , n, is a vector aᵢ, and the ith scaling factor [symbol] ᵢ is:
$${i}_{} = \sqrt{\frac{{\sum }_{j = 1}^{n} {N}_{j}}{{\sum }_{j = 1}^{n} {t}_{j}^{2}}} \cdot \frac{{t}_{i}}{\sqrt{{N}_{i}}} ,$$
wherein Nᵢ is the channel count of the ith concatenation layer input, tᵢ is the mixing factor for the ith respective concatenation layer input, and Σ₁ⁿ tᵢ=1.

10. The system according to claim 6, wherein the neural network is one of a diffusion model (DM), a generative pretrained transformer (GPT), a convolutional neural network (CNN), a recurrent neural network (RNN), an autoencoder, a feedforward neural network (FFNN), a graph neural network (GNN), or a generative adversarial network (GAN).

11. A machine-readable medium having stored thereon a set of instructions, which if performed by one or more processors, cause the one or more processors to at least:
cause a neural network to be trained, at least in part, by performing, for a concatenation layer of the neural network and for each of a plurality of training iterations:
a forward pass, the forward pass comprising:
receiving, from a plurality of upstream layers via a plurality of input paths, a plurality of concatenation layer inputs,
scaling each respective concatenation layer input of the plurality of concatenation layer inputs to generate a plurality of scaled inputs, wherein each respective concatenation layer input is scaled by multiplying the respective concatenation layer input by a respective scaling factor, the respective scaling factor being determined based on a number of channels of the respective concatenation layer input and a mixing factor for the respective concatenation layer input, and
concatenating the plurality of scaled inputs to provide a concatenation layer output.

12. The machine-readable medium according to claim 11, the instructions, if performed by the one or more processors, further cause the one or more processors to cause the neural network to be trained, at least in part, by further performing, for the concatenation layer of the neural network and for each of a plurality of training iterations:
a backward pass, the backward pass comprising:
receiving gradients of a model loss with respect to the concatenation layer output,
splitting the received gradients into a plurality of gradient outputs, each respective gradient output corresponding to a respective concatenation layer input of the plurality of concatenation layer inputs, and
routing, in a backward direction, the plurality of gradient outputs via a plurality of gradient paths to the plurality of upstream layers, each respective gradient path corresponding to a respective input path of the plurality of input paths.

13. The machine-readable medium according to claim 11, wherein each respective scaling factor is further determined based on a number of channels in one or more other concatenation layer inputs of the plurality of concatenation layer inputs and one or more other mixing factors for the other concatenation layer inputs of the plurality of concatenation layer inputs.

14. The machine-readable medium according to claim 11, wherein the plurality of concatenation layer inputs are n concatenation layer inputs, wherein the ith concatenation layer input, i=1, . . . , n, is a vector aᵢ, and the ith scaling factor [symbol] ᵢ is:
$${i}_{} = \sqrt{\frac{{\sum }_{j = 1}^{n} {N}_{j}}{{\sum }_{j = 1}^{n} {t}_{j}^{2}}} \cdot \frac{{t}_{i}}{\sqrt{{N}_{i}}} ,$$
wherein Nᵢ is the channel count of the ith concatenation layer input, tᵢ is the mixing factor for the ith respective concatenation layer input, and Σ₁ⁿ tᵢ=1.

15. The machine-readable medium according to claim 11, wherein the neural network is one of a diffusion model (DM), a generative pretrained transformer (GPT), a convolutional neural network (CNN), a recurrent neural network (RNN), an autoencoder, a feedforward neural network (FFNN), a graph neural network (GNN), or a generative adversarial network (GAN).

16. A method for training a neural network, the method comprising:
performing a forward pass, the forward pass comprising:
receiving, from a plurality of upstream layers via a plurality of input paths, a plurality of concatenation layer inputs,
scaling each respective concatenation layer input of the plurality of concatenation layer inputs to generate a plurality of scaled inputs, wherein each respective concatenation layer input is scaled by multiplying the respective concatenation layer input by a respective scaling factor, the respective scaling factor being determined based on a number of channels of the respective concatenation layer input and a mixing factor for the respective concatenation layer input, and
concatenating the plurality of scaled inputs to provide a concatenation layer output.

17. The method according to claim 16, wherein each respective scaling factor is further determined based on a number of channels in one or more other concatenation layer inputs of the plurality of concatenation layer inputs and one or more other mixing factors for the other concatenation layer inputs of the plurality of concatenation layer inputs.

18. The method according to claim 17, wherein the plurality of concatenation layer inputs are n concatenation layer inputs, wherein the ith concatenation layer input, i=1, . . . , n, is a vector aᵢ, and the ith scaling factor [symbol] ᵢ is:
$${i}_{} = \sqrt{\frac{{\sum }_{j = 1}^{n} {N}_{j}}{{\sum }_{j = 1}^{n} {t}_{j}^{2}}} \cdot \frac{{t}_{i}}{\sqrt{{N}_{i}}} ,$$
wherein Nᵢ is the channel count of the ith concatenation layer input, tᵢ is the mixing factor for the ith respective concatenation layer input, and Σ₁ⁿ tᵢ=1.

19. A system comprising:
one or more processors to perform inference using a neural network trained, at least in part, by the method according to claim 17; and
one or more memories to store the neural network.

20. A machine-readable medium having stored thereon a set of instructions, which if performed by one or more processors, cause the one or more processors to at least:
perform inference using the neural network trained, at least in part, by the method according to claim 17.
